(19) United States
(12) Patent Application Publication
(10) Pub. No.: US 2002/0181067 A1
(43) Pub. Date: Dec. 5, 2002

(54) Electro-optic switching assembly and method

(76) Inventors: Alexander B. Romanovsky, San Jose, CA (US); Gene H. Haertling, Albuquerque, NM (US)

Correspondence Address: KNOBBE MARTENS OLSON & BEAR LLP, 2040 MAIN STREET, FOURTEENTH FLOOR, IRVINE, CA, 91614, US

(21) Appl. No.: 10/013,336

(22) Filed: Nov. 5, 2001

Related U.S. Application Data
(63) Continuation-in-part of application No. 09/434,085, filed on Nov. 5, 1999, now Pat. No. 6,381,060.
Application No. 09/434,085 is a continuation-in-part of application No. 08/959,778, filed on Oct. 29, 1997, now Pat. No. 6,310,712.
(60) Provisional application No. 60/245,810, filed on Nov. 3, 2000.

(51) Int. Cl. G02F 1/03; G02F 1/07

(52) U.S. Cl. 359/245; 359/251; 359/254

(57) ABSTRACT

An optical system (10) includes an optical switching module (210,300,350) that is adjustable between first and second conditions to selectively direct an incident light signal (240,301,351) between either of at least two optical paths (236,238,304,303). At least one optical switch (218) is integrated into a substantially planar waveguide substrate in order selectively switch light (240,301,351) entering the switch from one waveguide (232,234) to exit the switch along either of at least two other waveguides (236,238). The optical switch (218) includes an electro-optic material (222) that is deposited into a cavity (220) formed within the substrate (214) such that the respectively optically coupled waveguides (232,234,236,238) interface with the switch (218) along the cavity walls. The switch (218) includes first and second regions (226,228) that interface at a boundary (230), and the electro-optic material (222) is located in one of the regions (226,228) such that an electrical field source (212,213,224) coupled to the material (222) in the one region (226) adjusts the boundary (230) between transmission and reflection modes with respect to at least one polarization of a light signal (232) incident upon the boundary (230) from a waveguide (232). The cavity and integrated switch are arranged such that the incident light signal (232) enters the switch from a waveguide (232) as a light beam that is not guided as it projects onto the boundary (230). Switching of light polarizations aligned with the applied electric field is accomplished in one regard by filling the second region (opposite the region receiving the incident light) with PLZT that has a reducing index of refraction in the presence of an applied field. PLZT is provided in the switch (11) in a formulation that provides substantially little hysteresis with respect to the applied field, and in particular is a non-ferroelectric, cubic, relaxor, polycrystalline, ceramic type having a lanthanum concentration of between about 8.5% and about 9.0%. The electro-optic material (222) may be in both regions (98,100,226,228) with the applied field region being thicker in the plane of the applied field than the other region. Or, the electro-optic material (222) may be in one region (100,226) with a second different material in the other region (98,228,411) that is less electro-optically active than the first region (100, 226, 417). The second material may be the electro-optic material (222) with another material that inhibits electro-optic activity, such as PLZT in combination with silica. The PLZT is deposited within the cavity (220) by a sol-gel process preferably after the cavity is coated with an optically transparent coating that forms a barrier to silica migration during heat treatment of the PLZT and that also provides for good adhesion for the PLZT. Polarization independent switching is achieved by optically coupling the light signal to generally two polarization dependent TIR boundaries (415,425,665,675) in series that separate and switch two polarization components of the light signal which are then combined by a combiner (330,390). An add-drop multiplexing system (900) is described that incorporates an array of the optical switching modules (S1,S2,S3) with a WDM de-multiplexor assembly (920) onto a single planar silicon wafer substrate (900).

This application is a continuation-in-part of Ser. No. 09/434,085, filed Nov. 5, 1999, which is a continuation-in-part of Ser. No. 08/959,778, filed Oct. 29, 1997, now U.S. Pat. No. 6,310,712. This application also claims the benefit under 35 U.S.C. §119(e) of U.S. Provisional Application 60/245,810, filed Nov. 3, 2000.

### TECHNICAL FIELD

The present invention relates generally to light modulators such as light switches. More particularly, the invention is an optical system using electro-optic switches as micro-structures integrated into planar waveguide arrays suitable for the high-speed signal processing of optical interconnects, telecommunications and flat panel displays.

### BACKGROUND ART

Electro-optic modulators have been well known in the art for years, but for multi-channel applications they have suffered from several disadvantages. A substantial portion of prior art modulator arrays have been formed from single wafers of electro-optically active material onto which surface electrodes have been attached, to form channels which are defined by the electric field lines within the optical wafer. Cross-talk, or interference between channels, has been a problem because electro-optic modulators are vulnerable on at least two levels. Since the channels are not restricted except by the electric field lines, activity in one channel can easily induce electro-optic interference in a nearby channel. This is in addition to usual electrical cross-talk experienced by closely grouped and unshielded electrical contacts. Also, previous electro-optic modulators, such as for example optical switches, have often relied on surface deposited electrodes, which produce electric field lines that are fringed, rather than channeled and directed. Due to the exponential decay of the electric field intensity inside the material, very high voltages may be required to drive the material to produce the desired electro-optic effect.

Electro-optic materials, such as LiNbO₃, can be expensive, and can require high driving voltages in optical switching applications. Liquid crystal modulators have also been used, but response times for this type are typically very slow, on the order of milliseconds. Also, the electro-optic effect exhibited by a material can be of several different orders, depending on the material. A first order effect, called the Pockels effect, is linear in its response to increase in applied voltage. A second order effect, called the Kerr effect, is quadratic in its response, thus a greater increase in effect can be produced relative to an increase in voltage. This can theoretically allow smaller driving voltages in a primarily Kerr effect material to be applied to produce a comparable electro-optic effect compared to material which produces primarily Pockels effect.

Lead zirconate titanate polycrystalline ceramic which is doped with lanthanum (PLZT) is a relatively inexpensive, optically transparent ceramic which can be made to exhibit either the quadratic Kerr effect or the linear Pockels effect, depending on the composition, and can be formed into wafers easily and used in sol-gel moldings. The concentrate of lanthanum, or “doping”, is variable, and can lead to varying characteristics in the material. PLZT that is commercially available is typically made from a “recipe” which produces a very high dielectric constant κ. Very high κ values produce high capacitance values C, which in turn produce high power requirements, as power (P) is proportional to CV²/2 where V=voltage. High power consumption in turn generates heat, so that some modulators that require high voltage also may require cooling. If the proportion of lanthanum dopant, or other components, in the material is adjusted, the dielectric constant value and electro-optic constant value, as well as the type of electro-optic effect (Kerr or Pockels), may also be varied, with the result affecting capacitance and power consumption.

Various specific PLZT formulations, observations, and applications are variously disclosed in the following references: “Ultrafast nonlinear response of PLZT thin films to femtosecond pulses,” Cailong Bao et al., CLEO 1995 CFB8, (1995); “Bulk vs. Thin Film PLZT Ferroelectrics,” D. E. Dausch et al., Proceedings of 8th ISAF, Greenville, S.C., 297-300, January (1993); “Comparison of Electro-optic Lead-lanthanum Zirconate Titanate Films on Crystalline and Glass Substrates,” K. D. Preston et al., Appl. Phys. Lett., 60, 2831-2833 (1992); and “Transverse Electro-optic Effect of Antiferroelectric Lead Zirconate Thin Films,” F. Wang et al., Optics Letters, 17, No. 16, 1122-1124, Aug. 15 (1992). The disclosures of these references are herein incorporated in their entirety by reference thereto.

Previous known attempts for modulating light in arrays generally suffer from common problems experienced by multi-channel optical and electrical systems in which the channels are not appropriately isolated. As discussed above, interference is easily induced in nearby channels resulting in cross-talk which can distort image clarity and corrupt data transmissions. Additionally, much of the prior art requires high driving voltages that are incompatible with TTL level power supplies.

One previously known disclosure includes a wafer of PLZT electro-optic ceramic material with a large number of surface mounted electrodes. The apparatus of this particular disclosure is intended to decrease cross-talk by use of large electrodes and increased space of the electro-optic windows. This is believed to result in less efficient use of the material, in that the generally large areas of material generally require higher applied voltages in order to provide the necessary electric field density in the wafer.

Another previously known disclosure provides a spatial light modulator made of a solid sheet layer of electro-optic material such as PLZT, which has paired surface electrodes. The apparatus of this disclosure is believed to require a driving voltage of approximately 20 volts in order to produce a phase retardation of Pi radians. Still another previously known disclosure provides a panel of electro-optic material that uses electrodes to define pixel regions, generally using voltages in the range of 100-200 volts. Another previously known disclosure providing a single slab of electro-optic material requires a driving voltage of 150 volts. Still another previously known disclosure provides a single wafer of Pockels crystal with surface mounted electrodes requiring a 70 volt driving voltage. It is believed that these previous disclosures are incompatible with TTL voltage levels, and further that none of these prior attempts have provided any mechanism for confirming electric field lines. Also, in general, use of higher driving voltages can generate undesirable levels of heat in the electro-optic material, which can mean that a cooling system may be required.

Other previously known electro-optic modulator arrays are also generally expected to result in undesirable degrees of cross-talk or electric field confinement, respectively. One previously disclosed array of optical modulators that are built into a neural network are generally of the liquid crystal type, although use of PLZT is mentioned. Another disclosure shows a single slab of electro-optic material with an array of electrodes that create fringe electric fields without any disclosed mechanism for field confinement. At least one other previously disclosed modulator array includes mirror-like devices that deflect or deform when electrostatic force is applied. Another previously disclosed apparatus provides a light valve array, with one specifically preferred material being PLZT. However, as mentioned above these previously disclosed types of devices are generally expected to provide unwanted cross-talk.

A large number of other modulators such as optical switches have also been disclosed that selectively change the index of refraction for one or more adjacent materials in order to selectively switch a light beam incident upon the switch with respect to at least one output location.

For example, some references disclose optical switching devices that are intended to change the material phase or state in one of two adjacent regions, such that the refractive index of that one region is adjustable relative to the adjacent region in order to selectively switch light incident upon the boundary between either transmitting across or reflecting at the boundary. Such change may be induced in the material located in the adjustable region, or may be created by replacing the material in the adjustable region with another material in another phase or state. In general, such adjustable region according to these disclosures is adjustable between a liquid phase or state and a vaporized or gaseous phase or state.

In another particular group of disclosures, a poled material, generally a ferro-electric Lithium Niobate (LiNbO₃) material in a single crystal structure, is arranged and electroded in a manner that is intended to provide an optical switch capable of selectively switching incident light beams between multiple paths. A specific domain region of the material is poled in a particular orientation relative to the next adjacent domain in order to achieve reflection of light at the interface of the two adjacent regions of the LiNbO3 material. In an attempt to provide a substantially controllable, planar boundary between adjacent domains as just described, the second adjacent domain is also generally poled in an opposite orientation to the first domain. Electrodes are generally provided on a common planar surface of the crystal in order to apply a fringing field to electro-optically activate the material out of plane of the axis of separation for the electrodes. Furthermore, various specific operations are generally required in order to pole the material in a manner that is intended according to these disclosures. Also, the poled domains in LiNbO₃ material of these disclosures are generally described to comprise portions of a single crystal structure. It is believed that the manufacture of such a single crystal switch in certain microstructure arrays may present significant challenges to cost and scalability. Still further, LiNbO₃ crystal switches as intended by these disclosures are also believed to require sizing and applied voltages that may also not be readily applicable to the requirements of certain microstructure arrays.

Other prior attempts at making optical switches have intended to use electro-optic properties of the unique “liquid crystal”-type of material in order to alter a refractive index of a portion of a device in a manner affecting the direction of a light signal incident on the device. Some prior disclosures are intended to use electro-optic liquid crystal for the purpose of polarization rotation or beam diffraction for switching light signals, either in the binary “on-off” sense or between multiple outputs.

Other previously disclosed liquid crystal modulators are intended to provide an optically active, TIR interface at a boundary between an electro-optic liquid crystal material and another adjacent material. Some references disclose that, by selecting between two voltages across the liquid crystal material adjacent the boundary, the index of refraction of the liquid crystal is adjustable between values that correspond to either transmission or reflection of incident light at the boundary interface.

It is believed that the previously disclosed electro-optic liquid crystal devices that are intended for use in switching optical switching would be extremely difficult to manufacture according to the small sizes desired for certain applications. It is further believed that the scalability of such devices may be limited to an extent that generally challenges the approach for certain applications. Still further, even if such devices could be made, confinement of the liquid crystal material within a highly isolated region of a microstructure switch requires significant design considerations. Even still, the switching times for the electro-optic liquid crystal elements disclosed are believed to be limited to insufficient speeds for certain applications, in particular regarding the generally “high speed” switching required for certain information management and telecommunication applications.

Other prior references disclose changing the index of refraction of an electro-optic material in either the core or the cladding (or both) of a waveguide in order to selectively switch an optical signal between the waveguide and an adjacent structure such as another waveguide. Such an approach has been previously labeled by others as “evanescent” coupling. One disclosed approach is intended to use liquid crystal as the electro-optic material, which is still believed to present the same limitations attached to the liquid crystal material as discussed above. In any event, such coupling of light from a waveguide through a cladding layer is believed to result in significant insertion loss into the evanescently coupled structure, and it is also believed to be difficult to achieve sufficient channel isolation for many applications.

The acceptance of SiO₂/Si planar waveguide technology as an opto-electronic integration platform continues to grow, based in part on the success of the arrayed waveguide grating (AWG) multiplexer/demultiplexers, and the technology's potential for the integration of several other optical networking functions. One function of particularly high interest is the integration of scalable optical switching, which in combination with a planar AWG would constitute a “single chip” or at least single platform core for a compact and cost-effective programmable optical add-drop multiplexer (OADM).

Such a programmable OADM might be particularly well suited for the broader “metro” or mesh level of the physical network for a variety of reasons. In one regard, the scale of multiplexing and switching at this more distributed level of the physical optical network may suffice with multiplexing to “only” 64 or 128 channels. In another regard, the reliability of solid-state and planar processing technologies may be just as crucial in the metro network as it is in the backbone because of the distributed nature of any potential reliability problems. In addition, the lower aggregate flow of revenue-bearing traffic at the metro level of the network (compared with a large backbone) dictates the use of a technology that has realizable potential for low cost of ownership using planar integration processes proven in semiconductors. Still further, the integration of optical switching and DWDM would dramatically increase the utilization of the aggregate bandwidth. This is especially so because the predictability of demand between nodes at this level of the network is less than at the backbone level where increased aggregation of traffic is statistically stable and predictable over time. Moreover, the miniaturization of planar integration also addresses a growing issue in trying to add facilities for capacity expansion in existing metropolitan node sites: the increasingly limited space and the concomitant challenge of increasing capability and components.

The intended use of TIR (total internal reflection) as an optical switching mechanism in a planar waveguide setting has been disclosed. One previously disclosed planar waveguide-based device is intended to thermally induce the vaporization of an index-matching oil in order to create a phase change and therefore change in index of refraction in order to selectively create a TIR boundary. Another previously disclosed planar waveguide-based device is intended to interchangeably displace a volume of fluid with a gaseous bubble within one of two adjoining portions of a waveguide cross-connect region, thereby adjusting the refractive index in that portion for the purpose of TIR switching. Another general disclosure is intended to provide a region of electro-optic material within a localized portion of the core of a waveguide crossing region for the purpose of TIR switching of an incoming light wave from one of the crossing waveguide segments between one of two output waveguide segments. This switch appears to be implemented completely within the guided modes of the waveguide crossing region, and very little disclosure is provided regarding how such a micro-structure switch may be manufactured or operated with an efficient and/or operational result.

For the foregoing reasons, there is a need for an array of discrete light modulating elements which can operate at TTL voltage levels, and at high speeds, with extremely low cross-talk.

There is a need for an optical switch that selectively switches a light signal at least in part by using an electro-optic material that has at least one of the following characteristics: solid, inorganic, non-poled, polycrystalline, ceramic, non-ferroelectric, cubic relaxor, or combinations or blends thereof

There is also a need for an optical modulator, such as a switch, that allows for selective light transmission or TIR reflection at a boundary between two regions of either uniform or dissimilar materials in the switch, but that does not require use of one or more of the following: a liquid crystal material, a poled material, or a single crystalline structure across both regions.

There is also a need for an optical modulator or switch that is readily applicable for use in a microstructure array, and in particular in an N×N or N×M optical channel switching array, and that may be manufactured in a highly scalable and cost-effective manner.

There is also a need for an optical modulator or switch that may be manufactured in a scalable and cost-effective manner into waveguide crossing regions in a planar waveguide array structure, and in particular in a SiO₂./Si planar waveguide structure, and in particular that can operate at speeds attributable to telecommunications applications.

There is also a need for an optical switching module that allows for N×N or N×M optical channel switching that is polarization independent.

There is also still a need for a polarization independent optical switch that is polarization independent and is adapted to be formed within a waveguide crossing region

### SUMMARY OF THE INVENTION

Accordingly, it is an object of the present invention to provide an array of discrete modulated elements of electro-optic material, in particular such an array of optical switches.

Another object of the invention is to provide arrays of electro-optically activated optical switches that can be driven by TTL voltages, and thus be compatible with standard TTL power supplies.

Yet another object of the invention is to produce arrays of electro-optic switches that have very little cross-talk between channels.

Still another object of the present invention is to provide a switching array with very fast response and switching time.

A further object of the present invention is to provide an array of pixels that can be of very small dimensions to reduce problems of aliasing in optical displays.

A yet further object of the present invention is to produce light modulating arrays and in particular optical switches that can be manufactured very efficiently and inexpensively.

Another object of the invention is to provide an optical system with an optical switch that is adapted to efficiently switch an incident input channel light beam between two output channels.

Another object of the invention is to provide an optical system with an optical switching array that is readily inlegratable into a planar waveguide array structure.

Another object of the invention is to provide an optical system that is readily integratable with OADM systems, and in particular that can be integrated together with WDM de-multiplexer and multiplexers on a single substrate such as a planar silicon chip.

A further object of the invention is to provide an optical system with an optical element with a substantially planar TIR boundary that is selectable between transmission and TIR reflection modes based upon a substantially localized optical refractive index response to an applied energy field within one region of material in the element.

Another object of the invention is to provide an optical switching module that can switch incident light signals between multiple output channels without regard to the polarization of the input light signal.

Another object of the invention is to provide a single optical switch that can selectively switch either of two input channels between either of two output channels.

Another object of the invention is to provide an optical switch design and method of manufacture that permits integration of free-space beam switching into a crossing waveguide region of a planar waveguide structure.

Another object of the invention is to provide a method for depositing an electro-optic material into a cavity of a planar waveguide structure such that the material may be adapted as an optical switch between optically coupled waveguides associated with the substrate structure.

These and other various objects apparent to one of ordinary skill based upon this disclosure are intended to be accomplished by and therefore form various bases of the invention, which is further provided at least in part according to the following aspects (which aspects are further refined below as to certain embodiments, variations, and features which are either preferred or define certain specific alternatives but are not to be read as limiting to the broad scope of the aspects):

One aspect of the invention is an optical switch with first and second regions that are in close conjunction with each other such that a boundary is formed at a junction between them. An electro-optic material is located within at least one of the first and second regions and has one or more of the following characteristics: a solid material, a non-poled material, a ceramic material, a polycrystalline material, a non-ferroelectric material, a cubic material, a relaxor material, or combinations or blends thereof The optical switch further comprising an electric field source that is adapted at least in part to apply an adjustable electric field to the electro-optic material in the one region such that the optical switch is adjustable between first and second conditions with respect to at least one polarization component of a light signal entering the optical switch and incident upon the boundary at an angle as follows. In the first condition, the first and second regions have respective indexes of refraction such that a substantial portion of the at least one polarization component of the light signal incident upon the boundary transmits across the boundary substantially unreflected. However, in the second condition the respective indexes of refraction for the first and second regions are sufficiently different such that a substantial portion of the at least one polarization component of the light signal incident upon the boundary reflects with total internal reflection at the boundary.

In another regard, the group of characterized materials from which the electro-optic material is chosen may further include a material that reduces its index of refraction with respect to a light polarization component that is aligned with an applied electric field. Furthermore, use of an electro-optic material having the characteristics of any one or more of the types of materials provided in the group is considered to provide certain unique benefits and is therefore considered a preferred embodiment of this aspect.

Another aspect of the invention is also an optical system with an optical switch having first and second regions in close conjunction with each other such that a boundary is formed at a junction between the first and second regions. According to this aspect however a first material comprising an electro-optic material is located in one of the first and second regions, whereas a second material is located in the other of the first and second regions that comprises the electro-optic material in combination with another material such that the second material is less electro-optically active than the first material. The optical switch of this aspect also comprises an electric field source which is adapted at least in part to apply an adjustable electric field to the electro-optic material in the one region such that the optical switch is adjustable between first and second conditions with respect to at least one polarization component of a light signal entering the optical switch and incident upon the boundary at an angle as follows. In the first condition, the first and second regions have respective indexes of refraction such that a substantial portion of the at least one polarization component of the light signal incident upon the boundary transmits across the boundary substantially unreflected. However, in the second condition the respective indexes of refraction for the first and second regions are sufficiently different such that a substantial portion of the at least one polarization component of the light signal incident upon the boundary reflects with total internal reflection at the boundary.

Another aspect of the invention is also an optical system with an optical switch having first and second regions in close conjunction with each other such that a boundary is formed at a junction between them. An electro-optic material is located within at least one of the first and second regions, and an electric field source is adapted at least in part to apply an adjustable electric field to the electro-optic material along an axis in the one region that is substantially aligned with the boundary. According to this particular aspect, the first region is thicker than the second region relative to the axis, such that the optical switch is adjustable between first and second conditions with respect to at least one polarization component of a light signal entering the optical switch and incident upon the boundary at an angle as follows. In the first condition, the first and second regions have respective indexes of refraction such that a substantial portion of the at least one polarization component of the light signal incident upon the boundary transmits across the boundary substantially unreflected. In the second condition, the respective indexes of refraction for the first and second regions are sufficiently different such that a substantial portion of the at least one polarization component of the light signal incident upon the boundary reflects with total internal reflection at the boundary.

According to one preferred embodiment of this aspect, a pair of electrodes are separated along the one region by the axis with the electro-optic material located therebetween, such that the thickness of the first region generally defines the separation of the electrodes. According to a further variation, the thickness of the second portion may be reduced by removal of a step region. Further to this variation, electric field lines within the active first portion are more narrowly directed and the TIR boundary is flatter and more uniform. In still a further variation, the step region is filled with a material having a low dielectric constant k. In still a further variation, the second region is stepped on each of two faces relative to the axis, such that the material in the first region adjacent each electrode is spaced from the material of the second region. Preferably, the first region has a first face, a second face separated from the first face along an axis, a thickness between the first and second faces relative to the axis, and an electro-optic material between the first and second faces. The second region has two opposite faces that are spaced from the first and second faces, respectively, of the first region relative to the axis such that the second region has a second thickness that is less than the first thickness.

Another aspect of the invention is an optical system having an optical switching module that switches a light signal without regard to a polarization alignment of the light signal. The module includes an electro-optic material and at least one electric field source coupled to the electro-optic material in order to apply an electric field to the electro-optic material to at least in part adjust the optical switching module between a first condition and a second condition with respect to a light signal that is incident upon the optical switching module and without regard to a polarization of the light signal as follows. In the first condition, a substantial portion of the light signal entering the optical switching module exits the optical switching module along a first output path. However, in the second condition a substantial portion of the light signal entering the optical switching module exits the optical switching module along a second output path.

According to one beneficial embodiment of this aspect, the optical switching module further comprises first and second pairs of two adjacent regions of material with first and second boundaries, respectively, formed at junctions between the two adjacent regions of each of the pairs. The electro-optic material is located within at least one of the two adjacent regions of each pair, and at least one electrical field source is adapted to apply an adjustable electric field to the electro-optic material in the one region of each pair such that each of the first and second pairs of regions is adjustable between a respective transmission mode and a respective reflection mode as follows. In the transmission mode for the first pair of regions, the light signal incident upon the first boundary at an angle substantially transmits across the first boundary. In the reflection mode for the first pair, a substantial portion of a first polarization component of the light signal substantially reflects with total internal reflection at the boundary while a second polarization component of the light signal substantially transmits across the boundary. In the transmission mode for the second pair of regions, a substantial portion of at least the second polarization component of the light signal transmitting across the first boundary and incident upon the second boundary also transmits across the second boundary substantially unreflected. In the reflection mode for the second pair of regions a substantial portion of the second polarization component of the light signal transmitting across the first boundary and incident upon the second boundary reflects with total internal reflection at the second boundary. Accordingly, the first condition is characterized at least in part by both of the first and second pairs of adjacent regions in the transmission mode, respectively, and the second condition is characterized at least in part by both the first and second pairs of adjacent regions in the reflection mode, also respectively.

In a further beneficial embodiment of this aspect, the module further includes a combiner that is adapted to combine the first polarization component reflecting at the first boundary and the second polarization component reflecting at the second boundary into an output light signal.

In one further variation of this embodiment, a plurality of at least n of the optical switching modules are provided in an optical switching array. Each optical switching module is adapted to receive an input light signal from a unique one of n input optical channels, wherein n is an integer. Further to this variation, n of the combiners are provided that are associated with the at least n optical switching module. Each combiner is adapted to combine the respective first and second polarization components from at least one of said optical switching modules. In a further highly beneficial variation, n² optical switching modules are provided, wherein each combiner is associated with a unique combination of n optical switching modules and is adapted to combine the respective first and second polarization components from any one of the respective combination of n optical switching modules into an output light signal. In still a further beneficial variation incorporating a unique pair of optical switches in each optical switching module, the optical switching array comprises 2n² optical switches.

In another embodiment of this polarization independent switching aspect, the first pair of two adjacent regions and first boundary form a first optical switch, and the second pair of two adjacent regions and second boundary form a second optical switch that is physically separated from but optically coupled to the first optical switch. In one variation of this embodiment, the optical switching module further comprises a waveguide located between and optically coupling the first and second optical switches.

According to another variation, the second polarization component enters the second optical switch with a second polarization that is substantially aligned orthogonally to a first polarization of the first polarization component, and the second pair of adjacent regions is adjustable between the respective transmission and reflection modes with respect to the second polarization.

However, in another variation the second optical switch is adjustable between the transmission and reflection modes with respect to a polarization that is substantially similarly aligned to the first polarization. Therefore, according to this variation a polarization rotator is provided between the first and second optical switches and is adapted to rotate the polarization alignment of the second polarization component after it transmits across the first boundary to a first rotated polarization that is substantially similarly aligned with the first polarization. Still further to this variation, a second polarization rotator is coupled to the second optical switch and receives the second component reflecting from the second boundary in the respective reflection mode for the second boundary and to rotate the polarization alignment from the first rotated polarization to a second rotated polarization that is substantially similarly aligned with the second polarization.

In further regard to the various two-boundary/polarization rotation embodiments of the polarization independent switching aspect, either or both of the polarization rotators may be constructed of electro-optic material. In still a further regard, this combination of elements may be respectively located within and optically coupled according to a planar waveguide structure. According to additional beneficial embodiments, two or more of the first optical switch, first polarization rotator, second optical switch, and second polarization rotator may be formed within a continuous cavity in the planar waveguide structure, and in another regard may be formed from a single contiguous region of electro-optic material.

According to another highly beneficial variation of the two TIR boundary embodiment of the polarization independent switching aspect of the invention, the first and second boundaries are located within a single optical switch. The optical switch has a first region, a second region in close conjunction with the first region, and a third region in close conjunction with the second region opposite the first region. The first, second, and third regions have first, second, and third optical indexes of refraction, respectively. The first and second regions form the first pair of two adjacent regions and the second and third regions form the second pair of two adjacent regions, such that the first boundary is located at a junction between the first and second regions and the second boundary is located at a junction between the second and third regions. The optical switch is adjustable between the first and second conditions by adjusting either (i) the second optical refractive index relative to both the first and third optical refractive indexes, or (ii) the first and third optical refractive indexes relative to the second optical refractive index.

With respect to the embodiment (ii) according to this variation, each of the first and third regions comprises an electro-optic material such that the at least one electric field source is adapted at least in part to apply first and second adjustable electric fields, respectively, to the electro-optic material along the first and third regions, also respectively. In a further embodiment, the electro-optic material is also located within the second region as a continuous piece of material. Further varying this embodiment, the first and second electric fields are substantially aligned along an axis and the first and third regions are thicker than the second region relative to an axis of alignment of the first and second electric fields.

With respect to the former embodiment (i) of this variation, the second region comprises an electro-optic material and the at least one electric field source is adapted to apply an adjustable electric field to the electro-optic material along the second region. The electro-optic material may be beneficially located within the first and third regions as well as the second region, wherein the second region is thicker than both of the first and third regions relative to an axis of alignment of the first and second electric fields.

According to still a further beneficial embodiment of the polarization independent switching aspect of the invention, an optical switching assembly is provided with a plurality of the optical switching modules associated with a substrate. A plurality of input waveguides and a plurality of output waveguides are also associated with the substrate. Each optical switching module is optically coupled to one of the input waveguides and at least two of the output waveguides. The optical switching assembly according to this embodiment is adapted to selectively direct an input light signal from any one of the plurality of input waveguides to one of at least two of the plurality of output waveguides at least in part by adjusting a selected one of the optical switching modules between the respective first and second conditions.

Another aspect of the invention is an optical system having a switching array with n optical switching modules coupled to one optical combiner as follows. Each optical switching module has at least one optical switch and is adapted to receive an input light beam from a unique one of n input optical channels. Each module is adjustable between first and second conditions as follows. In the first condition the optical switching module is adapted to separate the input light beam received by the optical switching module into first and second separated light beams and also to direct the first and second separated light beams to exit the optical switching module along first and second output paths, respectively. In the second condition the optical switching module is adapted to allow the input light beam to exit the switching module along a third output path. The optical combiner is coupled to the switching array and which is adapted to combine the respective first and second separated light beams from any one of the n optical switching modules into an output light beam.

Another aspect of the invention is an optical system having first and second optical switches coupled to an optical combiner as follows. The first optical switch is adapted to selectively switch a first polarization component of an incident light beam entering the first optical switch from a first output path to a second output path while allowing a second polarization component of the incident light beam that is orthogonally aligned with the first polarization component to transmit along the first output path. The second optical switch is optically coupled to the first output path and is adapted to selectively switch the second polarization component between a third output path and a fourth output path. The combiner according to this aspect is adapted to receive the first polarization component from the first optical switch at least in part along the second output path, and also to receive the second polarization component from the second optical switch at least in part along the fourth output path. The combiner combines the first and second polarization components into an output light beam that is substantially similar to the input light beam.

Another aspect of the invention is an optical system with first and second optical switches coupled to a polarization rotator as follows. The first optical switch is adapted to selectively switch a first polarization component of an input light beam incident upon the first optical switch from a first output path exiting the first optical switch to a second output path exiting the switch while allowing a second polarization component of the input light beam that is orthogonally polarized with respect to the first polarization component to exit the first optical switch along the first output path. The polarization rotator is adapted to rotate a polarization alignment of the second polarization component along the first output path from a first polarization alignment to a second polarization alignment. The second optical switch is adapted to receive the second polarization component from the polarization rotator and to selectively switch the second polarization component in the second polarization alignment from a third output path exiting the second optical switch to a fourth output path exiting the second optical switch.

Another aspect of the invention is an optical system having an optical switch integrated into a cavity formed within a substrate. A first input waveguide and first and second output waveguides are also associated with the substrate and are respectively optically coupled to the optical switch within the cavity. The optical switch is formed within the cavity with a first region and a second region in close conjunction with the first region such that a boundary is formed between the first and second regions. An electro-optic material is located within at least one of the first and second regions and has a composition that is different than the substrate and also different than the waveguides. An electric field source is adapted at least in part to apply an adjustable electric field to the electro-optic material in the one region such that the optical switch is adjustable between a first condition and a second condition with respect to at least one polarization component of a light signal entering the optical switch from the first input waveguide and incident upon the boundary at an angle as follows.

In the first condition, the first and second regions have respective indexes of refraction such that a substantial portion of the at least one polarization component of the light signal incident upon the boundary transmits across the boundary substantially unreflected and into the first output waveguide. In the second condition, the respective indexes of refraction for the first and second regions are sufficiently different such that a substantial portion of the at least one polarization component of the light signal incident upon the boundary reflects with total internal reflection at the boundary and exits the optical switch into the second output waveguide.

According to one embodiment of this aspect, a second input waveguide is also associated with the substrate and is also optically coupled to the cavity. In the first condition a substantial portion of at least one polarization component of a second light signal entering the optical switch from the second input waveguide and incident upon the boundary transmits across the boundary substantially unreflected and exits the optical switch into the second output waveguide. In a further highly beneficial variation, the optical switch is adapted such that in the second condition a substantial portion of the at least one polarization component of the second light signal incident upon the boundary reflects with total internal reflection at the boundary and exits the optical switch into the first output waveguide. In a further regard to this embodiment in general, and in particular with respect to these variations, the optical switch and associated cavity is integrated into a 2×2 waveguide crossing region of a planar waveguide structure.

According to another embodiment of this aspect, a wavelength de-multiplexer is coupled to n optical switching modules associated with the substrate, wherein each switching module includes at least one of the optical switches that is coupled to a first input waveguide and first and second output waveguides. The wavelength de-multiplexer is adapted to receive a WDM optical signal and to separate the WDM optical signal into n wavelength channels carrying n distinct light signals, respectively, with n unique wavelength bands, also respectively, wherein n is an integer. Each optical switch is adapted to receive at least one polarization component of one of the wavelength channels along the respectively coupled first input waveguide and is also adapted to selectively switch the one wavelength channel between either one of the respectively coupled first and second output waveguides.

In one highly beneficial variation of this embodiment, the wavelength de-multiplexer is integrated with the substrate. In another variation, the wavelength de-multiplexer is physically separate from the substrate, but each wavelength channel is optically coupled to the input waveguides associated with the substrate through either free-space or a plurality of coupling waveguides.

According to another embodiment of this aspect, n retain waveguides and n drop waveguides are also associated with the substrate. Each of the n switching modules is adapted to allow at least one polarization component of each of the n wavelength channels to be selectively retained to one of the n retain waveguides or dropped to one of the n drop waveguides. The arrangement allows m drop waveguides to carry m wavelength channels, respectively, with n−m retain waveguides carrying n−m wavelength channels, also respectively, and with m retain waveguides left open without a retained wavelength channel, wherein m is in integer between zero and n.

In one variation, each retain waveguide and each drop waveguide is unitary with at least one output waveguide, respectively. In another variation, a wavelength multiplexer is coupled to each of the n retain waveguides and is adapted to combine the n−m wavelength channels from the respective retain waveguide segments into a retained wavelength multiplexed signal. The wavelength multiplexer may be beneficially integrated with the substrate, though the wavelength multiplexer may instead be physically separate from the substrate but optically coupled to each of the n retain waveguides through either free-space or a plurality of coupling waveguides.

In another beneficial variation, the optical switch assembly further comprises a plurality of add waveguides associated with the substrate and that are adapted to receive and carry a plurality of added wavelength channels, respectively. Each of the add waveguides is optically coupled to one of the n retain waveguides, and the optical switching modules are adapted to selectively couple up to m of the added wavelength channels to up to m of the retained waveguides that are selectively left open by a dropped wavelength channel.

Another aspect of the invention is an optical system that includes a substrate, an input waveguide array of n input waveguides that are associated with the substrate, an output waveguide array of m output waveguides associated with the substrate, and an optical switch assembly with a plurality of optical switches associated with the substrate. The n input waveguides are adapted to carry n distinct light signals as n distinct input optical channels, respectively, wherein n is an integer. The m output waveguides are adapted to carry m distinct light signals as m distinct output optical channels, respectively, wherein m is an integer greater than n. Each optical switch is optically coupled to an input waveguide such that a light signal carried by the input waveguide enters the optical switch, and is also optically coupled to at least two output waveguides. Each of the switches is adapted to selectively switch at least one polarization component of the light signal entering the optical switch to exit the switch into either of the at least two respectively coupled output waveguides. The plurality of optical switches are arranged with respect to the input and output waveguide arrays, respectively, such that each of the n input optical channels may be selectably directed to exit the optical switch assembly along any one of exactly n+1 of the output waveguides.

According to one embodiment of this aspect, m is equal to 2n such that the number of output waveguides and associated output optical channels m is equal to twice the number of input optical channels. In one variation of this embodiment, the optical switches are arranged such that each of the of the n input optical channels may be selectively switched to a unique one of the output waveguides, such that each optical input channel not be selectively switched to n−1 of the output optical channels. The uniquely coupled output waveguides according to a further variation are adapted to carry respectively coupled input wavelength channels as dropped channels in an add-drop multiplexing arrangement.

According to another embodiment of this aspect each optical switch comprises an electro-optic material and an electric field source. The electric field source is adapted at least in part to apply an adjustable electric field to the electro-optic material in order to adjust the optical switch between first and second conditions with respect to the at least one polarization component of the light signal entering the optical switch from a first input waveguide coupled to the optical switch. In the first condition, a substantial portion of the at least one polarization component of the light signal entering the optical switch exits the optical switch as a first output optical channel into a first output waveguide. In the second condition, a substantial portion of the at least one polarization component entering the optical switch exits the optical switch as a second output channel into a second output waveguide.

In one variation of this embodiment, each optical switch has a first region and a second region in close conjunction with the first region such that a boundary is formed at a junction between the first and second regions. The electro-optic material is located along at least one of the first and second regions, and the electric field source is adapted to apply the adjustable electric field to the electro-optic material in the one region in order to adjust the optical switch between the first and second conditions. In the first condition, a substantial portion of the at least one polarization component of the light signal incident upon the boundary transmits across the boundary substantially unreflected and exits the optical switch as the first output optical channel into the respectively coupled first output waveguide. In the second condition, a substantial portion of the at least one polarization component of the light signal incident upon the boundary reflects with total internal reflection at the boundary and exits the optical switch as the second output optical channel into the second output waveguide.

In one further embodiment of this variation, each optical switch is also optically coupled to a second input waveguide. In the first condition a substantial portion of at least one polarization component of a second input optical channel entering the optical switch from the second input waveguide as a second light signal and incident upon the boundary transmits across the boundary substantially unreflected and exits the optical switch into the second output waveguide. In a further embodiment, in the second condition a substantial portion of the at least one polarization component of the second input optical channel incident upon the boundary reflects with total internal reflection at the boundary and exits the optical switch into the first output waveguide.

Another aspect of the invention is an optical system having a wavelength de-multiplexer, an optical switching array, and a wavelength multiplexer all integrated with a waveguide array in a single planar waveguide substrate, which in particular may be a SiO₂/Si substrate.

Another aspect of the invention provides an optical system with an optical switch and an interfacing waveguide array. The optical switch has at least one bottom face, n side walls, and at least one top face opposite the at least one bottom face with respect to the n side walls. The switch is adapted to receive at least one input light beam incident upon the optical switch along a first optical path and is adjustable as follows. In a first condition, the input light beam is allowed to exit the optical switch along a second optical path exiting the optical switch. In a second condition at least one polarization component of the input light beam is directed by the optical switch to exit the optical switch along a third optical path. The waveguide array includes not more than n−2 waveguides optically interfaced with the optical switch along not more than n−2 of the side walls. A first waveguide of the array is optically coupled to the first optical path. A second waveguide of the array is optically coupled to the second optical path. A third waveguide of the array is optically coupled to the third optical path. In one embodiment of this aspect, the switch has 6 walls in a substantially hexagonal shape. In another embodiment, the switch has 8 walls with a substantially octagonal shape. In a further embodiment, the optical switch comprises an electro-optic material with an electrical field source adapted at least in part to apply an electric field to the material.

Another aspect of the optical system of the invention provides a substrate with a cavity formed therein and a plurality of waveguides formed within the substrate and that are interfaced with the cavity in a particular arrangement. The cavity has n side walls within the substrate, and is further defined by first and second boundary regions located opposite each other with respect to the n side walls. Not more than n−2 of the waveguides are interfaced with the cavity along not more than n−2 of the side walls. In one embodiment of this aspect, the cavity has 6 walls in a substantially hexagonal shape. In another embodiment, the cavity has 8 walls with a substantially octagonal shape.

Another aspect of the optical system of the invention provides a substrate with a switch assembly having a plurality of optical switch modules as follows. Each module has at least one optical switch associated with the substrate, and is adapted to optically couple to a unique optical input channel carrying a unique input light beam and also to optically couple to a unique optical output channel. Each optical switch module also has an optical switch that is constructed at least in part from a material having an adjustable optical refraction index in the presence of an applied energy field. The switch assembly is adapted to selectively direct an input light beam from any one of the plurality of optical input channels to any one of the plurality of optical output channels by adjusting the respective index of refraction of at least a selected one of the optical switches and without regard to a polarization of the input light beam.

Another aspect of the optical system of the invention provides a substrate, an electro-optic material, an electric field source, and a coating, in a particular arrangement as follows. The substrate has a surface that defines at least in part a cavity. The electro-optic material is located within the cavity. The electric field source is adapted at least in part to apply an electrical field to the electro-optic material within the cavity. The coating is located at least in part between electro-optic material and the surface, and is a mixture of a second material that is different than the electro-optic material and a third material that is different than the electro-optic material and also the material. In one beneficial variation, the coating comprises a mixture of a second material that has a different composition than the electro-optic material and a third material that has a different composition than either the second material or the electro-optic material.

A still further aspect of the optical system of the invention provides a substrate, an electro-optic material, and a coating as follows. The substrate is constructed of silica and silicon. A cavity is formed within the substrate such that a surface of the substrate borders the cavity. The electro-optic material is formed within the cavity by beat processing an electro-optic precursor material within the cavity at sufficient temperature that generally causes migration of SiO₂ from the substrate into the cavity. The coating is located at least in part between the electro-optic material and the surface of the cavity, such that the electro-optic material is substantially free from silica contamination. In one particular variation, the electro-optic material is formed by heating the precursor material generally at least at 600 degrees C.

A further beneficial embodiment of either of these optical system aspects providing a coating within a substrate cavity, the second material comprises a relatively electrically conductive material, and the third material comprises an electrical conductivity neutralizing agent. The coating according to this embodiment does not substantially inhibit an application of an electric field to the electro-optic material.

According to another beneficial embodiment, the coating comprises a material that is selected from the group consisting of MgO, Al₂O₃, ZrO₂, TiO₂, ITO (Indium Tin Oxide), or combinations and blends thereof. In a particularly beneficial embodiment, the coating comprises a mixture of ITO and Al₂O₃. In a further variation to this embodiment, the electro-optic material comprises a PLZT material.

Another aspect of the optical system of the invention provides a substrate with waveguides formed therein, and a plurality of optical components arranged as follows. The substrate has a cavity formed therein, and two of the waveguides are optically coupled to and are separated by an optical path through the cavity. Each of the plurality of optical components is located within the cavity and along the optical path between the two waveguide segments. Each optical component is also adapted to influence at least one aspect of an input light beam from one of the waveguides incident upon the cavity such that an exit light beam that is different from the input light beam exits the cavity into the other interfacing waveguide.

Another aspect of the optical system of the invention provides a plurality of optical components that are constructed at least in part from a portion of a substantially continuous material that defines an optical path. The material is of a type that is adjustable in order to influence at least one aspect of a light beam propagating through the material when an energy field is applied to the material. Each optical component further incorporates an energy field source that is adapted at least in part to apply an energy field to the material within the respective optical component. Each optical component is aligned with respect to the other optical components such that each component acts upon at least one aspect of a light beam propagating through the material along the optical path.

The invention also include various method aspects as follows:

One method aspect of the invention is a method of manufacturing an optical switching structure. The method according to this aspect includes: providing a substrate with a first input waveguide, a first output waveguide, and a second output waveguide; forming an cavity within the substrate such that the first input waveguide and first and second output waveguides are each respectively optically coupled to the cavity; and forming an optical switch within the cavity, wherein the optical switch is adapted to switch a light signal entering the optical switch from the first input waveguide at the first location to exit the optical switch either into the first output waveguide or into the second output waveguide.

One highly beneficial embodiment of this method includes forming the optical switch within the cavity at least in part by placing a material within the cavity that has an index of refraction that changes in the presence of an applied energy field. A further variation of this embodiment includes placing a precursor material within the cavity and heat treating the precursor material to form the material. In still a further and particularly beneficial variation, the precursor material is provided as a sol-gel substance.

In another embodiment of this method aspect, an electro-optic material is placed into the cavity in order to form the switch. In a further regard, at least one electrode is positioned in close association with the electro-optic material such that an electric field may be applied to the electro-optic material within the cavity when a voltage is applied between the electrode and another electrode. In one variation, the electrode is provided along at least one wall of the substrate that defines at least in part the cavity. In a further variation, a second electrode is provided opposite a first electrode along an axis with the electro-optic material between the electrodes along the axis. In still a further variation, the at least one electrode is positioned along a bottom surface of the cavity such that the electrode is covered by the electro-optic material when placed within the cavity. This allows a second electrode to be placed on a top surface of the electro-optic material such that an electric field in the material between the electrodes is substantially transverse to an optical axis of the respectively coupled waveguides.

In a further variation to the electro-optic material embodiment of this aspect, a step is formed in the electro-optic material within the cavity such that one region of the electro-optic material has a first thickness relative to an axis within the cavity and another adjacent region of the electro-optic material has a second thickness within the cavity relative to the axis that is less than the first thickness.

In another variation, a second material is placed within the cavity that has a different composition than the electro-optic material. Further to this variation, the electro-optic material forms a first region and the second material forms a second region within the cavity that is in close conjunction with the first region such that a TIR switching boundary is formed at the junction between the first and second regions. A further embodiment of this variation includes forming the second material by combining a volume of the electro-optic material with another material such that the resting index of refraction of the second material substantially matches the resting index of refraction, but further such that the second material is less electro-optically active than the electro-optic material alone in the first region and an applied electric field to the first region provides a TIR boundary at the junction of the regions with respect to the incident light signal.

In a highly beneficial further embodiment of this variation, the electro-optic material is a PLZT material, and the second material is formed by combining the volume of PLZT material with the other material. Still further, and highly beneficial, the other material is a silica based material.

Another method aspect of the invention is a method for constructing an optical system as follows. A substrate is provided that is constructed of at least one of silica and silicon. The method includes forming a cavity within the substrate, filling the cavity at least in part with an electro-optic precursor material, heating the electro-optic precursor material within the cavity to at least 600 degrees C, and substantially preventing migration of silica into the electro-optic material while the electro-optic material is being heated.

Another method aspect of the invention is a method for constructing an optical system by providing a substrate comprising at least one of silica and silicon, forming a cavity within the substrate such a surface of the substrate forms a cavity wall that defines at least in part the cavity, coating the cavity wall with a mixture of a first material and a second material, and filling the cavity at least in part with an electro-optic material having a different composition than the first material, the second material, or the mixture.

Another method aspect of the invention is a method for making an optical system by: providing a substrate comprising at least one of silica and silicon, forming a cavity within the substrate such a surface of the substrate forms a cavity wall that defines at least in part the cavity, and applying a coating to the cavity wall that comprises a mixture of a first material that is substantially electrically conductive and a second material that substantially neutralizes the electrical conductivity of the mixture. The method is performed such that the cavity may be filled at least in part with a third material such that the coating is between the third material and the cavity wall. In one particular embodiment of this aspect, the coating is transparent or transmissive with regard to a light beam entering the cavity. In another embodiment the coating is substantially non-electrically conductive.

Still another method aspect of the invention is a method for making an optical system by: forming a cavity within a substrate such a surface of the substrate forms a cavity wall that defines at least in part the cavity, applying a coating to the cavity wall that comprises a first material selected from the group consisting of MgO, Al₂O₃, ZrO₂, TiO₂, Indium Tin Oxide (“ITO”), and combinations and blends thereof, and filling the cavity at least in part with an electro-optic material having a different composition than the coating or the first material.

Additional highly beneficial further embodiments of the particular optical system and method aspects just described include the following features, which are not considered limiting to the beneficial broad scope of the aspects previously described, but which are considered preferred features whose combinations with the broader descriptions constitute additional modes of the invention.

One such embodiment in particular provides the various optical switches, switching modules, or associated cavities within a substantially planar substrate. In one beneficial variation, the planar substrate is a SiO₂/Si planar waveguide array. In another particularly beneficial variation, these various optical switching elements are formed within a “free-space” cavity in the substrate that is optically coupled to various input and output waveguides in the substrate.

Another such beneficial embodiment includes providing the various optical systems, switches, and modules with an electro-optic material. An electric field source is associated with the electro-optic material in order to adjust the index of refraction of the material and thereby influence the direction of light coupled to the material. In particularly beneficial variations, the electro-optic material may be any one or more of the following types of materials: a solid material, a non-poled material, a ceramic material, a polycrystalline material, a non-ferroelectric material, a cubic material, a relaxor material, a material that reduces its index of refraction in the presence of an applied electric field, or combinations or blends thereof. In a further beneficial variation, the electro-optic material is a PLZT material. Still of particular benefit, the PLZT material has a lanthanum concentration of between about 8.5% and about 9.0% by atomic percent.

Another such beneficial embodiment of the optical switching elements of the various aspects allows the light signal being switched to enter the optical switch as a light beam that is not guided and projects onto the boundary. In a further highly beneficial variation, this “free space” switch is coupled to the incident light signal and output light paths or channels via waveguides, and still more beneficially is integrated with a planar waveguide array. In another beneficial variation, a collimator is coupled to an input light source in order to substantially collimate the light signal as it enters a respective “free-space” optical switch or module as a projected light beam.

Other such beneficial embodiments of the TIR boundary-based switching aspects relate to the location of the electro-optic material with respect to at least one polarization component of an incident light beam. According to one such embodiment, the electro-optic material is located within the first region, and the respective electric field source is adapted to apply the adjustable electric field to the electro-optic material in the first region in order to adjust the respective optical switch between the respective first and second conditions with respect to the at least one polarization component of the light signal entering the optical switch in the respective first region.. In an alternative variation, the electro-optic material is located within the second region, and the electric field source is adapted to apply the adjustable electric field to the electro-optic material in the second region in order to adjust the optical switch between the respective first and second conditions with respect to the at least one polarization of the light signal entering the respective optical switch in the respective first region.

Still other such beneficial embodiments of the TIR boundary-based switching aspects relate to the type of electro-optic response in the electro-optic material in relation to the applied electric field in the respective electro-optic material. According to one such embodiment, the electro-optic material has an index of refraction that increases with the applied electric field with respect to the one polarization component of the light signal. According to another such embodiment, the electro-optic material has an index of refraction that decreases with the applied electric field with respect to the one polarization component of the light signal. Each of the increasing or decreasing refractive index type of electro-optic material provides unique benefits with respect to electro-optic activity in the first region or the second region with respect to a light signal entering the first region.

Yet further such beneficial embodiments for the TIR boundary-based switching aspects relate to the type of electro-optic response in the electro-optic material in relation to the applied electric field and the polarization of the light signal being switched. According to one such embodiment, the applied electric field is substantially aligned with a polarization of the one polarization component being switched at the boundary. In another embodiment, the applied electric field in the responding material is aligned substantially orthogonal to a polarization of the one polarization component. Each of the field aligned or orthogonally aligned types of electro-optic responses provides a unique benefit with respect to desired electro-optic activity in the first region or the second region, and further with respect to increasing or decreasing change in the index of refraction of the material.

According to still another such beneficial embodiment of the TIR boundary-based switching aspects, the electric field source includes first and second electrodes that are separated the electro-optic material along an axis in the one region such that an electro-optic response to the applied electric field is substantially localized within the electro-optic material between the electrodes in the one region. In a particularly beneficial variation, a substantially localized electric field within the electro-optic material along the axis between the electrodes is substantially aligned with the boundary. In another variation, the one region being electro-optically activated is thicker than the other of the first and second regions with respect to the axis. In another variation, a second material is provided in the other of the first and second regions having a different composition than the electro-optic material. A further beneficial embodiment of this variation provides the second material as the electro-optic material in combination with another material such that an electro-optic response to an applied electric field in the second material of the other region is less than an electro-optic response in the electro-optic material of the one region.

One further beneficial embodiment of the coating method aspects of the invention includes applying the coating by forming a liquid mixture of a relatively electrically conductive material with an electrical conduction neutralizing agent, applying the liquid mixture to the surface, and curing the liquid mixture to a substantially solid mixture form that is substantially secured to the surface. One further variation includes forming the liquid mixture in an alcohol based solution. A beneficial further variation includes forming the liquid mixture by mixing ITO in an alcohol based solution with Al(NO₃)₃ also in an alcohol solution, wherein the Al(NO₃)₃ may be in a hydrated form.

Another such beneficial embodiment of the method aspects that apply a coating to a substrate cavity ancillary to forming an electro-optic component within the cavity includes providing an electro-optic precursor material in a non-solid form, filling the cavity at least in part with the electro-optic precursor material in the non-solid form, and treating the electro-optic precursor material to form the electro-optic material in a substantially solid form within the cavity.

Another beneficial embodiment of the method aspects that coat a substrate cavity in order to form an electro-optic element within the cavity further includes depositing PLZT as the electro-optic material within the cavity and onto the coating. In one highly beneficial variation, the PLZT is provided in the cavity with a lanthanum concentration of between about 8.5% and 9.0% on an atomic percent basis.

Another highly beneficial embodiment of the method aspects that coat substrate cavity in order to form an electro-optic element in the cavity includes forming an optical switch at least in part constructed of the electro-optic material within the cavity without poling the electro-optic material.

Another highly beneficial embodiment of the method aspects for coating a respective substrate cavity includes providing the coating as a mixture of ITO and Al₂O₃.

Still a further beneficial embodiment of the coating methods includes providing the respective substrate with at least one waveguide formed therein, and forming the cavity such that the waveguide is optically coupled to the cavity along the cavity wall.

The invention further provides additional embodiments to the optical system, switch, and method aspects just described, as is established by the detailed description of the embodiments that follows or the claims appended hereto.

The various aspects just described present numerous advantages in advancing the various objects of the invention.

An advantage of the present invention is that the optical switches of the various aspects may be operated with TTL voltages or lower.

Another advantage of the invention is that the optical switches of the various aspects have relatively low voltage requirements for operation, and therefore heating of the elements is reduced and requirements for cooling are minimized.

Yet another advantage of the present invention is that very small elements such as switches may be produced, thus allowing for planar waveguide array integration.

A further advantage of the present invention is that cross-talk between channels such as the switch-coupled waveguides is very limited.

A yet further advantage of the present invention is that sol-gel processes can be used to create arrays very efficiently, scalably, and inexpensively.

Still another advantage of the present invention is that the switches can be very rapidly switched, with switching times on the order of picoseconds (10⁻¹² seconds).

Yet another advantage of the present invention is that sol-gel processes can be used to make micro-structures for integrating into substrate-based array platforms for applications such as telecommunications, information storage or transfer, printing and/or displays. These molding processes are easily scalable and can produce arrays with large numbers of elements quickly and for very low cost.

Another advantage allows for solid state switching of polarized optical signals having unknown orientation.

Another advantage allows for a solid state TIR switch to be incorporated into a planar waveguide optical cross-connect array for rapid, reliable switching of input channels between various output channels without the use of moving parts, without the use of localized, high thermal gradients, and without the need to reliably and controllably contain any fluid.

Another advantage allows for a rapid and reliable solid state OADW add-drop system.

These and other objects and advantages of the present invention will become clear to those skilled in the art in view of the description of various known modes of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a perspective view of a system for modulating and switching light beams that uses a light modulating array, showing the modulation of impinging light beams;

FIG. 2 is a perspective view of a modulator array, and electrical circuit showing an alternative location for conductive pads;

FIG. 3 is a perspective view of a modulator array, and electrical circuit showing the elements mounted on a substrate of different material;

FIG. 4 is a perspective view of a modulator array and electrical circuit in which electrodes have been attached to the top and bottom wafer surfaces;

FIG. 5 is a perspective view of a modulator array and electrical circuit showing an alternate location for conductive pads;

FIG. 6 is a perspective view of an alternate embodiment of a modulator array and electrodes;

FIG. 7 is a perspective view of another alternative embodiment of a modulator array and electrodes;

FIG. 8 is a perspective view of system for modulating and switching light beams that uses a modulator array and beam splitters to separate modulated and unmodulated beams into different channels;

FIG. 9A is a plan view of a single optical element for use in a modulator array that has two bordering regions and an electroded electro-optic material along the first region to form of a selective TIR boundary between the regions in order to modulate a light beam entering the first region such that the light beam may exit the element along different output paths or channels;

FIG. 9B is a plan view of another optical element with two bordering regions and an electroded electro-optic material along the second region to form a selective TIR boundary between the regions in order to modulate a light beam entering the first region such that the light beam may exit the element along different exit paths or channels.

FIGS. 9C-G show schematic graphs that illustrate the relative optical refraction indexes for certain distinct modes of electro-optic activity variously along the first and second bordering regions, respectively, of a TIR switch such as according to the structure shown in FIG. 9A, with respect to the graphs in FIGS. 9C-E, or according to the structure shown in FIG. 9B, with respect to the graphs in FIGS. 9F-G.

FIG. 10 is a perspective view of a system for modulating and switching light beams that shows a single element of a different version of a modulator array used as an alternate mechanism for separating modulated and unmodulated beams into different channels;

FIG. 11 is a perspective view of a modulator array in which electrodes have been placed so as to produce an electric field that is collinear with the direction of light propagation;

FIG. 12 is a cross-sectional view of an embedded electrode array in a sol-gel matrix of electro-optic material;

FIG. 13 is a front perspective view of a single optical switch of the present invention;

FIG. 14 is a front perspective view of the single optical switch of FIG. 13, from which the upper electrode has been removed for easier viewing, the switch being in an inactive state;

FIG. 15 is a front perspective view of the single optical switch of FIG. 13, from which the upper electrode has been removed for easier viewing, the switch being in an active state;

FIG. 16 is a front perspective view of an alternative embodiment of a single optical switch of the present invention that has improved flatness and uniformity of TIR boundary;

FIG. 17 is a front perspective view of an optical switch having electrodes placed on the side walls of the element.

FIG. 18A is a top plan view of an array of optical switches configured as a cross-connect switch in which two upper and lower input signals cross to exit from output channels; and

FIG. 18B is a top plan view of an array of optical switches configured as a cross-connect switch in which two upper and lower input signals exit from upper and lower output channels without crossing.

FIG. 19A shows a top plan view of a planar waveguide array with waveguide crossing regions according to one construction that is adapted to incorporate the optical elements of the present invention.

FIG. 19B shows a top view of a TIR switch in a cavity formed at a waveguide cross-connect region, and shows the waveguide crossing angle by reference to the plane of the TIR boundary of the switch.

FIG. 19C shows a graphical view of waveguide crossing angle versus insertion loss and channel isolation, respectively, according to one particular group of chosen parameters for a TIR switch in a waveguide cross-connect region.

FIG. 20A shows a schematic view of a polarization independent optical switching module using two different polarization dependent TIR switches and a recombiner.

FIG. 20B shows a schematic view of another polarization independent optical switching module using two similar polarization dependent TIR switches, two polarization rotators, and a recombiner.

FIG. 21A shows a top plan view of a portion of a polarization independent optical switching module similar to that shown schematically in FIG. 20A, and shows two different polarization dependent TIR switches incorporated into a planar waveguide structure.

FIG. 21B shows a cross-sectioned view taken along line 21B-21B through a first TIR switch shown in FIG. 21A.

FIG. 21C shows a cross-sectioned view taken along line 21C-21C through the first TIR switch shown in FIG. 21B.

FIG. 21D shows a cross-sectioned view taken along line 21D-21D through a second TIR switch shown in FIG. 21A.

FIG. 21E shows a cross-sectioned view taken along line 21E-21E through the second TIR switch shown in FIG. 21A.

FIG. 22 shows a top plan view of a portion of another polarization independent optical switching module similar to that shown in FIG. 20A, and shows two different polarization dependent TIR switches incorporated into a planar waveguide structure in a configuration similar to that shown in FIG. 21A, except that the TIR switches are integrated and adjoined to each other in a single, contiguous “free-space” cavity of the planar waveguide structure.

FIG. 23A shows a top plan view of a polarization independent optical switching module of the type depicted in FIG. 20B without the combiner, and shows two similar polarization dependent switches and two polarization rotators integrated into a common contiguous free-space cavity region formed in a planar waveguide structure.

FIG. 23B shows a longitudinally cross-sectioned view taken along lines 23B-23B shown in FIG. 23A.

FIG. 23C shows a transverse cross-sectional view taken along lines 23C-23C shown in FIG. 23A.

FIG. 24 shows a top plan view of another optical switching module similar to that shown in FIG. 23A except that the geometry of the “free-space” cavity in which the electro-optical components of the module reside is modified to reduce the total area of filled material that is integral with the electroded electro-optical regions.

FIG. 25 shows a top plan view of a TIR switch located within a cavity in a planar waveguide structure, and shows the cavity having another geometry that is configured to reduce unnecessary material regions integral with the operative switch material.

FIG. 26A shows a top plan view of a TIR switch having three regions that include two electroded, electro-optic regions on either side of a non-electroded intermediate region, and further shows various transmission and reflection modes for input light beams incident on either of the two electroded, electro-optic regions.

FIG. 26B shows a transverse cross-sectional view taken along line 26B-26B in FIG. 26A, and shows a groove formed along the intermediate region at the top of the structure such that the intermediate region is not bordered by a top electrode and further such that the intermediate region has a narrower thickness than the two bordering, electroded electro-optic regions.

FIG. 26C shows a transverse cross-sectional view similar to that shown in FIG. 26B, except showing an additional bottom groove along the intermediate region such that the intermediate region is further narrowed with respect to the two bordering electroded, electro-optic regions, and further such that the intermediate region is not bordered by either a top electrode or a bottom electrode.

FIG. 26D shows a transverse cross-sectional view taken through another TIR switch with three bordering regions according to the invention, and shows an intermediate, electroded region of electro-optic material located between two opposite regions that are less thick than the intermediate region and that are not electroded for electro-optic activation.

FIG. 26E shows cross-sectional view taken through two substantially parallel boundaries between adjacent regions of a TIR switch similar to that shown in FIG. 26C, and schematically shows two orthogonal polarization components of an incident light beam that reflect with TIR at different ones of the boundaries.

FIG. 27 shows a schematic, top plan view of a planar waveguide structure with a waveguide cross-connect pattern incorporating an array of TIR switches and other optical components in various different configurations that provide alternative polarization independent switching modules according to the invention.

FIG. 28 shows a schematic, top plan view of a planar waveguide structure similar to that shown in FIG. 27, and shows the switched planar waveguide structure interfaced with a wavelength demultiplexor in an arrayed waveguide structure, an output wavelength multiplexor in an arrayed waveguide structure, and an add/drop interface with a remote channel destination.

FIGS. 29A-C show various schematic illustrations of certain specific switching architecture examples that are adapted to incorporate various of the TIR switches and modules according to the invention.

### DETAILED DESCRIPTION OF THE INVENTION

A preferred embodiment of the present invention is an array of light modulating and switching microstructure devices. In one regard, the present invention solves many of the problems of the prior art by using lanthanum doped lead zirconate titanate crystal (PLZT), which is an optically transparent ceramic that becomes birefringent when proper voltage is applied. PLZT, in particular with respect to the formulations herein described below, exhibits a quadratic electro-optic response to voltage increase thus allowing lower driving voltages. In addition, the present invention uses an optimized compositional “recipe” in which the proportion of lanthanum dopant and matrix elements has been designed to produce low dielectric constant κ, higher electro-optic efficiency, and thus low power requirements. Additionally, the electro-optic elements are 3-dimensional and of very small size, generally 10 μm-200 μm in the light propagation direction, or much less, depending on the design. This allows production of very highly confined and intense electric fields in these elements by using small voltages, including TTL levels of approximately 5 volts, and lower. This has advantages because power supplies that are already set up for TTL level digital components can supply the electro-optic modulators as well. Cross-talk has been nearly eliminated by the use of grooves or regions that are filled with air or other dielectric materials. These physically separate at least a portion of the elements, thus directing and channeling electric field lines more closely. PLZT, as well as other electro-optic materials, also allows for pico-second response time, thus allowing very high switching frequencies that can be greater than about 10 GHz, though in certain applications may generally be between about 1 GHz and about 10 GHz.

The use of embedded electrodes produces more uniform electric field strength in the elements. This allows a much lower driving voltage and a much more predictable and controllable electric field.

The present invention is also useful when using standard recipe electro-optic materials, in which the dielectric constant has not been minimized, and also in a variety of other electro-optic materials beside PLZT. Electro-optic materials in one regard may be generally classified into at least the following categories, 1) electro-optic crystals, 2) polycrystalline electro-optic ceramics, 3) electro-optically active polymers, 4) electro-optic semiconductors, 5) electro-optic glasses, and 6) electro-optic liquid crystals. Although the electro-optic properties of the materials are variable depending on composition, various aspects of the present invention can be implemented with materials of any of these categories. Specific examples of electro-optic materials besides PLZT which may be used variously according to the embodiments include, but are not limited to, LiNbO₃, LiTaO₃, BSN, PBN, KTN, KDP, KD*P, KTP, BaTiO₃, Ba₂NaNb₅O₁₅, GaAs, InP, CdS, AgGaS₂, and ZnGeP₂. The very small dimensions of the elements result in very low element capacitance even when using material having a relatively large dielectric constant κ. It is to be understood however that certain specific beneficial aspects of the invention as herein described may be more applicable to, or in the alternative more limited with respect to, certain of these materials than with others.

Notwithstanding such substitute materials, however, PLZT provides several features which are believed to be particularly well suited for the embodiments as provided hereunder; as such, PLZT is also illustrative of various broader classes of materials as follows. In one regard, PLZT is inorganic. In another regard, PLZT forms a polycrystalline structure. In still a further regard, PLZT according to certain formulations, including in particular those herein described, is generally a non-ferroelectric material, at least in a resting condition. More particularly, such PLZT formulations are considered to fall within a class of “relaxor” materials that generally possess a substantially cubic and symmetric structure that exhibits substantially low hysteresis with respect to material polarization vs. applied electric field. However, certain such cubic PLZT relaxor structures are also observed to exhibit generally ferroelectric behavior in the presence of an applied electrical field. Moreover, certain cubic PLZT relaxor materials are also substantially non-polable, and may be provided in a substantially non-poled condition according to various of the electro-optic components herein disclosed.

Each of these material features just described provides a benefit in manufacturability and/or functionality that is believed to be particularly useful according to the optical components herein described, and in particular with respect to the TIR switching embodiments herein described. Therefore, each of these material features as applied to the optical systems described herein is considered an independently beneficial aspect of the invention; the various combinations and sub combinations of these features similarly applied to the embodiments are further contemplated as additional beneficial aspects of the invention.

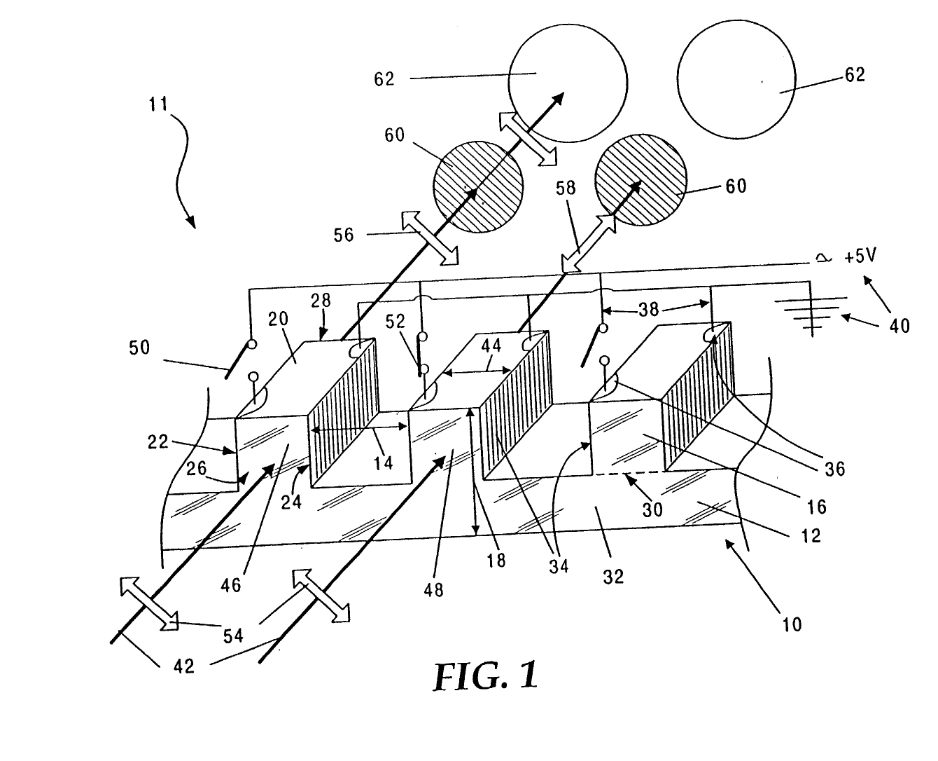

As illustrated in the various drawings herein, and particularly in the view of FIG. 1, a form of this preferred embodiment of the inventive device is depicted by the general reference character 10.

FIG. 1 illustrates an array of light modulating microstructures 10 as well as a system 11 for modulating or switching light in a number of independent channels. In this preferred embodiment, the array 10 is formed from a wafer 12 of PLZT. PLZT has been chosen for its large electro-optic effect and low absorption for thin wafers.

If PLZT is used, the relative proportion of the Lanthanum dopant in the ceramic can be very important in determining the driving voltage required for the elements. The composition also is important in establishing the optical properties such as transparency, grain size and pore size, speed, power dissipation, operating temperature and for maximizing both the linear and the quadratic electro-optic coefficients of the material. Commercial recipes for PLZT have largely used Lanthanum concentrations of 9.0% to 12% (generally by atomic percent). If Lanthanum concentration is varied in the range of 8.5% to 9.0% of the PLZT ceramic and the concentration of Zirconium and Titanium generally fall within the respective ratio of 65/35, it may be possible to achieve a higher quadratic electro-optic coefficient (R) in the PLZT for the La dopant percentage closer to 8.5%. For the PLZT compositions, where Zr and Ti are maintained in a 65/35 ratio and the overall percentage of La is varied:

La=9.5%, R=1.5×10⁻¹⁶ m²/V²;

La=9.0%, R=3.8×10⁻¹⁶ m²/V².

It is known that for La<8.0%, PLZT loses quadratic electro-optic properties. It is therefore expected that somewhere around 8.5% La there should be a maximum for R around (5-40)×10⁻¹⁶ m²/V².

This enhanced value of electro-optic coefficient provides many advantages. It will permit lower required driving voltages, and thus lower power dissipation in the material and hence lower heating of the device. This in turn allows the device to be driven at significantly higher frequencies, even without external cooling. Also, the use of lower La concentrations (which is a free electron donor) will result in a reduced “charge screening” effect. The overall result is higher modulation efficiency of devices manufactured from this material.

The wafer 12 has regions or grooves 14 formed to produce protrusions 16 from the original thickness 18 of the wafer 12. The grooves 14 may be formed by any number of means, such as mechanical machining with micro-saws, chemical etching using photo-resist masks, or laser ablation, or the array may be molded in shape from polycrystalline ceramic, among other methods. The grooves 14 provide isolation between the channels of the array 10, serve to direct and channel the electric field lines in the electro-optic material and thus allow the array to operate with nearly zero cross-talk.

Each protrusion 16 has a top face 20, a first side face 22 and a second side face 24, a front face 26 and a rear face 28. The grooves 14 can be cut through the entire original thickness 18 of the wafer 12, in which case, the protrusions will have an independent bottom face 30, or if the groove is not cut through the entire original thickness 18, the bottom face 30 will be integral with the wafer 12, as shown by the dotted line in FIG. 1.

The faces of the wafer 32 can be polished either before or after the grooves 14 are formed, to prevent scattering of light entering or leaving the wafer 12. Electrodes 34 are attached to the protrusions 16 by any of a number of ways, but one preferred method is to embed the electrodes 34, as this may produce a more uniform electrical field. It is also possible that the material of the electrode 34 may completely fill the grooves 14. Conductive pads 36 of gold or some other metal or conductive material are used to attach electrical leads 38 to the electrodes 34, which connect them in turn to the electrical power supply 40. An electrical field is thus established which is oriented in a transverse direction relative to the direction of the incoming light beams 42. The width of electro-optic material between the grooves 14 in the protrusions 16 establishes the electrode gap 44 in this configuration of electrode 34 placement.

For ease of reference, an assembly containing a protrusion 16, attached electrodes 34, and conductive pads 36 shall be referred to as an “element”. The size of the wafer 12, the protrusions 16 and the electrode gaps 44 will depend on the material chosen, and the desired range of applied voltages to be used. The electro-optic effect exhibited by an element of a particular material depends on the electric field strength within that element. The density of that field will in turn depend on the amount of applied voltage, the material chosen, and the physical dimensions of the element in which the electric field is contained. Using very small elements allows a large concentration of electric field density by use of small to moderate voltages. In the present invention, in order to use voltages in the TTL range, around 5V, it is estimated that the physical size of the elements, if made of PLZT, will be on the order of 20 μm×20 μm×200 μm. The grooves 14 can be made very small, and indeed may be limited by the size of machining tools used to form them. Excellent results in terms of near zero cross-talk have been achieved using micro-sawing methods where the kerf size of the saw cuts are around 25 μm. Effective reduction of cross-talk between channels may be achieved with grooves as small as 5 μm.

Such tiny elements can produce modulated beams of very small size, producing such fine image resolution that the unaided eye is incapable of distinguishing it. It may have applications where microscopic images are required, or where multiple beams are combined in groups of 5 or 10 elements to make up 1 pixel in a display device.

The size of the elements will also depend on whether the beam is transmitted through the element or reflected from a rear surface, in which case, the length or the driving voltage can be cut roughly in half to produce the same degree of modulation. Materials with smaller electro-optic properties may require greater size or increased applied voltage to achieve proper modulation results.

In FIG. 1, a first element 46 and a second element 48 are shown, which in this preferred embodiment, will be assumed to be composed of PLZT. Between the first element 46 and the voltage supply line, an open switch 50 is shown to represent that the element 46 has no voltage applied, and is in an inactive state. It is, of course, to be understood that nothing so primitive as throw-switches need be used to practice the invention. Most likely, very high frequency (perhaps as much as 100 GHz or more) square waves of appropriate voltage will be used, but throw-switches are used here as an easy means of illustrating the state of the applied voltage.

The incoming light beams 42 having incoming linear polarization 54 which is aligned with the upper tip 45 degrees to the left of vertical, (which shall be referred to as “R” polarization) impinge on both elements 46 and 48. This incoming light may be linearly polarized laser light, or it may be initially unpolarized light, perhaps even including light from an incandescent bulb, which has been transmitted through a polarizer to produce linearly polarized light. First element 46 is inactive, thus the outgoing polarization 56 of the first element 46 is unchanged. It passes through an R aligned polarizer 60 and is detected by a light sensor or photo detector 62, perhaps to be recognized as a digital “1”.

In contrast, switch 52 is closed leading to the second element 48, thus the supply voltage is applied and the element 48 is active. The element 48 becomes birefringent under the influence of the applied electric field. Birefringence causes an incoming beam 42 that is linearly polarized at a 45 degree angle relative to the direction of the applied electric field to split into two orthogonal components which are respectively parallel and perpendicular to the electric field lines. These components travel along the same path but at different velocities. The electro-optic effect thus will cause a phase shift between the two components, as one is retarded in relation to the other. After traveling through the element 48, the components re-combine with the result that the polarization of the emergent beam 58 is changed. If the voltage is sufficient to cause a λ/2 shift in polarization, the polarization will be rotated by 90 degrees, relative to its original orientation. In FIG. 1, it is assumed that a λ/2 voltage of 5 volts has been applied which produces a 90 degree phase shift to give a linearly polarized output beam 58, which is oriented with the upper tip now 45 degrees to the right of vertical (which shall be referred to as “S” polarization). This S polarized light is now blocked by the R aligned polarizer 60, which allows no light to reach the detector 62. This may be recognized by a digital device as a “0”.

If the applied voltage causes a λ/4 rotation, the outgoing polarization 58 will be made into circular polarization, as the tip of the resultant electric field vector will describe a circle as it propagates. Intermediate voltage values will result in elliptical polarization. These will be incompletely blocked by the polarizer 60, which will allow only the R aligned component to pass. Thus, the light seen by the detector 62 may be theoretically controlled anywhere in the range from undiminished incoming intensity to total extinction, to produce analog-type output signals if the appropriate control voltage is applied.

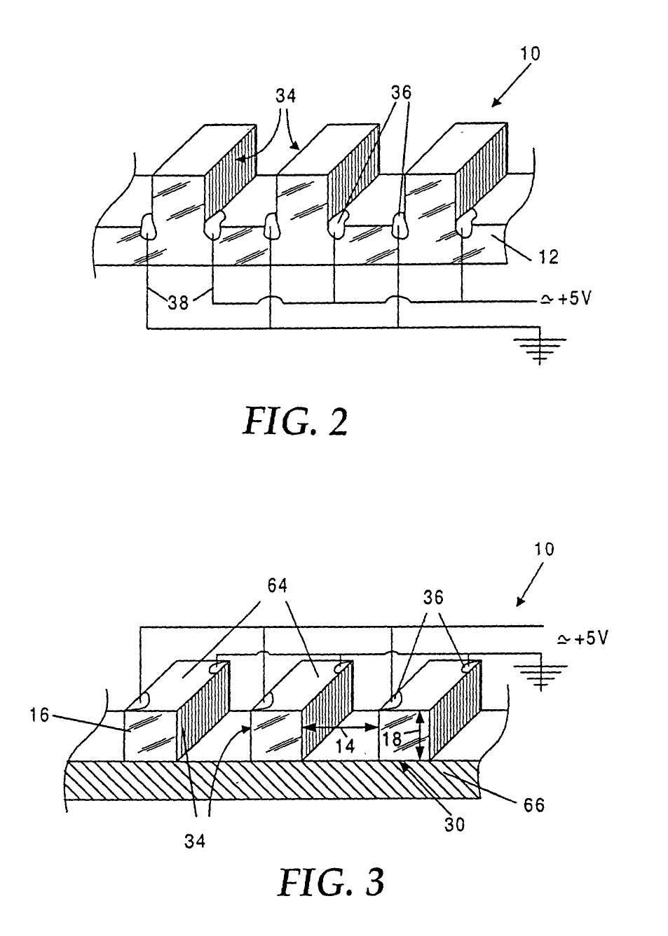

FIG. 2 illustrates a different version of the modulator array 10. A wafer 12 is shown with attached or embedded electrodes 34, and in this embodiment, the conductive pads 36 are located in a different configuration for attachment to electrical leads 38.

FIG. 3 illustrates another version of the modulator array 10, in which the grooves 14 have been extended completely through the original thickness 18 of the wafer. The elements 64 here are composed of the protrusion 16 portions of the wafer 12 and their respective attached or embedded electrodes 22 and conductive pads 24 (see FIG. 1). A number of elements 64 have been formed on a substrate 66 made from a different material that the bottom faces 30 now contact. This substrate 66 is preferably a low dielectric material that is not electro-optically active, such as SiO₂, for one example among many. The protrusions 16 may be attached or glued to the substrate 66 prior to machining or attachment of the electrodes 34 and pads 36, or the completed elements 64 may be assembled prior to attachment to the substrate 66.

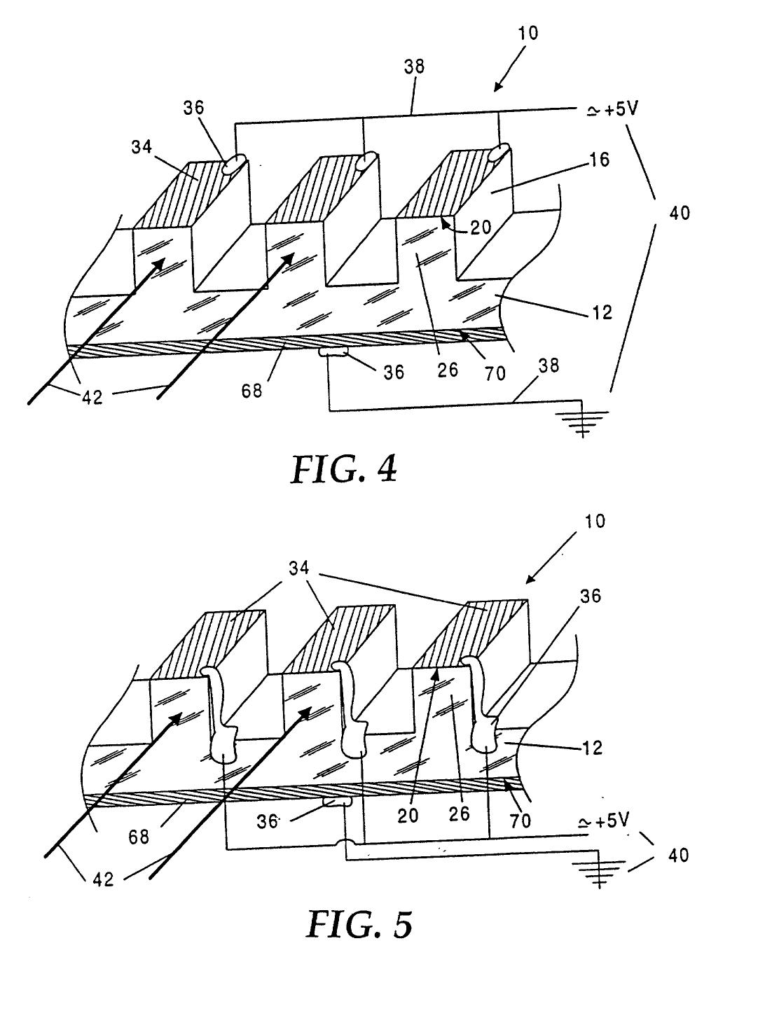

FIG. 4 shows yet another version of the modulator array 10. In this embodiment, electrodes 34 are attached to the top faces 20 of the protrusions 16 and a single large electrode 68 is positioned on the bottom side 70 of the wafer 12. It is to be understood that a plurality of appropriately placed individual electrodes could be used on the bottom side 70 of the wafer 12 in place of the single large electrode 68 pictured here and in the following FIG. 5. Conducting pads 36 are attached to the top and bottom electrodes 34, 68 as attachment points for the electrical leads 38. Polished front faces 26 are indicated as before, and incoming light beams 42 are shown to indicate orientation. The polarization direction has not been shown, as the principles of phase retardation operate much the same as in FIG. 1, with a λ/2 shift producing a 90 degree rotation, etc. This placement of electrodes 34, 68 produces a different orientation of transverse electrical fields, but still retains the advantage of channel separation and minimization of cross-talk which was unavailable in the prior art.

FIG. 5 shows a variation of the configuration in FIG. 4, in which the upper conductive pads 36 are located in a different orientation relative to the wafer 12. The top and bottom electrodes 34, 68 are positioned as in FIG. 4, to produce a transverse electric field. The polished front faces 26 and incoming light beams 42 are again shown for orientation purposes.

Although not pictured here, it is to be understood that this arrangement of top and bottom electrodes and the variations in conductive pad locations seen in FIGS. 4 and 5 can be used with elements that have been positioned on a different substrate material, in the manner suggested by FIG. 3, if the substrate material has the proper conductive properties. It may also be possible for elements to be directly attached to a single large bottom electrode that can act as a substrate to support and position the elements. Alternately, the electrodes may be attached or embedded on both sides of the electro-optic material directly before mounting the assembled elements onto a substrate.

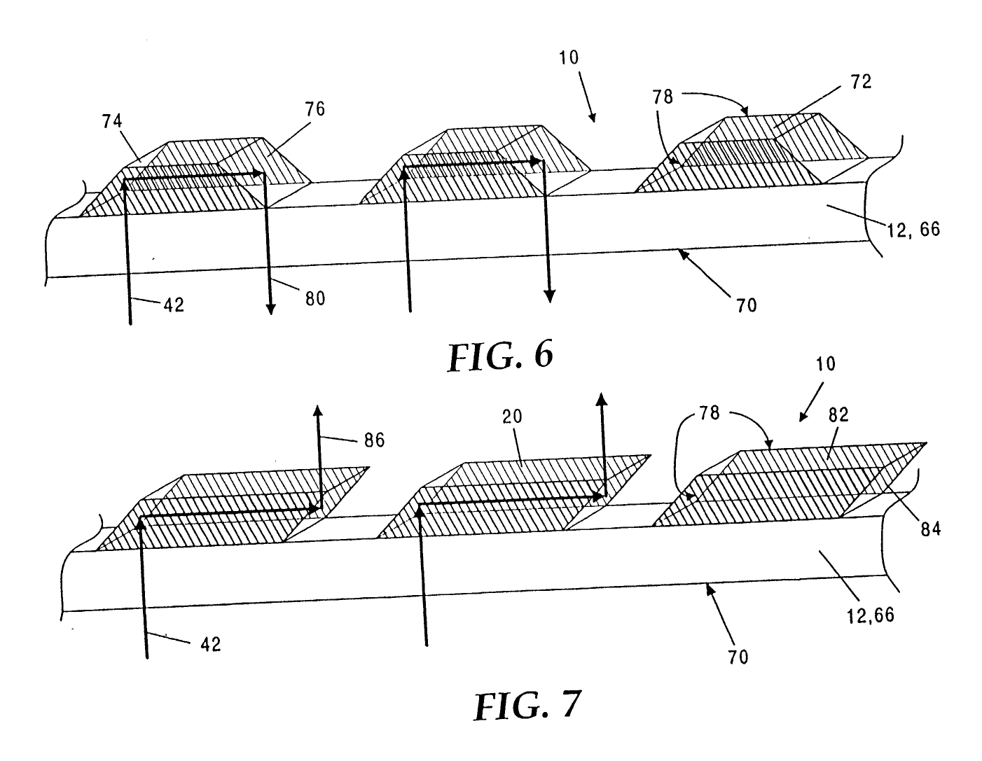

FIG. 6 shows another version of an array 10 of modified protrusions 72 which have either been formed on the original wafer 12 or formed separately on a substrate of different optically transparent material 66 in a similar manner to the embodiment shown in FIG. 3. The modified protrusions 72 are shown to be oriented with their long sides parallel to the long edge of the wafer 12 or substrate 66, but it should be understood that they may also be oriented with the long sides of the protrusions 72 transverse to the long edge of the wafer 12 or substrate 66. An incoming polarized light beam 42 enters from the bottom side 70 of the wafer 12 or substrate 66 and is internally reflected on the angled first side face 74 and angled second side face 76 to reemerge from the bottom side 70 of the wafer 12. If appropriate voltage has been applied to the electrodes 78, the resulting polarization of the emergent light beam 80 will be modulated in the manner described above. The angles of the faces here are chosen to allow total internal reflection, but it is to be understood that if a reflective coating is applied to the faces, a variety of other angles may be used as well.

FIG. 7 illustrates yet another version of a modulator array 10 in which the protrusions 82 have been modified in another manner such that the angled second side face 84 of each has been angled to direct the emergent beam 86 out of the top face 20 of each protrusion 82. As in FIG. 6, the protrusions may be oriented in a transverse direction, a different substrate material may be used, and a reflective coating may be applied to reflecting faces.

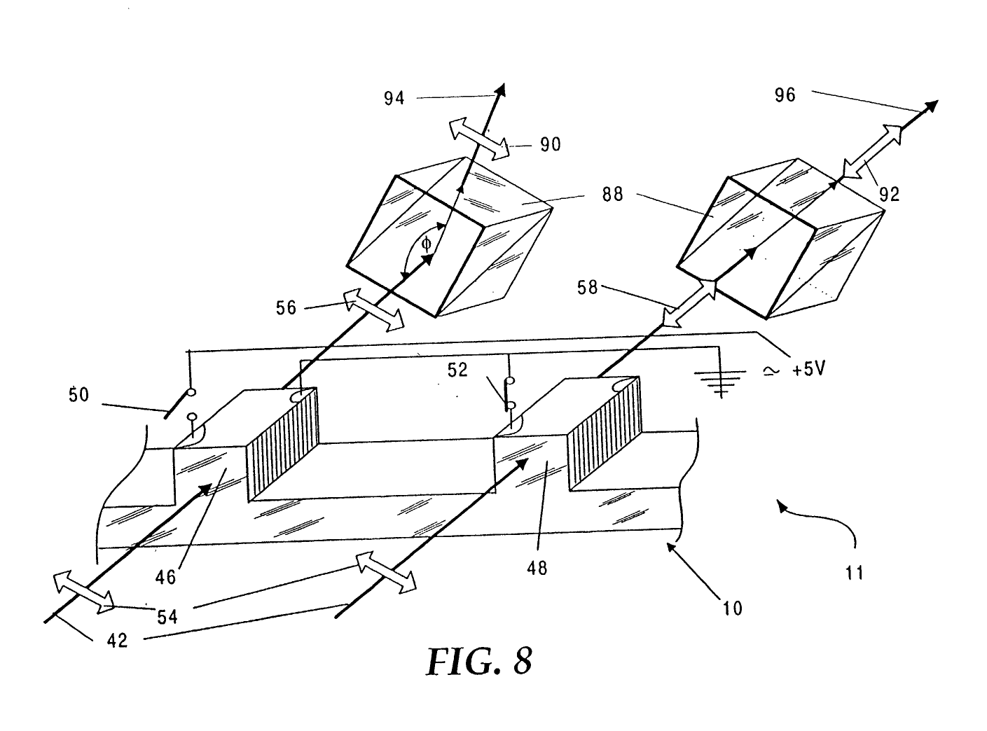

FIG. 8 shows a system 11 for modulating or switching light beams that uses the modulator array 10 in much the same configuration as in FIG. 1. An incoming linearly polarized beam 42 of polarization “R” enters a first element 46 that is inactive due to an open switch 50, so that its exiting polarization 56 is unchanged. This enters a beamsplitter 88 that has been positioned so that light of R polarization will be reflected out of the beamsplitter at angle φ, as shown by reflected beam 90. In a second element 48, which is active, the voltage is assumed to be such as to produce a λ/2 shift, the polarization is rotated 90 degrees to “S” orientation, and this passes through the beamsplitter 88, as shown by unreflected beam 92. These beams can be used to carry separate digital information, and may be designated “channel 1” 94 and “channel 2” 96. It is to be understood that beam splitters can be used as a channel separation device with any of the various embodiments illustrated herein.

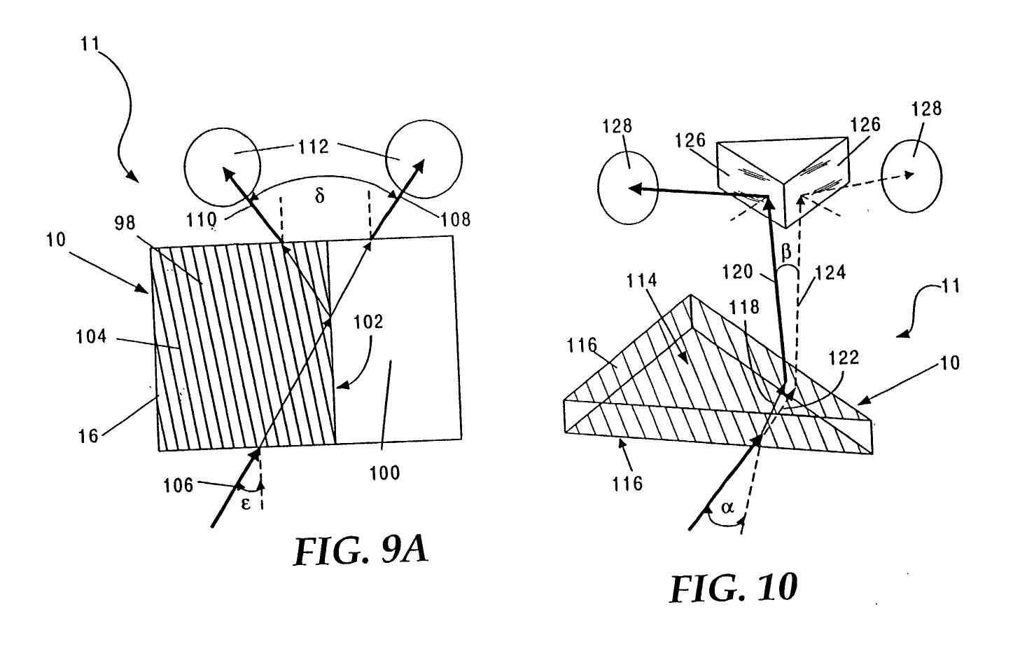

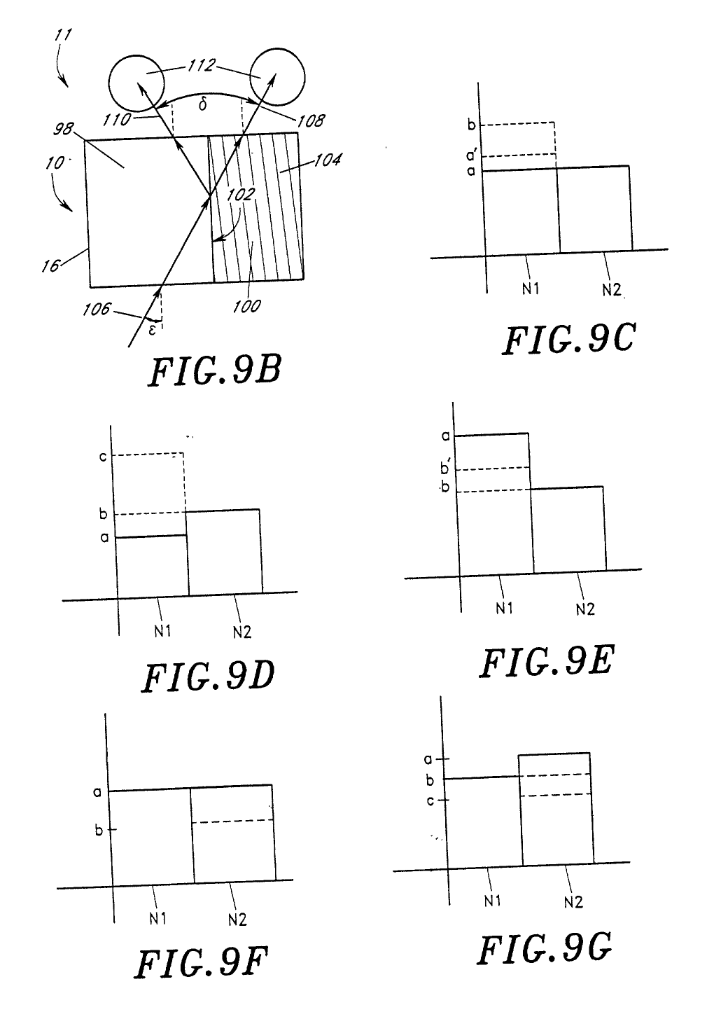

FIG. 9A shows a top plan view of another system 11 for modulating or switching light beams which uses a different version of a light modulating array 10. A single protrusion 16 is shown, which is composed of a first block 98 or portion of material having an index of refraction N₁, and a second block 100 of material having index of refraction N₂. A boundary 102 is formed at the junction of the two materials. One of the two blocks, in this case the first block 98, has top and bottom electrodes 104. First block 98 is composed of electro-optic material such that when electrodes 104 are uncharged, the electro-optic material is inactive, and N₁=N₂. When voltage is applied to electrodes 104, the first block 98 becomes active and the index of refraction changes for polarization components which are aligned with the electric field lines so that for this polarization, N₁>N₂. When first block 98 is inactive, an incoming beam 106 is projected into the first block 98 at entry angle ε to a normal such that the beam passes through the boundary between the two blocks 98, 100 and emerges as unreflected light ray 108. When first block 98 is active the index of refraction is increased such that total internal reflectance (TIR) occurs, and the beam is reflected back into the first block 98 at the boundary 102, and emerges as reflected light ray 110. The two emergent beams 108 and 110 are separated by angle δ, which has been greatly exaggerated here. These separated beams 108, 110, can be detected by sensors 112, and thus be used to establish channel separation for data transmission.

Alternatively, the protrusion 16 can be made from a single integral block of material, which has been electro-optically divided into portions or sections. A first section 98 may have electrodes 104 attached to induce a different index of refraction in this section. An incoming beam 106 will then be totally internally reflected, as described above, at the interface between the activated 98 and unactivated sections 100. This interface or boundary 102 can be established more definitely by having the second section 100, be of a different thickness than the first 98. This serves to direct the electric field lines better so that less fringing is produced, and a sharper interface boundary 102 is established.

Other specific arrangements of materials may be substituted for the specific illustrative embodiment shown in FIG. 9A and still achieve a TIR switch wherein at least one of two adjacent material regions exhibits a change in its optical refractive index in the presence of an applied energy (in particular an electric field), such that the following two modes or conditions may be interchangeably selected: (i) a transmission mode wherein a substantial portion of an incident light beam transmits across a boundary between the first and second regions (e.g. regions have substantially matched optical refraction indexes); and (ii) a TIR reflection mode wherein a substantial portion of at least one polarization component of the incident beam reflects with total internal reflection at the boundary (e.g. regions have sufficiently different indexes).

In particular, an appropriate TIR switch according to the invention may comprise adjusting an applied field in electro-optic material along either the first region (98), as shown and described above with respect to FIG. 9A, or the second region (100), as shown in FIG. 9B. Which of these regions is the appropriate position for the field adjusted electro-optic material depends upon the particular type of electro-optic response in the field-adjusted electro-optic material, the orientation of the electric field in the electro-optic material with respect to the polarization of an incident light beam to be switched, and the relative optical refraction index of the material with respect to the material in the other bordering region.

More specifically, the index of refraction for one “increasing” type of electro-optic material exhibits an increase in its index of refraction for light polarization components aligned with an applied electric field in the material. Another “decreasing” type of electro-optic material exhibits a decrease in its optical refraction index for similar field-aligned polarization components. Moreover, some “increasing” or “decreasing” types of electro-optic materials exhibit either increasing or decreasing change in their respective optical refraction indexes with respect to light polarization that is orthogonal or otherwise out of alignment with an applied electric field. These different types of electro-optic materials may be used to achieve a desired TIR boundary (e.g. N₁>N₂) for switching a given light beam so long as the relative optical refraction indexes between the bordering regions (98,100) may be adjusted between substantially matched (N₁=N₂) and substantially different (N₁>N₂) indexes at their interface.

Additional beneficial embodiments for implementing different materials in the first and second regions of TIR switches, such as those just described with reference to FIGS. 9A and B, are described as follows with reference to the graphs shown in FIGS. 9C-E. For the purpose of understanding these graphs: reference numeral “a” represents the value for the resting, relatively “inactivated” refractive index for the electro-optic material; and reference numerals “b” and/or “c” represent values for relatively “activated” refractive indexes for the electro-optic material where appropriate.

FIGS. 9C-E represent beneficial embodiments incorporating an electro-optic material within the first section or region (98) of the TIR switch, such as according to the structure shown in FIG. 9A. More specifically, FIGS. 9C-D represent examples using an “increasing” index-type of material in the first region (98) with respect to the light polarization to be switched, whereas FIG. 9E represents an embodiment incorporating a “decreasing” index type of material the first region (98).

More specific to FIG. 9C, the electro-optic material in the first section (98) has a resting index N₁ equal to “a” and that substantially matches the refractive index N₂ relatively non-electro-optic material in second region (100). Therefore, the resting state is characterized by N₁=N₂=“a”, and is therefore the light “transmissive” mode for the switch. As further shown in FIG. 9C, activation of the electro-optic material in the first region (98) increases its index of refraction such that N₁=“b”. The value of the second region (100) remains equal to “a”, such that N₁(“b”)>N₂(“a”); the activated state is therefore the light “reflective” mode for the switch.

FIG. 9D however represents an embodiment wherein an electro-optic material in first region (98) has a resting refractive index N₁=“a”<N₂. According to this embodiment, an applied field of some value is required to increase the index such that N₁=“b”=N₂ in order to achieve the transmissive mode for the switch. Additional field strength further increases the electro-optic material's index such that N₁(“c”)>N₂(“b”) to thereby achieve the light reflective mode for this switch embodiment.

FIG. 9E represents various modes for a “decreasing” type of electro-optic material in the first region (98) as follows. In the resting state, first region (98) has a resting index N₁(“a”)>N₂(“b”), which characterizes the light reflective mode for the switch. However, as further shown, upon activation of the “decreasing” type electro-optic material in first region (98), the index N₁ decreases such that N₁=“b”=N₂. Thus, the activated state according to this embodiment characterizes the light transmissive mode for the switch.

FIGS. 9F-G represent beneficial embodiments incorporating an electro-optic material within the second region (100) of a TIR switch, such as according to the FIG. 9B structure. More specifically, FIG. 9F represent use of a “decreasing” index-type of material in the second region (100), whereas FIG. 9G represents an embodiment incorporating a “decreasing” index type of material in the first region (98).

It is also appreciated that the respective indexes of the bordering first and second regions (98,100) of the FIG. 9A or 9B embodiments are not strictly required to exactly “match” in order to achieve a transmission state for the respective TIR switch. TIR is generally achieved along a boundary between two materials for light beams that are incident upon that boundary beyond a “critical angle” from the normal of the boundary surface; the value of such critical angle is dependent upon the relative index difference of the bordering regions. Therefore, assuming that an incident light beam has a predictable angle with respect to a boundary region between the first and second bordering regions, the relative refractive indexes between the two bordering regions (98,100) may be adjusted between two distinct levels of difference that respectively correspond to transmission or reflection modes at the interface boundary. At one level of difference, the angle of the incident light may be beyond the critical angle and therefore experience TIR reflection at the boundary. At another, second level of difference there is a different critical angle such that incident angle of the light beam is below the critical angle for TIR and instead passes through the boundary substantially unreflected despite some index change is present at the boundary.

This second level of difference illustrates what is herein meant by “substantially matched” indexes of refraction between the two bordering regions—the degree of index difference at the interface is sufficiently low that TIR is not experienced by the incident light beam. This condition is graphically illustrated for further understanding in FIGS. 9C and 9E, wherein first region N₁ is shown to have an optical refractive index equal to a′ and b′, respectively, which substantially match the index a and index b, also respectively, of the bordering region.

It is also to be appreciated that the condition of a transmission mode through a boundary of not exactly matched indexes of refraction may result in some diffraction of the crossing light beam even though TIR is not achieved. Therefore, such diffractive transmission modes may dictate careful positioning of the switch, and/or light receiving implements for coupling to the crossing beam, according the light beam's diffracted direction through the switch.

According to the various material arrangements and related modes of operation just described above, an “increasing” electro-optic material for either field aligned or orthogonal polarizations may be incorporated within either the first region (98) of a TIR switch (FIG. 9A) or the second region (100) (FIG. 9B). However, the same material may also exhibit a “decreasing” index for other (e.g. orthogonal) polarizations. Such an electro-optic material may be activated in one of the two adjacent regions for switching one given polarization, e.g. the first region (98), and may also be used for TIR switching of an orthogonal polarization by activation with a similarly aligned electric field in the opposite second region (100).

PLZT according to the formulations provided hereunder is known to exhibit a “decreasing” index of refraction for field-aligned light polarization components, and to exhibit an “increasing” index of refraction for light polarization components out of line with such a field. Therefore, such PLZT material may be activated with an applied field along the first region (98) for switching polarization components of an input light beam that are orthogonal with the applied field. Conversely, such PLZT material may be activated along the second region (100) for switching field-aligned polarization components.

However, it is further contemplated that such materials as PLZT may exhibit different “degrees” of electro-optic activity in “field aligned” and “orthogonal” planes. Therefore, different field strengths may be required in order to achieve the required electro-optic activity to induce the necessary refractive index change for TIR switching of certain polarizations. For further illustration, PLZT has been characterized in field aligned and orthogonal activity as follows.

Based on the experimental data known in the literature (e.g. T. Utsunomiya, K. Nagata, K. Okazaki: presented at FMA-5, Kyoto, 1985), the magnitude of electro-optic coefficients in PLZT in a 9/65/35 composition are measured to have ratio: R₃₃/R₁₃=3:1, wherein R₃₃ represents field aligned polarization activity, and R₁₃ represents activity for polarization component orthogonal to an applied field. Moreover, R₃₃ is positive and R₁₃ is negative. Therefore, the refractive index for the vertical polarization (R₃₃) is reduced (Δn) from an initial index condition (n₀) under an applied field (E_{z}) according to the formula:

(i) For R₃₃: Δn=n_{z}−n₀=−0.5n₀³ R₃₃E_{z}²;

In contrast, the refractive index for horizontal polarization (R₁₃) is increased (Δn) according to the formula:

(ii) For R₁₃: Δn=n_{z}−n₀=−0.5 R₁₃E_{z}²

Electric field strength (E_{z}) is derived from a voltage applied (V) between electrodes separated by a distance (d) according to the formula:

(iii) E_{z}=V/d

Therefore, TIR switching for both field aligned (R₃₃) and orthogonally polarized (R₁₃) light may result by providing for example the following two TIR boundary conditions:

1) launch the two orthogonally polarized light beams (a) from the same side of a switch, either as separate beams or as one randomly polarized beam that may be separated into orthogonal components, and provide two different TIR boundaries for TIR reflection, or (b) one common boundary but from opposite sides, provided that in both cases (a) and (b) each light beam is incident upon the boundary from the side where E-field induced refractive index is higher than on the opposite side of the boundary; and

2) In order to provide TIR reflection for the orthogonally polarized beam according to a similar percent index change resulting in a similar critical angle for TIR reflection as that provided for the field aligned polarization component, apply a higher voltage to the electro-optic material for the orthogonal case than is needed for the same conditions for the vertical polarization component. In particular, this higher voltage for orthogonal TIR reflection will in many instances be √3 times higher voltage than applied to the electro-optic material for field aligned TIR reflection.

Therefore, PLZT according to the specified formulation is three times more electro-optically active in its decreasing index response for field aligned polarization when compared to the increasing index response for polarization components orthogonal to the applied field. However, in order to achieve the same overall change in the orthogonal plane, the applied voltage in many cases need only be increased by a factor equal to the square root of three, or 1.73 times the voltage which is necessary to achieve the same critical angle for the decreasing, field aligned response.

As introduced above, both first and second regions (98,100) may be electro-optic, and in fact may comprise the same electro-optic material and still achieve the intended TIR result so long as electro-optic activity and therefore index change is isolated to one of the regions sufficiently to create the desired TIR boundary between regions during activation. One highly beneficial example provides the electro-optically activated region with different thickness than the other non-electroded region such that the electric field is better collimated and therefore isolated within the electroded region. Preferably, either region (98,100) may be the thicker one, depending upon where electro-optic activation is desired. In one specific beneficial example, both first and second regions (98,100) are constructed of PLZT, wherein second region (100) is electroded and is thicker than the bordering first region (98).

The embodiments shown and described above, including in particular with respect to FIGS. 9A-G, illustrate a broadly beneficial aspect of the invention that uses an applied energy to change the relative refractive index between two adjacent material regions in a UR switch. Moreover, the specific embodiments are described with respect to an applied electric field in electro-optic material, and still more specifically with respect to using a voltage applied between two electrodes associated with the electro-optic material. While this aspect of the invention provides highly beneficial advantages as herein described, other beneficial variations are also contemplated.

For example, an inductive energy source may be positioned adjacent certain types of materials in a TIR switch as described in order to create a localized magnetic field in the material resulting in the desired optical refractive index response. In addition, various materials are known to exhibit optical refractive index changes in the presence of other types of applied energy than an electric field, such as for example: light energy (e.g. applied laser light or high intensity UV light); thermal energy (e.g. thermal conduction from an adjacent heater source); sonic energy (e.g. ultrasonic energy); or mechanical force energy (e.g. compression of the material). In one particular example for illustration, an ultrasound source, such as an ultrasonic PZT transducer, may be positioned closely adjacent the material region for applying ultrasonic energy to that region to change the optical refractive index there. Further to this particular example, sufficient temperatures may be reached in either or both of the PZT transducer or the switch material in order to create a thermal-optical index response in the switch material that may be the primary mode of index response or additive to an ultrasound field response.

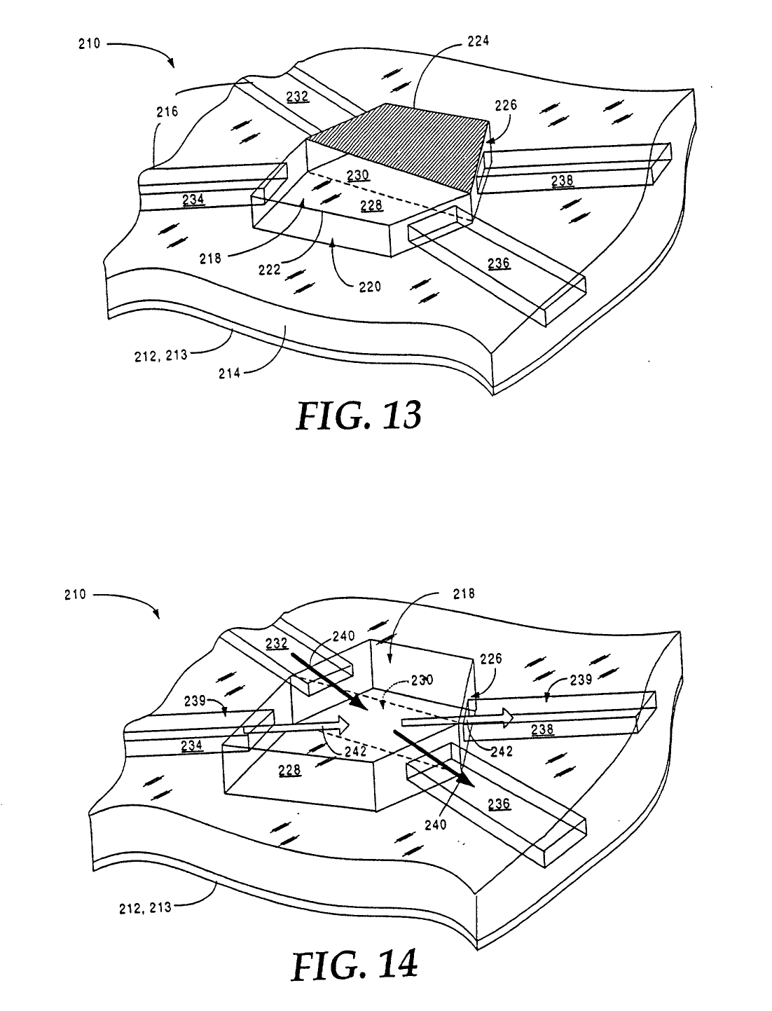

It is to be appreciated that the various particular TIR variations just described with general reference to FIGS. 9A-B are applicable to various of the other embodiments associated with other Figures herein shown and described. For example, the embodiments for FIGS. 13-27 may interchangeably incorporate the various specific material arrangements and associated electrodes as described for FIGS. 9A-G and still achieve the intended TIR structures and results according to those related modes of the invention.

FIG. 10 shows a perspective view of another system 11 for modulating or switching light beams which uses yet another version of the light modulating array 10 to perform channel separation. A single prism-shaped protrusion 114 is shown, which can be electro-optically activated by electrodes 116 to increase the index of refraction. This causes the light beam to be bent towards the normal upon entry slightly differently than when the material is an inactive state. Thus when the element is active, the light beam will follow a first path 118, and will emerge at a slightly different angle relative to the normal upon leaving the element, thus following a first exiting path 120. In contrast, when the element is inactive, the light follows a second path 122 upon entry, and follows a second exiting path 124. Both of these second paths are shown in dashed line in FIG. 10. These first and second exiting paths 120, 124 are separated by angle β, and they can be further directed by mirrored surfaces 126 to sensors 128 to produce separate channels. The separation of the paths and the separation angle has been exaggerated in the FIG. 10.

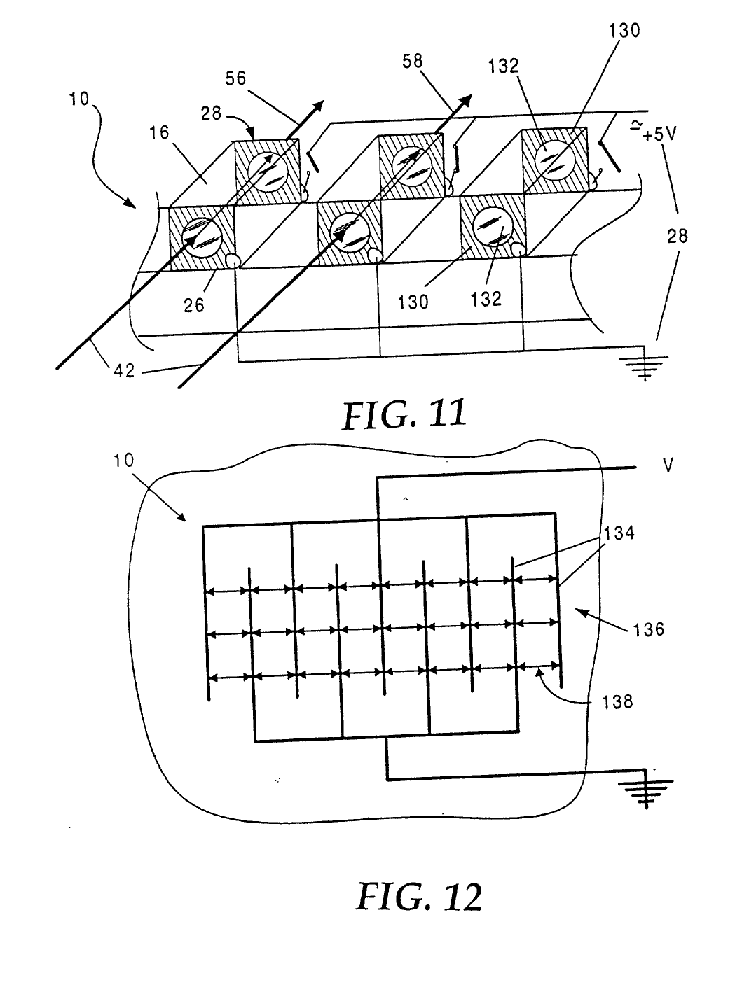

FIG. 11 illustrates yet another version of the present light modulating array 10 in which end-mounted electrodes 130 each having an aperture 132 have been attached to the front faces 26 and rear faces 28 of the protrusions 16. In this configuration, the electric field lines are collinear with the direction of incoming light beams 42. The application of appropriate applied voltage results in the change in polarized output in a manner similar to that discussed above. It is to be understood that the above mentioned methods of splitting the output into separate channels, or using an external polarizer and sensor may be used, as well as mounting of elements on different substrate material, and variations in conductive pad placement.

It is also possible to have a light-producing element, such as a diode laser, with a modulating element physically attached at the laser's output, in order to produce a single integrated element.

Another variation of the preferred embodiment uses sol-gel processing to create an array of elements that are fixed in a flexible medium. Sol-gel processing is a chemically based, relatively low temperature (400-800 degrees C) method that can produce ceramics and glasses with better purity and homogeneity than higher temperature (2,000 degrees C) conventional processes.

When using molding processes, two approaches are possible. In the first approach, a non electro-optic, optically transparent or non-transparent matrix is prepared. Electrodes are deposited on the side walls. Then it is filled with electro-optic material of sol-gel type. It is then cured to produce an array of electro-optic modulators separated spatially by non electro-optic material.

In the second approach, an electro-optically active matrix of solid material is prepared. Electrodes are deposited on the side walls. Then it is filled with non electro-optic material, of optically transparent or non transparent, preferably of the sol gel type. Then it is solidified (e.g. by heating such as sintering or otherwise curing) to produce an array of electro-optic modulators separated spatially by non electro-optic material.

For the PLZT thin films made by the sol-gel process with 1-2 μm spacing between embedded adjacent electrodes, λ/2 voltages range from 20-30 Volts for 0.5 μm thick films, to TTL levels (4-5 Volts) for 1-2 μm film thickness. This idea is very attractive for large area flat panel display applications, which function like CRT tubes and which may successfully compete with them. Because electrode spacing is necessarily very small to achieve low driving voltages, resulting pixel size is also very small, which makes this embodiment ideal for high-resolution flat panel displays or spatial light modulators. This fine pixel structure is below typical resolution capability of the human eye, so for consumer applications, sub-micron and micron size substructures may be aggregated to produce standard sized pixels (usually dozens or hundreds of microns). To simplify the manufacturing process and make it compatible with existing flat panel technology, the pixel size can be made larger. In this case, each pixel represents an interdigital pattern of PLZT embedded shutter electrodes.

FIG. 12 shows a top plan view of a modulator array 10 composed of embedded electrodes 134 that are contained in a sol-gel matrix 136. The arrow lines indicate electric field lines 138. The height of the electrodes 134 (out of drawing plane) is defined by the thickness of the film. In the figure, light also travels perpendicular to the drawing plane. For non-polarized light, the modulator array 10 is placed in between two cross polarizers (not shown).

The electrode structures can be deposited either prior to the sol-gel film deposition, or after it, using known etching or micro-machining techniques. Using etching techniques and molding processes, the height of the electrodes 134 can be much higher, 10 μm or more with the same 1-2 μm spacing between electrodes. In this case, sol-gel can fill the spacing between electrodes 134 and the thin film can still be thin enough (a few microns) to guarantee the same fabrication process and similar process conditions. This will allow driving or switching voltages on the TTL level (4-5 Volts) or below (1-3 Volts and even lower). The arrays thus fabricated can be used in either transmissive or reflective modes. Additionally, the sol-gel material can either be used to completely fill the gap between electrodes, or it can instead be deposited on the sides of the electrodes as a coating. If used as a coating, an additional electrode can be added on the outer side of the sol-gel coating to make a complete element, each element being separated from its neighbor by a gap or groove.

FIG. 13 shows a preferred embodiment that makes use of several of the inventive features previously disclosed. An optical switch 210 is shown which makes use of total internal reflection at the boundary between an activated portion and an inactive portion of electro-optic material, in the manner of the embodiment previously described and shown in FIG. 9.

The optical switch 210 is fabricated upon a substrate of semi-conductor material 212, which acts as a first electrode 213. Upon this substrate, a matrix of material 214, preferably glass is formed. Light conductive channels 216 are formed in the matrix, and these channels can be formed of either fiber optic material, or preferable are waveguides. The switching element 218 is preferably formed by making a cavity 220 in the matrix material 214, which is then filled with electro-optic material 222. In the preferred embodiment, this electro-optic material is PLZT that is introduced in a sol-gel state, and then solidified such as by sintering and densifying the material. The PLZT sol-gel is used to fill the cavity, and then after sintering, a second electrode 224 is placed on top of a first portion 226 of the electro-optic material 222, leaving a second portion 228 that is not covered by the second electrode 224. The second electrode 224 is connected to a high-speed switching power supply (not shown). At the boundary between the first portion 226 and the second portion 228, there is a potential total internal reflection (TIR) boundary 230. This boundary will act to reflect incident light that approaches from an angle greater than the critical angle for the interface of materials with different indexes of refraction. For TIR to occur, the incident light beam must also have polarization that is parallel to the plane of the boundary. In FIG. 13, this would be vertical polarization.

The first material portion 226 and second material portion 228, as discussed above, may be portions of a single unity piece of electro-optic material. It is also possible that the two portions 226, 228 are separate components, perhaps composed of different materials, which have indexes of refraction which match closely enough that light will not be reflected at the boundary 230 when the first portion 226 is inactive, but which will be totally reflected internally when the switch 210 is active.

Of the four light conductive channels 216 shown, going counter-clockwise from the upper left hand channel, there is a first incoming signal channel 232 and a second incoming signal channel 234, a first outgoing signal channel 236, and a second outgoing signal channel 238.

FIG. 14 illustrates an optical switch 210 from which the second electrode 224 has been removed for easier viewing. The optical switch 210 shown is in an inactive state, i.e. no voltage is applied to the electrodes, and thus the index of refraction of the first portion 226 of the PLZT and the second portion 228 exactly match. Therefore, the TIR boundary 230 only potentially exists, and is shown in dashed lines in the figure. A first incoming signal 240 is shown as a black arrow which enters the switching element 218 through the first incoming signal channel 232. As the switch 210 is inactive, the first incoming signal 240 continues unaffected and is relayed through the first outgoing signal channel 236. A second incoming signal 242 is depicted as a white arrow which enters from the second incoming signal channel 234, and also continues in a straight line to exit from the second outgoing signal channel 238. Since the second incoming signal is not intended to be modulated by the TIR boundary 230, it is merely relayed onward from this switch 210. The second incoming signal channel 242 together with the second outgoing signal channel 238 can be thought of as a passive crossing channel 239 with respect to the second incoming signal 242. The incorporation of a passive crossing channel 239 is useful in routing of signals in larger arrays of optical switches, as will be described below, but is not necessary to the operation of the individual switch 210 shown in FIG. 14. Its inclusion here is thus not to be construed as a limitation on the structure or operation of the switch 210.

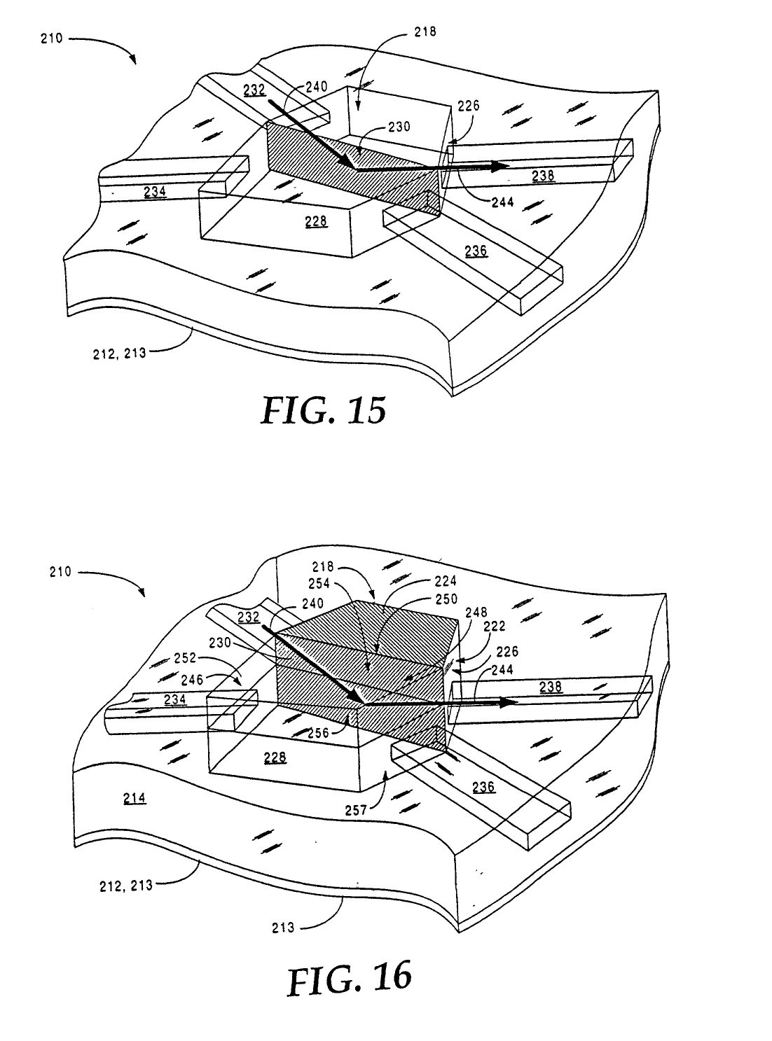

FIG. 15 illustrates the optical switch 210, again with the top electrode removed, in an active state. Thus, the electrodes, although not shown, are charged and an electric field is generated in the first portion 226 of electro-optic material. The index of refraction is thus increased for this portion, so that total internal reflection is produced for light that approaches at the angle assumed by the first incoming signal 240, again shown as a black arrow. The TIR boundary 230 is established, and the first incoming signal 240 is reflected off the TIR boundary 230 and into the second outgoing signal channel 238 as the reflected beam 244. Thus the first incoming signal can be switched from the first outgoing signal channel 236 whenever the appropriate electric field is generated in the first material portion 226. This switching can be done very quickly, on the order of pico-seconds (10⁻¹² seconds), and as explained above, standard TTL voltages can be used, which are compatible with many standard power supplies.

The quality of the reflected beam 244 is dependent on the flatness and uniformity of the TIR boundary 230, much the same as that of any reflecting surface. A reflected beam from a very flat surface will naturally tend to retain the properties of the incident beam better than a reflected beam from a less flat and less uniform surface. The properties of the boundary of the electric field produced define the flatness of the TIR boundary. If the electric field lines are diffused and irregular with much fringing, the boundary will also be defused and irregular. Thus it is desirable to confine and direct the electric field lines so that the boundary is as nearly a sharply defined flat plane as possible. FIG. 16 shows a preferred embodiment of the present invention in which the flatness of the TIR boundary is enhanced.

In the embodiment shown in FIG. 16, the thickness of the matrix layer 214, as well as that of the electro-optic material 222 has been increased. It should be understood that the relative thicknesses of the layers shown are for illustration only and are not drawn to scale. The switch 210 shown is in the active state, thus charge is applied to the second electrode 224 and an electric field has been established in the first material portion 226, creating TIR boundary 230. A step region 246 has been removed from the second portion 228 by some shaping process such as etching including reaction ion etching and plasma etching, laser ablation, or use of mechanical processes such as abrasion or cutting, so that the second material portion 228 has a remaining thickness less than the thickness of the first portion 226. A step face 248 is thus established as the vertical surface of the first portion 226 above the second portion 228 of the electro-optic material 222, this step face being created by the removal of second portion 228 material resulting in the step region 246. The front edge 250 of the second electrode 224 is configured to exactly match the profile of the step face 248. In fact, both may be formed simultaneously by first depositing the electrode 224 on the electro-optic material 222, and masking the electrode 224 to the extent of the desired material first portion 226. The step region 246 is then etched or ablated along with the unmasked part of the electrode 224, at the same time.

The step region 246 is then filled with some material having a low dielectric constant (k) and low polarizability (p), which will be referred to as low k low p material 252. The glass material of the matrix 214 is well suited for use as low k low p material 252, as is air, plastic and many kinds of gases or liquids. The electric field lines created when the electrode 224 is charged will not propagate well in this low k low p step region 246, and will form a sharp boundary along the step face 248. This defines the upper portion 254 of the TIR boundary 230 as a flat plane along the step face 248. This flatness and definition are extended to all the electric field lines and thus throughout the lower portion 256 of the TIR boundary 230 which extends through to the substrate 212.

As stated above, the illustration has been drawn without any attempt to depict the relative thicknesses to scale. Representative dimensions are 20 microns for the thickness of the PLZT material in the first material portion 226, a step depth of approximately 7 microns, and thus a thickness of 13 microns for the second material portion 228, assuming that an incident beam is approximately 10 microns in diameter. These dimensions are not to be construed as limiting, and much variation is possible.

It will of course be obvious to one skilled in the art that other variations and embodiments are possible as well. As mentioned above, it is possible that the two portions 226, 228 are separate components, perhaps composed of different materials. The second portion 228 may even be of a non-electro-optic material, in which case, the second electrode 224 need not be limited to only the first portion 226, but may extend over both first and second portions 226, 228. Only the first portion 226 will then change index of refraction, and the boundary 230 will correspond to the physical boundary of the first portion 226 component. The uniformity and quality of reflected image from the TIR boundary 230 will then depend on the smoothness of the boundary wall of the first portion 226, as machined or etched. This type of element may have advantages as to ease of manufacture.

For another example of variation, a curved mask could be applied to provide a curved front edge 250 to the electrode 224 and thus also produce a curved step face 254 and TIR boundary 230. This may have some advantages in focusing or manipulating the reflected beam 244 profile. For example, the reflected beam can therefore be focused in such a way as to insure that the beam will be efficiently coupled into the outgoing waveguide. Thus a separate collimating or focusing element could be eliminated. It is also possible to configure the switch 210 with curved outer boundaries or other geometric shapes besides the hexagonal shape shown as the perimeter of the element 218. Perimeter portions 257, as seen in FIG. 16, may be curved or straight, and by providing both a curved perimeter 257 and a curved TIR boundary 230, it is therefore possible to create a first portion 226 which could be a configured in a convex-convex lens shape, for one example among many. Of course, many other combinations of flat and curved surfaces could be used for the perimeter portion 257 and TIR boundary 230 of the first portion 226, and all are contemplated by the present invention.

The switch may also have only one incoming signal channel and two outgoing signal channels, or more than two incoming and two outgoing signal channels.

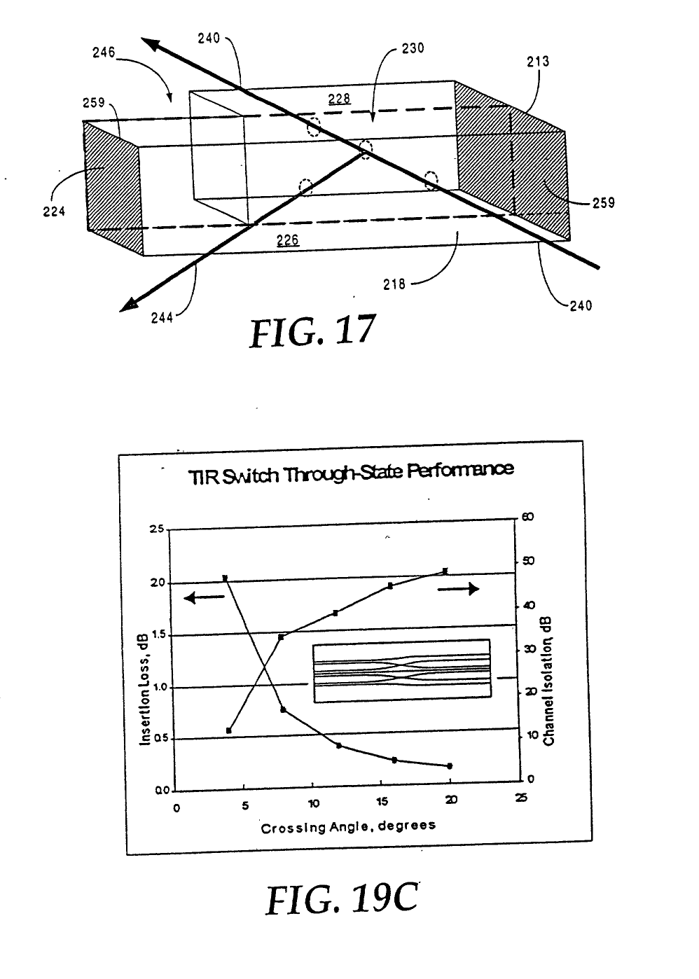

It is also possible for the electrodes to be placed on side surfaces of the element rather than top and bottom surfaces. Such a configuration is shown in FIG. 17. The switching element 218 includes side walls 259 to which the first electrode 213 and second electrode 224 are attached. As before, the first portion 226 is of greater thickness than the second portion 228, so that there is a step region 246 formed which serves to direct and confine the TIR boundary 230. An incoming signal beam 240 is shown passing through as if the TIR boundary 230 is inactive, by the black arrow. Also shown is the reflected beam 244, depicted by a gray arrow, which will result if the TIR boundary 230 is activated. The element 218 can be included in a matrix material, which is not shown here, and included in larger arrays, as will be discussed below.

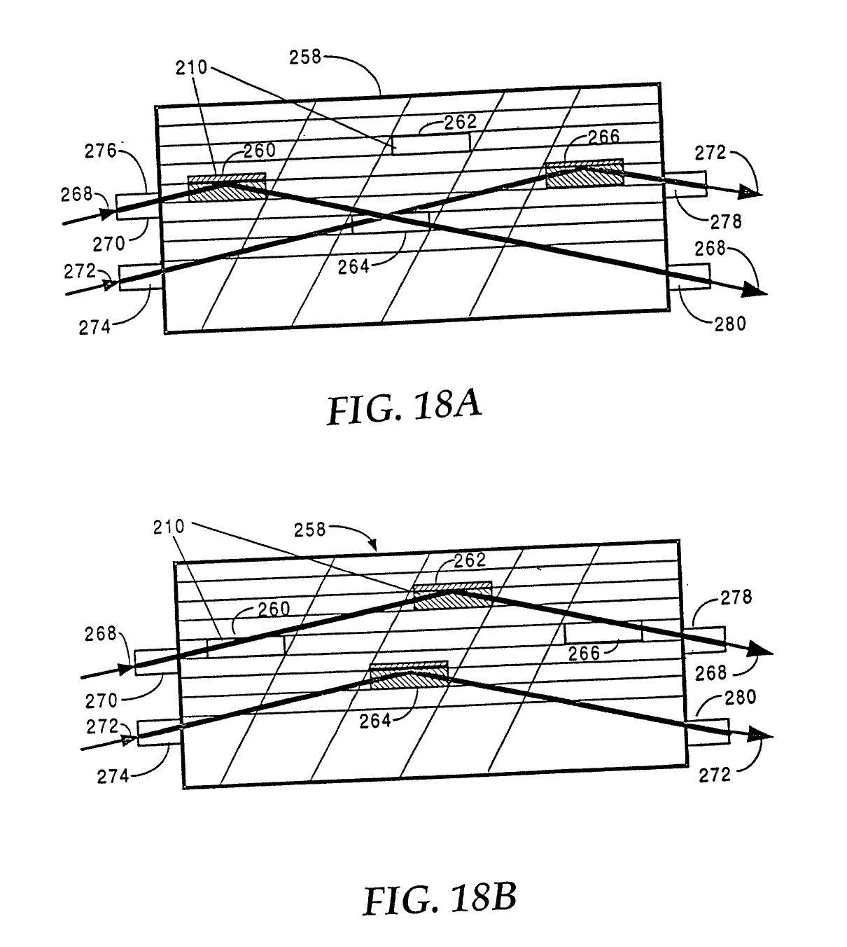

The optical switches 210 are made to be used in arrays and groups to form N×M matrices for switching signals. FIGS. 18A & 18B illustrate a simple 2×2 cross-connect switch 258 using four optical switches, which are designated as first switch 260, second switch 262, third switch 264, and fourth switch 266. A first input signal 268 arrives through the first input channel 270, and a second input signal 272 arrives through the second input channel 274. The incoming signals 268, 272 are each optionally passed through collimators 276 and then enter the cross-connect switch 258. A first output channel 278 and a second output channel 280 are provided at the output of the cross-connect switch 258. All signals may be routed to the cross-connect switch by signal channels, as described above, which may be optical fibers, waveguides or free-space propagation. In FIG. 18A, switches 260 and 266 are active, and are represented graphically as active by shading. The switches work as previously described to cause TIR of an incoming beam of the appropriate polarization, assumed vertical for the illustrative example in FIGS. 18A and 18B, which approaches within an appropriate range of angles. The first input signal 268 is thus reflected by switch 260 and passes through inactive switch 264 to exit through second output channel 280. Second input signal 272 also passes through inactive switch 264 but is reflected by switch 266 to exit through first output channel 280.

FIG. 18B shows the routing of signals when switches 262 and 264 are active, shown by shading. First input signal 268 passes through inactive switch 260, but is reflected by active switch 262 to pass through inactive switch 266 and finally exit through first output channel 278. Similarly, second input signal 272 is reflected by active switch 264 and exits through second output channel 280.

Of course, it will be obvious that other combinations of active and inactive elements exist, for example, where both switches 260 and 262 are inactive so that first input signal 268 will pass in an undeflected straight line to arrive at a possible third output channel, not shown. Similarly, if both switches 264 and 266 are inactive, second input signal 272 will travel undeflected to a possible fourth output channel, also not shown. Thus the cross-connect switch is not limited to an “N×N” switching matrix, where N=2, for instance, but can be designed to a “N×M” matrix, where, for the combinations discussed immediately above, N=2, and M=4. Also obviously, more switches can be added and more input and output channels used to increase the number of possible variations.

The optional collimators 276 discussed above are used to collimate the beam and provide more uniform beam profile within the cross-connect switch 258. Upon exit from the cross-connect switch 258, there may be a focusing lens, not shown, or other optics to manipulate the size or shape of the beam. The beam exiting from a first cross-connect switch can be aligned to enter a second cross-connect switch, a fiber optic, waveguide or other optical device, or may be used to excite pixels on a display screen.

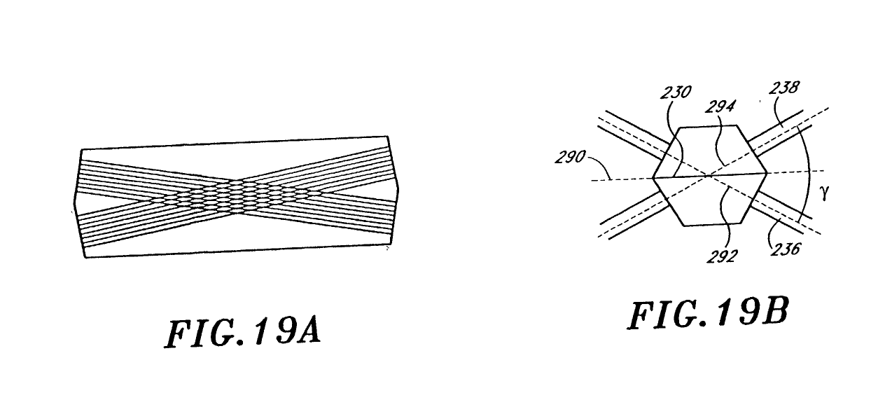

The optical switch structures and methods of manufacture herein described are particularly well suited for combination in a planar waveguide cross-connect system, as introduced above. According to such combination, micro-scale structures are formed at the intersections of a prescribed crossing-waveguide pattern in a silica-on-silicon planar waveguide platform, such as is shown schematically for the purpose of illustration in the FIG. 19A. One particularly beneficial combination results from a controlled deposition of electrodes onto PLZT that is formed (beneficially molded, e.g. according to sol-gel processing) into specially configured micro-cavities that are first created at the intersection point of the waveguides. PLZT is a dielectric, transparent (from 400 nm to >7000 nm), quadratic, electro-optic, solid solution of lead, lanthanum, zirconium and titanium oxides that exhibits exceptional change in index of refraction (Δn) with applied electric field intensity (e).

The deposited PLZT structures, and integrated electrodes, may be shaped and configured in order to apply intense and precisely confined electric fields with a moderate level of voltage, which may according to certain configurations be less than about 35 volts DC, and in some applications less than about 10 volts, and in further specific configurations even less than about 5 volts. Upon application of sufficient electric field intensity, a TIR surface is created at a well-defined plane within the PLZT, across which the index of refraction can change by 10⁻² or greater.

The angles of the crossing waveguides are determined based upon the critical angle for TIR reflection, which is based upon the desired Δn, which is in turn driven by the PLZT material formulation and the applied electric field. Once such parameters are established and fixed within the planar host structure, the desired Δn is achieved under the applied electric field so that a beam of light from one waveguide will experience total internal reflection and be redirected into the crossing waveguide. Without the e-field induced TIR, the beam traverses the micro-cavity and re-enters the continuation of the origin waveguide. A unique aspect of this device design is that the optical signal is delivered to and collected from the TIR switching element in a passive waveguide, while the actual switching takes place in a free-space environment.

Additional benefits from the use of a stable dielectric metal oxide such as PLZT are the apparent elimination of the need for hermetic sealing in order to insure stability of switch performance, the absence of current flow which would cause Joule heating and resultant complex thermal gradients, and a response time of slightly less than a nanosecond, or about three orders of magnitude faster than a MEMS, liquid crystal, or thermo-optic switch.

Modeling of Switch Element Performance

The behavior and performance of the optical signal in the waveguide-freespace-waveguide transport path according to the TIR switching fabric as herein described may be determined and optimized according to various known modeling techniques, such as for example by using R-Soft BeamProp™, MathCAD™ and EXCEL™ applications. In particular, such modeling is useful in determining optimal waveguide crossing angles according to certain predetermined parameters. The terms “crossing angle” with respect to waveguides are herein intended to mean the angle between crossing waveguide channels (236, 238) or segments relative to an arc that includes the axis (290) of the TIR boundary (230), shown as γ in FIG. 19B. FIG. 19B. depicts the crossing angle γ as being defined by optical axes (292, 294) through the respective crossing waveguide segments (236, 238).

FIG. 19C graphically shows the results of a 2 dimensional, simplified model, and includes two curves illustrating the dependence of both insertion loss and channel isolation, respectively, with the crossing angle, γ, of two crossing waveguides.

Further parameters that are integrated into the model illustrated by FIG. 19C include without limitation the following. A microcavity is theoretically formed at the waveguide crossing region that is filled with a material having an index of refraction equal to 2.4 for the given light wavelength of 1.55 um (approximating PLZT according to 9/65/35 formulation). The following are other parameters related to the model: the waveguides are given widths of 8 microns, with respective indices of 1.4495 and 1.4452 given for the waveguide core and cladding. The lengths of the cavities are varied for each data point so that the waveguides have 4 um separation where they terminate at the theoretical cavity edge boundary, and further so that the light modes do not substantially interfere with each other at that cavity edge boundary.

Optimal waveguide crossing angles for TIR switches according to the input parameters described may be determined according to the curves shown in FIG. 19C, and further in view of the following desirable operating ranges. In one regard, the value for insertion loss preferably is no more than about 1.0 dB, and still more preferably is no more than about 0.5 dB (or closer to zero than −0.5 dB as shown in the graph). In particular, such insertion loss limits are more sensitive for switching fabrics incorporating larger numbers of “n” switches, since the insertion losses are additive across the number of switches propagated by a light channel signal. In another regard, the value for channel isolation preferably has a magnitude greater than about 30 to 35 dB.

Further to FIG. 19C, the slopes for both insertion loss and channel isolation are clearly steeper where crossing angle values are less than about 7 to 7.5 degrees, and the preferred combination of insertion loss and channel isolation are met at that angle. Therefore, one desired range for waveguide crossing angle comprises angles that are no less than about 7 or 7.5 degrees. Furthermore, for a given electro-optic material in the TIR switch cavity, steeper crossing angles require higher Δn, and therefore higher applied electric fields; therefore, angles greater than 20 degrees are generally regarded as particularly challenging for TIR boundary creation. Thus, it is contemplated that crossing angles of no more than about 20 degrees are preferred. Accordingly, though various other conditions may be operable according to certain applications and design modifications, a highly beneficial range for an electro-optic TIR switch fabric design in a planar waveguide setting as herein modeled and described comprises a waveguide crossing angle that is between about 7 degrees and about 20 degrees.

Experimental Observation

Various experiments have been performed in order to evaluate various aspects of the molded PLZT/TIR switch as herein described. Various aspects of such experiments are herein described as follows.

a. TIR Evaluation of PLZT Substrate

The performance of an optical TIR switch using PLZT was evaluated as follows. Electrodes were deposited on opposite faces of a block of PLZT with a separation width of 400 nm. The electroded PLZT was configured with a groove formed along the middle of the block through the top electrode in order to apply a substantially collimated electric field across only a portion of the PLZT substrate, thereby forming a TIR boundary between the edge of the electroded portion and the adjoining grooved portion where the electrode was removed. The electroded PLZT substrate was positioned within a test set-up in a manner allowing for a 0.63 um diode laser light source to launch light into the substrate across a range of incident angles relative to the induced TIR boundary. The electrodes were connected to a controllable voltage source. A background surface was positioned for viewing a projected image of light spots as the incident light beam from the laser source propagates through and then exits the PLZT substrate. The position of a projected light spot against the background was observed as voltage between the electrodes and the incident angle of the laser light relative to the TIR boundary were each systematically varied.

TIR switching of the incident light source was established when the projected light spot moved from a first location against the background (representing the initial zero field condition and transmission of the light across the TIR boundary area), to a second distinct location against the background from a reflected path exiting the substrate from the induced TIR boundary. TIR switching with a full switching angle of 6 degrees was observed for an applied voltage of 150V between the electrodes, resulting in an applied field strength of 0.375 V/um.

b. Evaluation of PLZT in SiO₂/Si Microcavities

The ability to integrate PLZT into cavities formed within fused silica substrates was evaluated. Cavities of 20 um and deeper were etched in a planar fused silica substrate using a “Deep Reactive Ion Etching” process. The cavities were successfully filled with PLZT material. Trenches were also formed across waveguides in a planar fused silica on silicon substrate. Optical transparency and electro-optic activity of the PLZT filled trenches were confirmed.

Δn may be empirically correlated with the optimal waveguide crossing angle, such as according to certain test structures such as shown in the insert of FIG. 19C that facilitate faster iteration of and determination of optimized Δn and crossing angle. The test structure shown in FIG. 19C contains a waveguide crossing angle of 20°, one of several test structures used to optimize the configuration for various operating parameters.

The experimental observations confirm that a planar waveguide-based, optical switch matrix may be constructed using an array of stable, solid-state, electronically controlled TIR switching elements in an efficient crossing-waveguide matrix. Such an integrated waveguide/switching structure is readily applicable with AWG-based DWDM to produce a single-platform reconfigurable optical add-drop “engine” suitable for deployment in metro network applications. The planar micro-scale switching matrix also suggests potential applications in cost-sensitive optical datacom applications as well as the potential for other integratable functions such as variable attenuation.

As alluded to above, for certain specific optical switch implementations as herein provided, the incident signal beam generally has a polarization which is parallel to the electric field alignment in order to be reflected by an active TIR boundary. Further variations are herein contemplated, however. For example, where some components of an incoming beam may have parallel polarization, and thus are switched by a first element, while other components with polarization orthogonal to the first element may pass through unaffected, perhaps to later be switched by a second switch having a TIR boundary at the appropriate orientation to now reflect the signal. It is also possible that larger combinations of switches such as the cross connect switch discussed above could be designed to only act upon light of a certain polarization, letting others pass. Many varieties of signal processing are thus possible. All such variations are contemplated by the present invention.

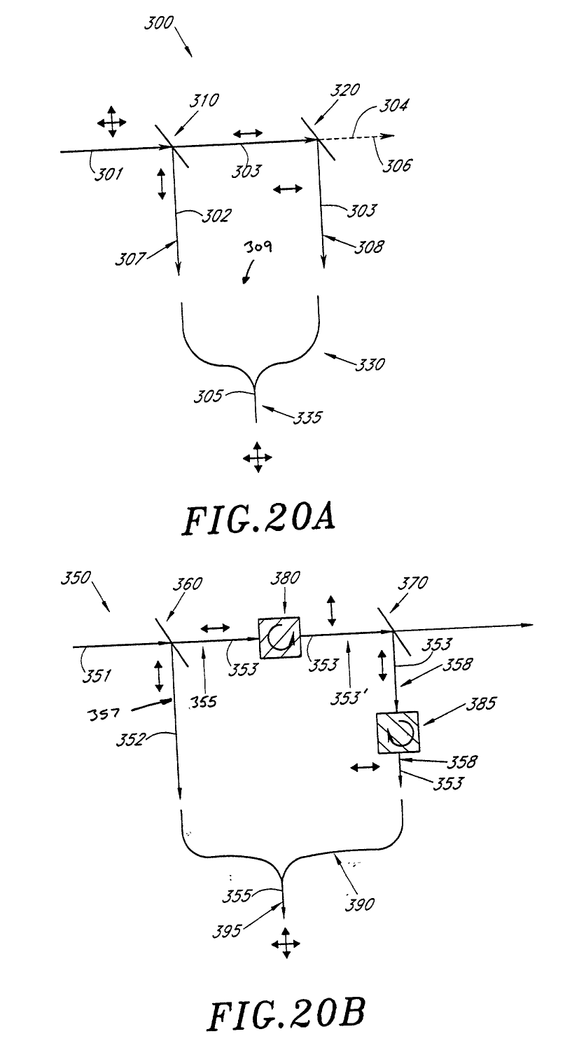

For the purpose of further illustration, optical switching module (300) shown in FIG. 20A uses two different polarization dependent optical switches (310,320) such that each of two orthogonal polarization components of an input light beam (301) may be selectively switched between a first output path (306) and a second output path (309) in the presence of a combiner (330). Switch (310) is configured to be adjustable between transmission and switched modes for a first polarization component of the input beam (301), whereas switch (320) is configured to be adjustable between transmission and switched modes for a second polarization component of beam (301) that is orthogonal to the first polarization component.

When both switches (310,320) are in transmission mode, both polarization components for input light beam (301) propagates through the module (300) and exits as exit beam (304) along output path (306). When switch (310) is in switched mode, a first polarization component of beam (301), shown at first polarized beam (302), is redirected by switch (310) to exit switch (310) along intermediate output path (307). However, the orthogonal polarization component of beam (301), shown at second polarized beam (303), transmits across switch (310) along a path that is incident upon switch (320). When switch (320) is in switched mode, second polarized beam (303) is redirected by switch (320) to exit switch (320) along intermediate output path (308). A combiner (330) recombines separated, polarized beams (302,303) to form a recombined beam (305) that substantially matches input beam (301) and exits module (300) along output path (335).

Thus, module (300) operates to switch input beam (301) with multiple polarization components by:

separating the polarization components from the input beam; independently switching those polarized components with spatially arranged, polarization specific switches; and recombining the separated and independently switched polarized beams into a recombined beam substantially matching the input beam. Moreover, it is to be appreciated that module (300) may be utilized in a manner which separates the two orthogonal polarization components into two different output paths or channels without recombining them, such as by providing one of the TIR switches in reflection mode for one polarization component and the other TIR switch in transmission mode with respect to the other orthogonal polarization component. Also, module (300) may be operated to select between: transmitting beam (301) with both polarization components into output channel (306); and transmitting one polarization component along output channel (306) and switching the other orthogonal component along its respectively selectable intermediate output path (307,308) and into output path (309). Still further, without the presence of combiner (330), module (300) may also be operated in a mode which separates and switches polarized beams (302,303) into separate intermediate output paths (307,308), respectively.

Another optical switching module (350) shown in FIG. 20B is also polarization independent. However, in contrast to module (300) shown in FIG. 20A, module (350) uses two switches (360,370) that are specifically active for the same polarization. Similar to the FIG. 20A embodiment, the first switch (360) selectively redirects a first polarization component of beam (351) as a first polarized beam (352) along intermediate exit path (357). Also similar to the FIG. 20A embodiment, the other orthogonal component of beam (351) transmits as second polarized beam (353) from the first switch (360) along intermediate path (355).

However, second switch (370) is specific to the same polarization as the first switch (360), and is therefore relatively ineffective as a switch to selectively direct second polarized beam (353) along multiple exit paths according to the initial polarization for that beam (353). Thus, a first polarization rotator (380) is positioned along intermediate path (355) between first and second switches (360,370) in order to rotate the polarization for second polarized beam (353) into a substantially similar orientation as the polarization of the first polarized beam (352). When second switch (370) is in the switched mode, the rotated second polarized beam (353′) passing from polarization rotator (380) is redirected by second switch (370) to exit second switch (370) along intermediate exit path (358). A second polarization rotator (385) is positioned along intermediate exit path (358) to then rotate second polarized beam (353) back to its original polarization orientation. After the correct initial orientation for second polarized beam (353) is re-established by the module after switching, combiner (390) then re-combines second polarized beam (353) with first polarized beam (352) to produce the desired, switched output beam (355) that is substantially similar to input beam (351) and exits module (350) along exit path (395).

It is to be appreciated that the optical switch modules shown and described by reference to FIGS. 20A and B may incorporate many different, specific types of polarization dependent switches in order to selectively switch an input light beam with orthogonal polarization components. Nevertheless, for the purpose of further illustration, several specific combinations of polarization specific switches that are believed to be highly beneficial in these applications are herein described as follows.

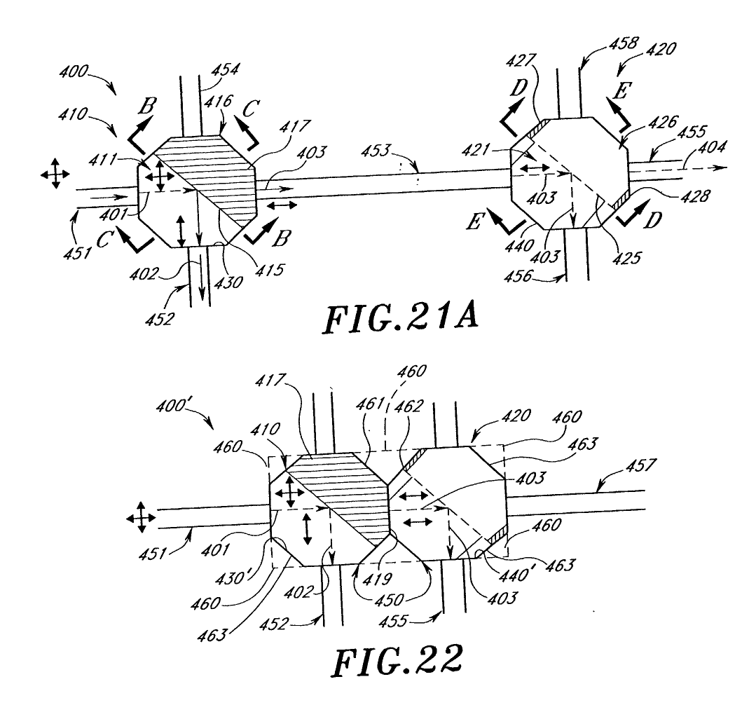

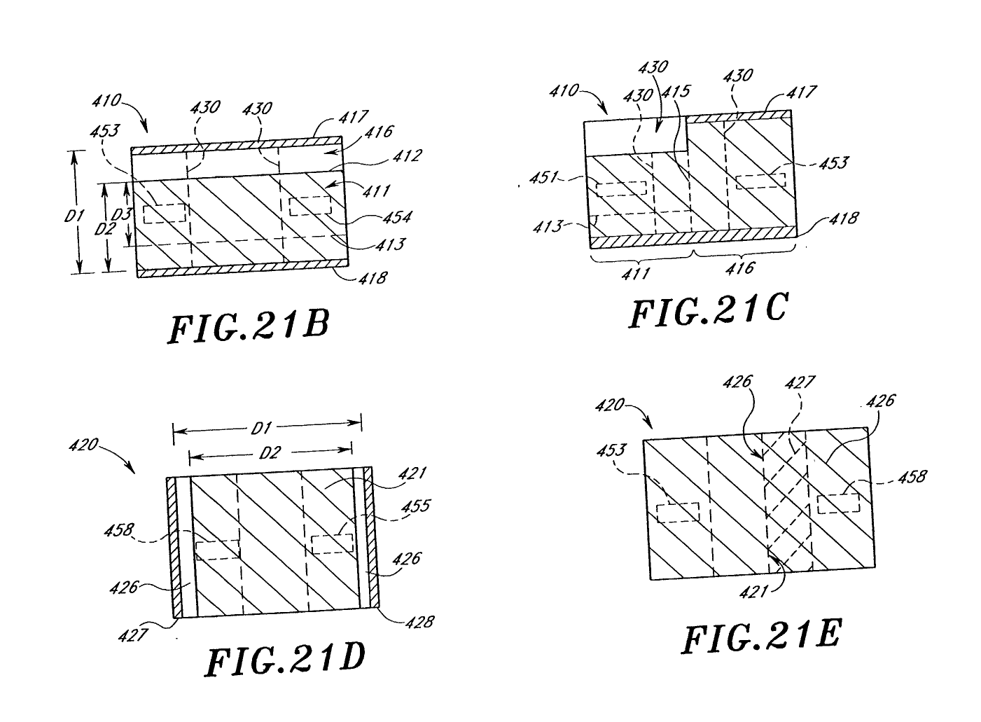

FIG. 21A shows one highly beneficial combination of two switches that are serially coupled in a planar waveguide setting for the purpose of forming an optical switching module of the type described above by reference to FIG. 20A. More specifically, first and second switches (410,420) are formed within cavities (430,440), respectively, which are formed in two cross-connect regions of various waveguide segments as follows. First switch (410) is formed at the cross-connect region between two respectively aligned pairs of orthogonally positioned waveguide segments (451,453) and (452,454), respectively. Second switch (420) is formed at the cross-connect region between two other respectively aligned pairs of orthogonally positioned waveguide segments (453,455) and (456,458), also respectively. As will be further developed below, one common intermediate waveguide segment (453) optically couples first switch (410) and second switch (420) and is linearly aligned with input waveguide segment (451) incident upon first switch (410) and exit waveguide segment (455) that exits second switch (420).

The specific structure shown in FIG. 21A for first switch (410) is generally of the type similar to that shown in FIG. 9B. In other words, first and second regions (411,416) are arranged to form a boundary (415), and second region (416) contains an electro-optic material, which may be for example PLZT, and is electroded in order to create an electric field in that material that changes the index of refraction in the second region (416). As shown in part at top electrode (417), the electrodes of this switch (410) are spaced vertically to create a vertically oriented electric field in the electro-optic material in order to selectively create a TIR surface at the boundary (415) for specific polarization components of input beam (401). When the TIR surface is formed due to different optical refraction indexes between first and second regions (411,416), first polarized beam (402) is separated from input beam (401) and is reflected to exit switch (410) along waveguide segment (452). However, as described above, the orthogonal polarization component for input beam (401) substantially transmits across boundary (415) and into intermediate waveguide segment (453) toward second switch (420).

Second switch (420) shown in FIG. 21B may be of a similar electro-optically activated type as that shown for first switch (410), and may generally be the same material. However, first and second electrodes (427,428) of second switch (420) are respectively separated in an orthogonal plane relative to the electrodes of first switch (410) such that the electric field in the electro-optic material of second switch (420) is orthogonal to the electric field created in the electro-optic material of first switch (410). In the event similarly active electro-optic materials are used in the first and second switches (410,420), the orthogonally oriented e-fields of these switches result in refractive index changes that are also respectively orthogonal, and therefore the affected polarization components for TIR purposes are also orthogonal for the respective switches. Thus, the second polarized beam (403) exiting first switch (410), which is orthogonal to the first polarized beam (402) reflected by first switch (410), is reflected at the TIR boundary (425) by the second switch (420) and is directed to exit second switch (420) along exit waveguide segment (456). As previously described, exit waveguide segments (452) and therefore first and second polarized beams (402,403), respectively, may be combined with a combiner (not shown) in order to complete an optical switching module for the whole of input beam (401).

As variously shown in FIGS. 21A-E, the material in each of cavities (430,440) is formed in a manner that provides a stepped thickness transition at the respective boundaries (415,425) of each switch (410,420). As previously described above, the material in each respective first region (411,421), where an electro-optic effect on index of refraction is not desired, has a reduced thickness compared to the respectively adjacent second region (416,426) so that the first region material does not border at least one of the electrodes along the adjacent second region. This is believed to reduce electric field fringing from the electroded second region into the material in the adjacent first region, and therefore results in a more planar TIR boundary of distinctly different optical refraction indexes between the bordering regions. Such thickness difference may be the result of forming a step in the material along one side of the bordering regions, such as is shown at step (412) in FIGS. 21A and B for switch (410) at the top of first region (411) in cavity (430). The thickness transition may also include a step in the material adjacent to the other opposing electrode, as is also shown for switch (420) in FIGS. 21A, D and E, and shown in shadow for switch (410) at step (413) in FIGS. 21B and C. By providing the thickness steps on each side of the first region, the material in that region no longer adjoins either electrode along the corresponding second region. It is further believed that a more planar TIR boundary results from this arrangement due to further enhanced electric field collimation within the electrode-bounded second region via reduced fringing of the electric field at both ends of the material of the first region.

Though specific electro-optic switching embodiments are shown in FIGS. 21A-E for optical switch module (400), other specific, polarization dependent switches may be incorporated into the overall assembly and still take advantage of the overall relationship shown for module (400) that allows for a polarization independent switching result. For example, other specific arrangements of electro-optic and non-electro optic material may be incorporated into the cavities (430,440) shown in FIG. 21A for the same purpose, such as is described above by reference to FIGS. 9A-G.

Furthermore, two polarization dependent switches may be formed as one integral structure, according to the polarization independent switching module of the invention, in an arrangement that does not require a waveguide segment in order to optically couple a polarization component passing through the first switch and into the second switch.

The specific embodiment shown in FIG. 22 provides two different polarization dependent TIR switches (410,420) which are similar to those shown in FIGS. 21A-E, but which are integrated and adjoined to each other in a single, contiguous “free-space” cavity formed within a planar waveguide structure. The electrode pairs (417,418) and (427,428) of each respective switch may be configured for independent activation, or may be configured to be activated separately. Because this arrangement brings the polarization dependent switches (410,420) closer together, the overall module (400′) may be made smaller which has advantages in applications where the available real estate for optical switching is limited. However, the combined cavity embodiment shown in FIG. 22 may require certain design considerations that are unique to this embodiment.

In one regard, it may be desirable to minimize possible refraction of beam (403) as it transmits from the activated, relatively lower index material of second region (416) into the relatively unactivated and higher index material of first region (421). Therefore, top electrode (417) and the opposite bottom electrode (not shown in FIG. 22) along second region (416) are preferably arranged to create a substantially perpendicular border (419) relative to the beam (403) at the location where activated second region (416) of first switch (410) borders first region (421) of second switch (420).

In another regard, it is possible that undesirable electrical and/or optical “cross-talk” may result between the integral, adjoining switches according to this embodiment. Therefore, such considerations may dictate further modifications to the integral structure, or the application of the alternative “waveguide-coupled” embodiment, for certain specific uses. For example, proper electro-optic operation of the adjoining switch components may limit available geometries and distances between the integral and adjoining switches, in particular where capacitance of the integral material is observed to affect electric field collimation and therefore planarity of the respective TIR boundaries. In other words, the field collimation between either or both of the two electrode pairs may be degraded by the overall capacitance of the increased volume of integral electro-optic material in the overall cavity, and/or by the mutual presence of the other respectively activated electrode pair applied to the same integral material.

In another regard, as illustrated by the previous embodiments, the cavity-filled switch embodiments shown in FIGS. 21A-E and 22 result in non-guided, “free-space” propagation of the incident light through the respective cavities (430,440) and (450). Some loss of the light signal may result as a function of distance traveled through the free-space domain in the cavities. More specifically, light exiting the incident waveguide segment and entering the free-space switching cavity generally exhibits “near-field” optical properties and acts substantially collimated through relatively short distances. Sufficiently short cavities thus substantially provide for “near-field” coupling of light to the corresponding exit waveguides with a substantially similar beam size as that which entered the switch, and therefore limited optical coupling loss from input to output. However, further distance in the non-guided free-space domain may result in more “far-field” properties wherein the beam acts less collimated and more divergent through the switch. Longer cavities such as of the FIG. 22 embodiment may thus result in “far-field” coupling of an exit beam into the exit waveguide segments with a larger beam pattern than entered the switch, and therefore increased optical coupling loss into the output segment.

Accordingly, a collimator may be used to more literally collimate input beams incident upon an optical switching module having a relatively long free-space domain, such as according to the FIG. 22 embodiment. Collimators of various types are widely known, and are commercially available for this application. However, a unique benefit results by combining active collimation with a free-space cavity that is formed within a planar waveguide and contains integral, multiple optical components. A particular unique benefit of such combination is the ability to provide a multiple component switching module such as according to the FIG. 22 embodiment. By actively collimating the beam before it exits an incident waveguide segment and enters a “free-space” switch such as that shown in FIG. 22, the beam size may be more appropriately maintained over a much longer propagation distance in the switch than for input beams passively emerging from a waveguide termination and into the switch without such active collimation.

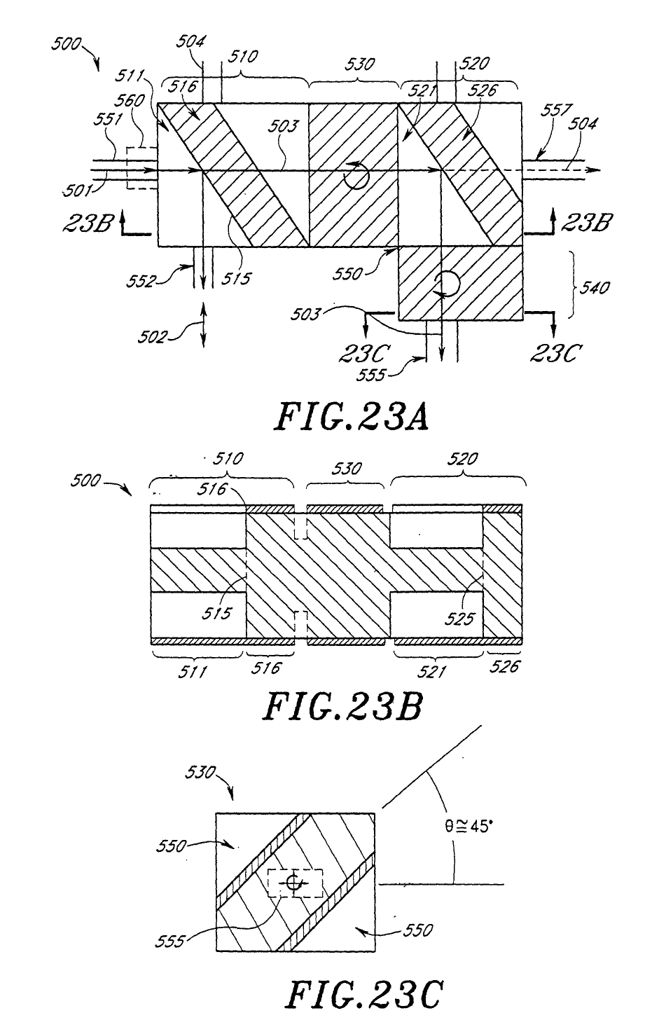

Optical switching module (500) shown in FIGS. 23A-C further illustrates one beneficial embodiment for use according to the embodiment shown schematically in FIG. 20B and described above. More specifically, optical switching module (500) includes first and second switches (510,520) and first and second polarization rotators (530,540) that are formed within one contiguous free-space domain within one cavity formed in a planar waveguide structure. In the particular beneficial embodiment shown, each of these structures (510,520,530,540) is formed from an electro-optic material, which may be the same material and may be formed from a contiguous filled cavity (550). Each electro-optic structure performs its respective function in the overall, polarization independent switching module (500) based upon an electro-optical response in the respective material to an applied energy field as follows.

A transmission mode is achieved for module (500) as follows. Switches (510,520) are provided in transmission mode such that there respective pairs of first and second regions (511,516) and (521,526) have substantially matched optical refraction indexes. First and second polarization rotators (530,540) are each provided in an “inactive” mode, such that the polarization of light passing therethrough is relatively unaffected. In the event the rotators (530,540) are configured such that electro-optic activation is used for polarization rotation, such as for example in the event the rotators are constructed of PLZT, the “active” mode for the rotators corresponds to a sufficient applied electrical field at an angle with respect to the polarization of the input beam (preferably 45 degree angle from the reference input polarization for a desired 90 degree polarization rotation). Therefore, the “inactive” mode for the rotators corresponds to an electric field at that angle which is insufficient for such rotation, preferably zero electric field.

With the switches (510,520) in transmission mode, and rotator (530) in its corresponding “inactive” mode, input beam (501) propagates through module (500) and couples into exit waveguide segment (557) substantially unchanged. However, as described above, the length of cavity (550) may require use of a collimator (560) in order to reduce far-field loss due to the free space propagation of input light beam (501) from input waveguide segment (551), across three serially positioned optical components (510, 520, 530) in cavity (550), and into exit waveguide segment (557).

The TIR reflection mode of operation for module (500) may be accomplished as follows. Switches (510,520) in the embodiment shown are each of similar structure and operate to selectively switch light having a similar polarization orientation. Switch (510) is activated to produce a TIR boundary (515) for switching a first polarization component of input beam as first polarized beam (502) that is directed upon reflection at boundary (515) toward exit waveguide segment (552). Because switch (510) is polarization dependent, a second polarized beam (503) orthogonally aligned with respect to first polarized beam (502) passes through TIR boundary (515) substantially unreflected and enters polarization rotator (530). Polarization rotator (530) formed within the cavity (550) between switch (510) and switch (520) is activated to rotate the second polarized light beam (503) to have a modified orientation that is appropriate for switching at switch (520), which in the specific embodiment is similarly aligned as first polarized beam (502). Second polarized beam (503) in its rotated alignment enters switch (520) that is activated to create TIR boundary (525) that substantially reflects rotated second polarized beam (503) toward second polarization rotator (540). Second polarization rotator (540) is activated to rotate the switched second polarized beam (503) back to substantially its original orientation for coupling into exit waveguide segment (555). Activation of the respective switches and polarization rotators is generally done simultaneously in order to direct first and second polarized beams (502,503) into their respective exit waveguides so that they may be recombined by a combiner (not shown), as previously described.

The polarization independent switching module (500) just described provides several independently beneficial aspects of the invention. In one aspect, two polarization dependent switches act specifically on two, similarly aligned polarization components of light that are then combined in a manner which allows for switching of a complex light beam having multiple polarization components. In another regard, two polarization rotators are combined in a switching module in a manner that rotates a light beam away from its original polarization component for the purpose of switching and then rotates the switched beam back substantially into its initial polarization alignment. In still a further regard, a switching module is provided which rotates a polarized beam for switching with a polarization dependent switch. Further to this aspect, this module may be further constructed to rotate the switched polarized beam back to its original alignment.

Still further, combining at least one polarization rotator and switch within a common contiguous free-space region formed within a planar waveguide structure is also contemplated as a beneficial aspect of the invention. Further highly beneficial aspects also include combining within such a cavity either or both of two polarization rotators or two switches, or other permutations of rotator and switch combinations, such as according to the specific beneficial embodiment herein shown in FIGS. 23A-C.

As previously described above, optical components formed in sufficiently long “free-space” cavities for coupling multiple waveguide segments may require active beam collimation as the beam enters the cavity in order to prevent light coupling loss through the structure and into the respective exit waveguide segment. Other design considerations may also be appropriate in order to address other undesirable consequences that may result from combining multiple electroded, electro-optic components in a contiguous electro-optic material within such a cavity, such according to the FIGS. 23A-C embodiment. For example, electrical cross-talk between the components may also result. In particular, the variously electroded regions may electrically couple (e.g. capacitively couple) to the adjacent electro-optic material regions. Such coupling may affect localization of field strength and may detrimentally affect the voltages necessary to achieve a particular field strength and hence desired mode of electro-optic operation. Therefore, it may be desirable in certain applications to design the respective cavities to minimize the amount of electro-optic material that is not necessary to affect the light as intended. For example, cavity (450) shown in FIG. 22 has a geometry that reduces the overall area from a simple rectangle that would otherwise encompass the respective components, shown for reference in shadow at perimeter (460). Such rectangular area of electro-optic filled material is reduced, such as in the regions of surfaces (461,462) and the surfaces (463) reducing the corners of the reference rectangular perimeter.

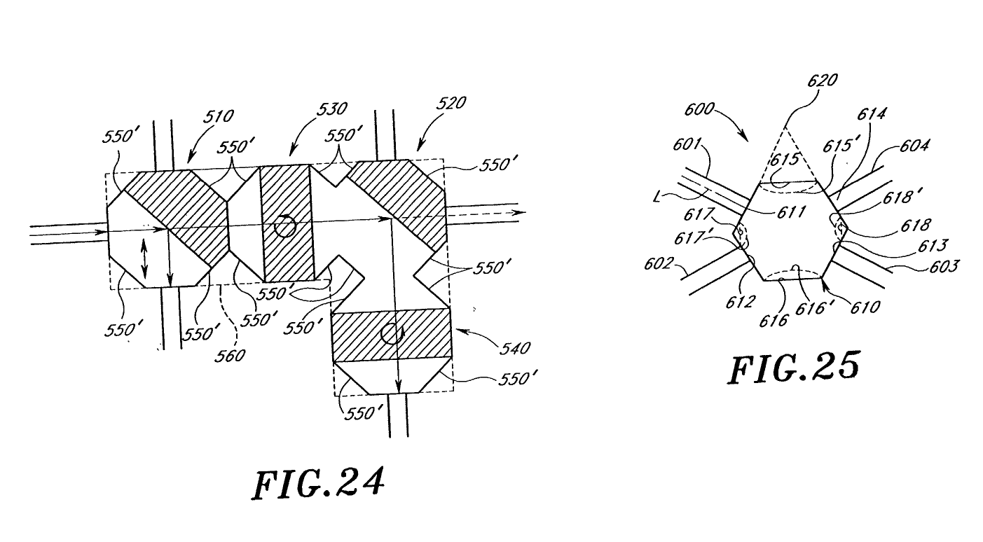

A further example is shown in FIG. 24, wherein a similar module (500) as that shown in FIG. 23 has its optical components (510,520,530,540) formed within a cavity (550) with an outer perimeter shown variously at outer surfaces (550′) that is shaped to reduce the electro-optic filled regions of a reference perimeter (560) that are not necessary for the components to perform their respective optical functions. In the case of longer cavity modules such as FIGS. 23 & 24, issues of cavity geometry as herein described may be pronounced due to the larger overall electro-optic volume that interacts across multiple electroded regions.

The issues of cavity geometry also relate to the simple “one-switch” structure according to the various embodiments herein shown and described, and as further illustrated by reference to cross-connect switch (600) shown in FIG. 25. Switch (600) is formed within cavity (610) that is generally hexagonal. Four of the six cavity walls (611,612,613,614) are oriented for flush termination of waveguide segments (601,602,603,604), respectively, as they interface at the respective walls into the free-space domain of the cavity. In other words, each of these four cavity walls (611,612,613,614) is substantially perpendicular to the propagation axis of incident light from the associated waveguide segment, as shown for example at wall (611) that is perpendicular to axis L of waveguide segment (601). The other two walls (615,616) do not interface with waveguide segments, as will be further developed below.

To initially illustrate the various geometry considerations for the cavities and associated switches of the invention, the hypothetical cavity representing the most simple combination of the waveguide interfacing surfaces (611,612,613,614) simply extrapolates these surfaces until they intersect to form a simple four-sided structure, e.g. as shown in part at reference corner (620). However, walls (615) and (616) effectively remove two corners from such four-sided structure, such as shown by corner (620) bounded by wall (615). A hexagonal (six-sided) structure bounded by walls (611,612,616,613,615) results that is smaller than the simple four-sided structure but efficiently preserves the optically useful free-space area.

As a further material-efficient modification, walls (617,618) similarly remove the other two corners from the simple four-sided cavity geometry that otherwise remained in the hexagonal design, such that an octagonal structure results by forming cavity (610) with the following walls shown (611, 617, 612, 616, 613, 618, 614, 615). The desired TIR boundary of a switch in a cavity as herein described generally corresponds to a relatively shallow critical incident angle, such that the shape of the resulting cavity, in any of the forms herein described, is generally longer along one axis and shorter along the respective transverse axis.

Several broadly beneficial aspects of the invention are illustrated by the various cavity geometries just described in detail. In one regard, a cavity is formed in a planar waveguide structure with n walls corresponding to n intersecting waveguide segments, and with at least 1 additional wall that does not intersect with a waveguide (e.g. n+m walls corresponding to n intersecting waveguide segments). In general, such additional wall(s) allows for cavity reduction as herein described. Though, these additional walls may have other uses, such as for example electrode deposition for the purpose of horizontal electric field application to electro-optic material within the cavity, as elsewhere herein shown and described.

In the particular hexagonal embodiment shown and described, the respective cavity has 6 walls, wherein 4 walls interface with 4 waveguide segments and 2 walls do not. This broadly represents a planar waveguide cavity with three pairs of opposite walls, wherein two pairs of opposite walls correspond to two respective pairs of optically aligned waveguide segments. The embodiment shown further illustrates the third pair of opposite walls which are not associated with interfacing waveguide segments, though a third pair of optically aligned waveguide segments may be interfaced with these walls as well. In another regard according to this aspect, pairs of input and output waveguide segments are separated along a long axis of a cavity in order to provide a critical angle for TIR reflection within the cavity; 2 additional walls extending along the long axis of the cavity do not intersect with a waveguide segment.

In the particular octagonal embodiment shown and described, the respective cavity has 8 walls; 4 walls interface with 4 waveguide segments, and 4 walls do not. In one regard, this octagonal arrangement broadly illustrates a cavity with 2n walls corresponding to n interfacing waveguide segments. In another regard, the 2n walls of the cavity correspond with n/2 pairs of waveguide segments wherein each respective pair of waveguide segments is optically aligned across the cavity.

The beneficial broad features of the various waveguide cavities just described also translate to the switch formed within the respective cavities, in particular to the extent that the walls of the cavity correspond to the walls of the material filling the cavity. Thus, the illustrative hexagonal or octagonal cavities and their corresponding beneficial features correspond to similar hexagonal or octagonal free-space switching structures, in particular formed of electro-optic material such as for example PLZT. Such material geometries for switches, e.g. hexagonal, octagonal, n+m walls with n optical inputs/outputs, etc., are considered as beneficial aspects of the invention whether the switches are formed within a waveguide cavity or otherwise.

Moreover, to the extent the various cavities and related filled material components are herein described by reference to “waveguides”, other substrates or interfacing assemblies than waveguides are also contemplated. For example, optical inputs and outputs into the switch structures and/or cavities may be coupled by other means, such as for example direct optical fiber coupling to the structure or free-space coupling. In any event, the benefits of reducing unnecessary material integral with a desired energy activation region of a TIR switch, and therefore the benefits of the corresponding switch and/or cavity geometries herein described, remain.

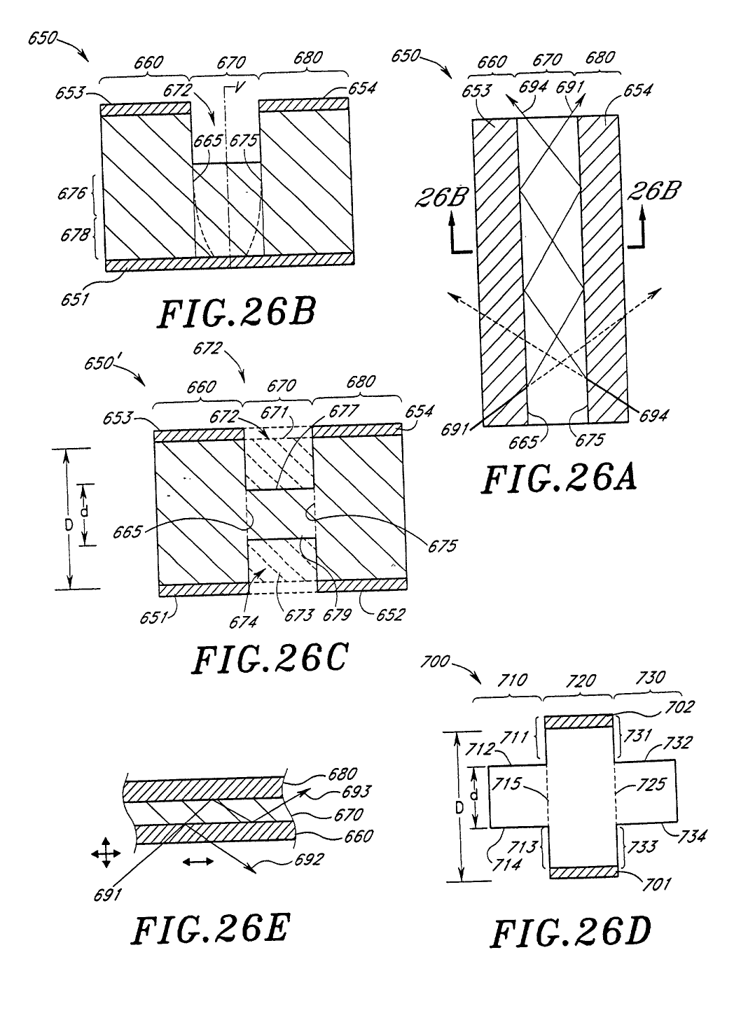

Various of the embodiments described above illustrate polarization dependent switches that selectively switch input light beams coming from one side of a single TIR boundary formed at least in part of electro-optic material. Other embodiments described illustrate polarization independent switching modules that use various combinations of polarization dependent switches. Further embodiments shown in FIGS. 26A-E illustrate various aspects of an electro-optic UR switch that selectively switches input light beams coming from either of two sides of a TIR boundary region.

More specifically, switch (650) shown in FIG. 26A has first and second regions (660,670) in a stepped configuration similar to that previously shown and described above. However, FIG. 26A further shows a third region (680) that is adjacent second region (670) opposite first region (660). A bottom electrode (651) extends across all the regions (660,670,680), whereas top electrodes (653,654) are disposed opposite bottom electrode along first and third regions, respectively.

A switch constructed as just described has been observed to selectively switch light entering the switch (650) from either first region (660) or third region (680) as follows. When substantially zero voltage is applied between either or both of top electrodes (653,654) and bottom electrode (651), light entering switch (650) at an angle in either first region (660) or third region (680) has been observed to pass through that incident region, through second region (670), and exit the switch (650) along the other opposite region (660) or (680), respectively. However, upon application of voltage between top electrode (653) and bottom electrode (651), light entering from either first or third region (660,680) at the same angle has been observed to reflect within switch (650) and to exit switch (650) along the same incident region.

Similar observations have also been made upon application of a voltage between bottom electrode (651) and top electrode (654) along third region (680), or between bottom electrode (651) and both top electrodes (653,654) along both first and third regions (660,680), also respectively.

As further shown in FIG. 26A, and also in FIG. 26B, the observed operation of switch (650) as just described is further believed to result from the formation of two TIR boundaries within switch (650) upon application of the voltages as described. More specifically, TIR boundary (665) is believed to be formed between first and second regions (660,670), and TIR boundary (675) is believed to be formed between first and third regions (660,680). Upon application of voltage between bottom electrode (651) and both top electrodes (653,654), electric fields are induced in each of first and third regions (660,680) with a corresponding change in the electro-optic material in each respective first and third region (660,680). However, second region (670) does not experience a similar field, and therefore a stepped transition in optical refraction index results at boundary (665) where the reduced index first region (660) borders second region (670), and also where second region (670) borders the reduced index third region (680). Therefore, as shown in FIG. 26B, light beam (691) entering from the first region (660) is believed to be reflected at the TIR boundary (675) between second and third regions (670,680), since according to the direction of propagation for incident beam (691), N₁<N₂>N₃. Similarly shown in FIG. 26B, light beam (695) entering from the third region (680) is believed to be reflected at TIR boundary (665) between first and second regions (660,670), since according to the direction of propagation for incident beam (695), N₃<N₂>N₁.

Moreover, light beam (694) entering first or third region (660,680) with a substantially perpendicular or horizontal trajectory relative to vertical axis V, and with a verticality relative to axis V that corresponds with section (676) shown, has been observed to reflect and exit switch (650) with substantially the same verticality as the incident beam. However, light entering switch (650) with a similar horizontal trajectory, but with a verticality that corresponds with section (678) shown, has been observed to reflect with a different exit verticality than the incident beam. Therefore, it is believed that this observation for the structure of FIG. 26 results from a TIR boundary which is substantially planar and vertical along section (676), but which has an “off-vertical” angle along section (678) that corresponds with the bottom of second region (670). This angled lower section (678) of the TIR boundary is further believed to result from a more pronounced fringing of the applied electric field into second region (670) along lower section (678) that is bordered by bottom electrode (651). The TIR boundary along upper section (676) is believed to be more vertical due to more substantially reduced fringing into second region (670) along that section which is sufficiently spaced from top electrodes (653,654).

Switch (650′) shown in FIG. 26C is similar to switch (650) shown in FIG. 26A, except that second region (670) is bounded not only by a top groove (672) (as in the FIG. 25 embodiment), but also by a bottom groove (674). Therefore, similar to switch (650) in FIG. 26A, switch (650′) has a first region (660), a second region (670) adjacent the first region (660), and a third region (680) adjacent the second region (670) and opposite the first region (660). All regions (660,670,680) are formed from a contiguous electro-optic material. Both first and third regions (660,680) each have associated pairs of top and bottom electrodes (651,653) and (652,654), respectively. Second region (670) however is not bordered by either a top or a bottom electrode, and has a reduced thickness “d” compared to the thickness D of first and third regions (660,680). Second region (670) is generally formed by forming top and bottom grooves (672,674,) in an initial block of integral electro-optic material such that regions (671,673) shown in shadow are removed. Such grooves result in forming the two respective pairs of bottom and top electrodes (651,653) and (652,654) for first and third regions (660,680), and also result in forming top and bottom surfaces (677,679) of second region (670) that are stepped away from and are not closely adjacent to the electrode pairs (651,653) and (652,654), respectively.

The structure shown in FIG. 26C may be operated in a similar manner as described above with respect to FIGS. 26A-B. By applying a voltage to each electrode pair (651,653) and (652,654), respectively, electric fields are respectively applied to first and third regions (660,680). An electro-optic response in these first and third regions (660,680) produces a change in optical refraction index there. However, such simultaneous voltage application to the electroded regions (660,680) has been observed to produce little overall electric field strength within the intermediate second region (670). As such, two boundaries (665,675) result that at similar locations of adjoining regions as the similarly referenced boundaries in FIG. 26A. However, the two boundaries (665,675) in the FIG. 26C structure have been observed to be substantially planar over most of the vertical aspect of second region (670). Very little, if any, modified vertical trajectory of reflected beams has been generally observed along the lower section of the second region (670) such as previously described with respect to the TIR boundary along lower section (678) in the FIG. 26A embodiment.

Still a further “double sided” TIR switch variation is shown in FIG. 26D, wherein switch (700) has three bordering regions (710,720,730) and two resulting TIR boundaries (715,725) as previously described. However, the FIG. 2D embodiment illustrates a somewhat reciprocal structure for intermediate second region (720) and the opposite first and third regions (710,730) in contrast to the FIGS. 26A-C embodiment. In the present embodiment, second region (720) is electroded with opposite electrodes (701,702) and has the relatively larger diameter D. First and third regions (710,730) are the regions having a reduced diameter d with opposite top and bottom surfaces (712,714) and (732,734), respectively, that result from top and bottom steps (711,713) and (731,733), also respectively, formed in the integral material that comprises switch (700). This structure also results in “two-sided” TIR switching variously at the boundaries (715,725).

A “double sided” TIR switch such as the specific embodiments just described may be further modified, such as according to the other embodiments herein disclosed. For example, the specific embodiments for FIGS. 26A-C were described to use a “decreasing” electro-optic material in the first and third regions (660,680); the FIG. 26D embodiment was described by use of an “increasing” index material second region (720). However, electro-optic material in the first and third regions (660,680) of the FIGS. 26A-C version may also “increase” its index of refraction relative to the neighboring second region (670), and material in the second region (720) of the FIG. 26D embodiment may also “decrease” its index relative to neighboring first and third regions (710,730)—in either case TIR reflection may still result for light beams entering from either side of the switches. For further illustration, light entering the increased, higher index first region (660) of the FIGS. 26A-C embodiment would reflect at TIR boundary (665) adjacent to the relatively lower index second region (670); light entering the relatively higher index third region (680) would reflect instead at TIR boundary (675) between second and third regions (670,680). Similar TIR boundaries with respect to the same reference incident beams may be formed by using a decreased and relatively lower index material in second region (720) of the FIG. 26D embodiment.

Other material iterations may be substituted for any of the FIGS. 26A-D embodiments and still result in TIR switching. For example, the relationships of bordering material regions described above by reference to FIGS. 9A-G may be used to construct various different TIR structures for switching according to the designs illustrated by FIGS. 26A-D.

In one highly beneficial mode, a material that exhibits an increasing electro-optic response in one plane and a decreasing electro-optic response in an orthogonal plane (e.g. PLZT) may be used in any of the structures shown in FIGS. 26A-D embodiment and provide for polarization independent switching. Similar to the other polarization independent switching modules described above, such a structure would switch each of two orthogonal polarization components at different TIR boundaries. However, in this particular embodiment, the two orthogonally aligned components are switched simultaneously at two boundaries formed at least in part by one activated switch region (vs. requiring two separately activated polarization dependent switches, which may be integrated into a common cavity, according to the other previous embodiments).

As shown in detail in FIG. 26E, an input light beam (691) incident upon first region (660) of a switch according to respectively specific modes for any of the embodiments of FIGS. 26A-D could be selectively switched as follows. The index of refraction in first region (660) is higher than in second region (670) with respect to a first polarization component of light beam (691), shown as first polarized beam (692). However, the index of refraction in second region (670) is higher than in either first region (660) or third region (680). Therefore, first polarized beam (692) reflects at TIR boundary (665) where N₁>N₂. An orthogonally aligned polarization component, second polarized beam (692), passes across TIR boundary (665) and reflects at a different TIR boundary (675) where N₂>N₃. This separate TIR reflection treatment for the polarized beams (692,693) also separates them spatially, as shown in FIG. 26E. Therefore, a combiner is still generally required to efficiently recombine the separated polarized components into an exit beam that is substantially similar to input beam (691).

For the purpose of further illustration, one specific “H” shaped electro-optic TIR switch that was arranged generally according to the three region configuration shown in FIG. 26C, and which has been observed to operate according to certain modes of the invention as described herein (in particular with respect to FIGS. 26A and E), was constructed as follows. A 1″ (length)×1″ (width)×410 nm (0.41 mm) (thickness) wafer of PLZT in a 9/65/35 composition is provided as an initial substrate upon which to form the switch. Chrome (Cr) is deposited onto the PLZT as an adhesion promoting layer; Au (gold) is deposited over the Cr.

Two opposite trenches are then diced down into the PLZT wafer perpendicular to the plane of the wafer, thus removing the Au/Cr coating as well as groove portions of the PLZT substrate itself. This dicing is performed using standard semiconductor dicing blades selected for making grooves on opposite sides of the plane having well matched width and locations. The diced trenches are aligned on both sides of the wafer first reference through the wafer cut with 90 degrees side wall was made close to the edge of the wafer. The wafer may also be diced all the way through the wafer in order to separate individual devices, such as for example for mass production of multiple devices from a single wafer. Optical input and output faces of a device with trenches diced as just described are then polished in order to be optically transparent, using for example a 0.5 um grid size diamond polymer polishing film. An anti-reflective coating may then be applied to the input and output faces of the device in order to reduce Fresnel reflections on the PLZT/Air optical interface. For the purpose of still further illustration, a device constructed substantially as just described and that was observed to be a suitable TIR switch according to certain aspects of the invention had the following dimensions: overall switch length (along the longitudinal axis of the diced grooves)—1.8 mm; overall switch width (perpendicular to the diced grooves across three bordering regions)—5.0 mm; overall switch thickness (between opposite outer surfaces of the wafer having the opposite grooves formed therein)—0.41 mm; width of the diced grooves—160 um; depth of the cut (perpendicular down into the PLZT wafer)—80 um; length of the grooves (along their long axis)—1.8 mm.

The TIR switch just described was observed to operate as follows. A 300V linear ramped, square wave voltage drop was placed between each of two pairs of opposite electrodes formed by the wafer dicing operation described. A laser diode (650 nm wavelength, i.e. red) at about 2 mW power was used as a light source. A polarized cube beam splitter was positioned between the light source and the TIR switch in order to control orientation of incident light polarization onto the device. Still further, a focusing biconcave glass BK-7 lens with focal length of 50 mm was used to launch light through the device.

According to the operating parameters just described, the following was observed when 0 volts was applied between the electrode pairs, respectively—light was transmitted through the device and red round shaped spot was imaged onto the screen behind the device. No reflecting virtual boundary was observed to be induced. Nevertheless, some scattered light could be seen around the transmitted spot which is believed to be associated with imperfections in polished input-output facets, and possibly unoptimized porosity/grain structure of bulk PLZT wafer.

However, when a positive non-zero voltage was applied between the electrode pairs, a TIR reflecting boundary was observed to be created to the extent that a red light spot on the screen was reflected in the horizontal plane on the screen to a new position. There was no additional scattered light introduced when the laser beam was switched according to visual observation. Moreover, a dark spot was left over on the place where light spot was observed before switching, indicating that switching occurred with high contrast and in full. When operated in the middle part of the TIR boundary reflected light spot was round shaped and switched in horizontal plane (polarization component of the input light beam that is orthogonal to the applied electric field between electrodes). A switching angle of 4 degrees was measured at 300V applied—this angle corresponds to a calculated estimate of critical angle based on the 3.8×10⁻¹⁶ m²/V² electro-optic coefficient provided by AURA Ceramics, the vendor of the PLZT material used in the device.

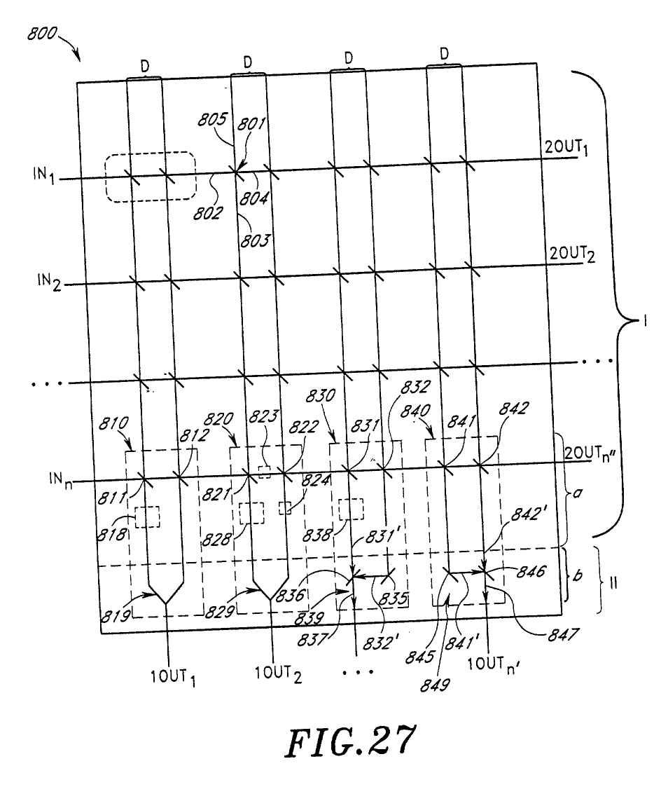

As introduced above, the optical elements and modules, and in particular TIR switching embodiments shown and described, are well suited for integration into planar waveguide structures. One such overall planar waveguide structure (800) is shown in FIG. 27, and is described as follows.

Planar waveguide structure (800) includes various “2×2” cross-connect regions, such as is illustrated at cross-connect region (801) where the axes of optical alignment for two respective pairs of optically aligned waveguide segments (802,804) and (803,805) intersect, as is well known in the art. Various modes for implementing the polarization independent switching modules described above are shown at modules (810,820,830,840), respectively, which are each described by reference to their planar waveguide implementation as follows.

Polarization independent optical switching module (810) is shown to be of similar type as that described above by reference to FIGS. 20A and 21A-22; switch (811) and switch (812) are each polarization dependent switches that selectively switch polarization components of light that are orthogonally aligned with respect to each other. Polarization independent optical switching module (820) is shown to be of similar type as that described above by reference to FIGS. 20B and 23A-24; switch (821) and switch (822) are each polarization dependent for selectively switching polarized beams with similar alignment, and polarization rotators (823,824) are therefore included in the module (820) for selected polarization rotation as previously described above.

As also previously described above, in either case of the module (810) or module (820) embodiments, polarization independent switching is accomplished by separating an input beam into orthogonally polarized beams that are each switched by polarization dependent switches, and then the separated beams are recombined. Modules (810,820,830,840) therefore include combiner assemblies (819,829,839,849) that recombine the respectively separated beams being switched by each respective module. Such combiner assemblies (819,829,839,849) may be integrated into the planar waveguide structure (800). Or, a separate planar combiner array structure may be directly interfaced to the planar waveguide structure (800), as shown by example at the interface between planar structures I and II in FIG. 27.

Further combiner array variations are also contemplated other than those specifically shown in FIG. 27. For example, planar combiner array structure II may be indirectly coupled to the respective output waveguide segments of planar waveguide structure I, such as by free-space alignment (which may employ use of collimators, as previously described) or by separate optical waveguide coupling (which may be yet a third planar waveguide structure or individual fibers, etc.). Moreover, separate combiners that are not integrated together may be each individually coupled to the respective separated channels to complete each polarization independent switching module, according for example to the various coupling modes immediately described above.

In any event, such combiners may be of various previously disclosed and commercially available types. Furthermore, modules (830,840) are also herein shown in order to illustrate other means for combining, and in particular to schematically illustrate two recombining variations that use further reflective mirrors in order to recombine the separated beams.

More specifically, module (830) includes switch (831) that directs first polarized beam (831′) toward one side of mirror (836) that is substantially non-reflective to first polarized beam (831′) that transmits through mirror (836) and propagates along output path (837). Second polarized beam (832′) transmits through switch (831) and is directed by switch (832) toward mirror (835) that reflects second polarized beam (832′) toward a side of mirror (836) that is reflective to second polarized beam (832′) that therefore reflects along output path (837) overlapped with first polarized beam (831′) transmitting through mirror (836). Such overlap provides the recombination of the orthogonally polarized beams (831′,832′).

The recombination of separated beams (841′,842′) for module (840) operates in a similar manner as that just described for module (830). However, in this variation first polarized beam (841′) is instead reflected by mirror (845) toward one side of second mirror (846) for subsequent reflection along output path (847). Second polarized beam (842′) transmits through the opposite side of second mirror (846) to overlap with reflected first polarized beam (841′) to result in a recombined exit beam along output path (847).

Modules (810,820,830) provide a longer distance for the respective second polarized beams to travel than the respective first polarized beams. The respective second polarized beams for modules (810,820) travel a distance D further than the associated first polarized beams. The second polarized beam (832′) traveling through module (830) travels a distance 2D further than the respective first polarized beam (831′). It is believed that such variance in travel distance between the two separated beams may result in phase differences between the signals that may adversely affect the integrity of the respective output beam after recombination. In particular, a phase shift results for the second polarized beam with respect to the separated first polarized beam. Therefore, these modules may incorporate a delay applied to the shorter traveled beam, as shown for illustration at delays (818,828,838) for modules (810,820,830), respectively. The use of delays in this manner is intended to counteract the phase delay with a more appropriate overlap of the polarized beams so that their recombined form more closely approximates the respective input beam.

Planar waveguide structure (800) is shown in FIG. 27 to include an array of switches wherein a switch is provided at each cross-connect region (801) where waveguides in the planar structure intersect. One aspect of the overall structure shown therefore provides a “n×2n” switch architecture—there are n input channels IN_{1 . . . n} and a total of 2n output channels based on n output channels 1OUT_{1 . . . n} and n output channels 2OUT_{1 . . . n}. However, not every input channel may reach every output channel, and therefore the “n×2n” aspect of planar waveguide structure (800) shown is considered of the “blocking” type. More specifically, each of the n input channels IN_{1 . . . n} may be selectively switched between each of the n output channels 1OUT_{1 . . . n}, as shown at the lower edge of planar waveguide structure (800). However, each of the n input channels IN_{1 . . . n} may only transmit through to one of the transmission output channels 2OUT_{1 . . . n} shown at the right edge of planar waveguide structure (800). A unique result follows: each input channel IN_{1 . . . n} may be selectively switched between n plus one outputs.

For further illustration, input channel IN₁ may be switched by any one of modules (810,820,830,840) to exit planar waveguide structure (800) at any one of the output channels 1OUT_{1 . . . n} at the bottom of planar waveguide structure (800). Or, input channel INₙ may be transmitted across modules (810,820,830,840) to exit planar waveguide structure (800) at specific output channel 2OUTₙ. However, the switch architecture shown in FIG. 27 does not allow for input channel n to reach others of the output channels on the right side of the structure (800). The switching modules (810,820,830,840) in this embodiment only select between: (i) transmission toward the next module (together enabling transmission to only one of output channels 2OUT_{1 . . . n} on the right side of the structure), or (ii) reflection toward a respectively coupled one of the bottom output channels 1OUT_{1 . . . n}.

The planar waveguide modes just described for the various polarization independent switching module embodiments illustrate several broad beneficial aspects of the invention.

One particular beneficial aspect provides a planar waveguide structure with an “n×2n” switching array wherein each of n input channels may be selectively switched between n plus one outputs.

Another particular beneficial aspect provides a planar waveguide structure that is adapted to separate n input channels into 2n intermediate channels, and then to recombine the separated 2n intermediate channels back into n output channels. In particular, the structure allows for each input channel to be separated into two intermediate channels that are thereafter recombined into one output channel; for the specific beneficial embodiment described each pair of separated intermediate channels are orthogonally polarized, and each recombined output channel may be substantially similar to its respective input channel before separation. Accordingly, a polarization independent “n×n” switching array may be provided that allows for n randomly polarized input channels to be selectively switched between at least n output channels.

A planar waveguide structure is also herein provided that separates n input channels into n pairs of respectively orthogonally polarized output channels (or 2n output channels wherein each output channel is orthogonally polarized with respect to another one of the output channels). This allows for use of a combining assembly to recombine the 2n output channels into n output channels that are each substantially similar to one of the n input channels (in particular with respect to having substantially similar polarization), thereby resulting in an overall “n×n” switching architecture.

Further to the “n×n” switching array aspects just described, any one or all of the output channels 2OUT_{1 . . . n} shown at the right edge of planar waveguide structure (800) are optional and may be inactive channels, either in the sense that they are not optically coupled to any useful output, or that they are removed from the overall structure. The resulting “n×n” switching array is therefore non-blocking—whereas any of the n inputs may be sent to any of the n outputs—whereas the “n×2n” aspects previously described above are of the “blocking” type.

Another beneficial aspect provides a planar waveguide structure with n² channel separation modules (or pairs of polarization dependent switches) coupled with n combiners in order to selectively switch n inputs between n outputs. In the particularly beneficial variation herein shown, the channel separation modules separate input channels to two orthogonally polarized channels. Moreover, an n×n switching array uses 2n switches (or n pairs of switches) with one combiner to selectively switch any one of n input channels into one of n output channels; this is beneficially done in a polarization independent switching array. In another regard, 2n individual light switches (or n pairs of light switches) are used to selectively switch one input channel between n+1 output channels. Still further, 2n² individual switches are provided for switching n inputs between n outputs, or 2n output channels in a partially blocked manner, as herein described. According to the specific beneficial embodiments herein shown and described, the 2n² switches, or 2n switches for each channel, provide polarization independent switching.

The various broad aspects of the planar waveguide switching arrays just described generally result from system applications of the various electro-optic TIR switches herein shown and described. However, these switching architecture aspects should not be considered as limited to the specific electro-optic TIR switch embodiments, and other switches may be suitable substitutes for some applications. Notwithstanding, various particular benefits result from incorporating the electro-optic TIR switches described, such as speed, reliability, efficiency, and manufacturability.

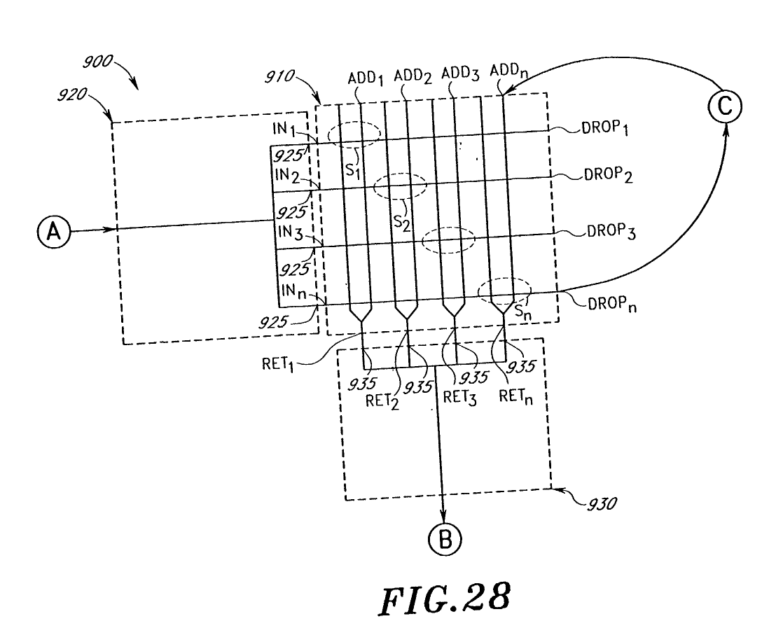

The embodiments herein shown and described by reference to FIG. 27 are believed to be useful to interface and cooperate with many different associated input and output devices and systems. Such integration may include “short reach” interface with other devices and systems; “long reach” switching interfaces are also considered useful applications of the switches of the present invention, including without limitation the switching architecture of FIG. 27. One particularly beneficial system (900) is shown in FIG. 28 for the purpose of illustration wherein a planar waveguide structure (910) similar that shown in FIG. 27 is interfaced with other optical devices.

More specifically, FIG. 28 shows an optical system (900) wherein a planar waveguide structure (910) is interfaced with three separate optical devices and/or systems, in particular useful in processing wavelength division multiplexed (“WDM”) input light beams. Firstly, arrayed waveguide de-multiplexer (920) is shown with n output wavelength channels (925) coupled to the n input channels IN_{1 . . . n} of planar waveguide structure (910). The terms “wavelength channel(s)” are herein intended to mean channels carrying light beams having unique respective wavelength bands. Secondly, an arrayed waveguide re-multiplexer (930) is shown with each of n input channels (935) coupled to one of the n output (or retained wavelength) channels RET_{1 . . . n} from planar waveguide structure (910). Thirdly, an add/drop interface is shown with a remote channel destination C as follows. Note that instead of having separate modules, any two of the planar waveguide structure (910), the demultiplexer (920), and the remultiplexor (930) or alternatively all three devices can be integrated on the same platform, chip, or substrate.

One of output (or “dropped wavelength”) channels DROP_{1 . . . n} from structure (910), or dropped wavelength channel c, is shown coupled to remote channel destination C to illustrate a “drop” of that dropped wavelength channel c from the input wavelength channel array launched into planar waveguide structure (910) from de-multiplexer (920). Moreover, the top edge of planar waveguide structure (910) is also shown to include a second set of n input channels ADD_{1 . . . n} which are adapted to receive “added” channel signals from a source, as shown at added wavelength channel d from remote channel destination C. As shown in FIG. 28, this added wavelength channel d replaces the dropped wavelength channel c and is recombined with the other retained or express wavelength channels RET_{1 . . . n} that are switched into re-multiplexer (930).

According to the multiple-device system (900) centered around switched planar waveguide structure (910) as just described, each input wavelength channel IN_{1 . . .} from demultiplexer (920) may be selected to exit structure (910) through any one of the retained or express output channels RET_{1 . . . n} from the structure (910). And, any input wavelength channel IN_{1 . . . n} may be dropped from the array by the structure (910) by not directing it toward any of those output channels RET_{1 . . . n}. Remultiplexer (930) remultiplexes the “retained” or “express” wavelength channels along various of the active output channels RET_{1 . . . n} from structure (910) in order to form an output channel (950) comprising the desired array of retained or express wavelength channels. Any dropped wavelength not switched into output channels RET_{1 . . . n} may terminate as a dead channel as useless, or may be detected, transmitted, or otherwise used for a particular purpose. In fact, the entire purpose of the system (900) of the present embodiment may be the peeling off of such “dropped” wavelength channel(s) in order to use that wavelength channel.

It may be desirable to locate the switches which either “drop” or “retain” the various wavelength channels according to a particular geometric pattern in structure (910) order to prevent or reduce a phase mismatch that may otherwise result between channels as they propagate through planar waveguide structure (910) before being remultiplexed by remultiplexer (930). For example, as shown in FIG. 28, input wavelength channel IN₁ may be switched at switch module S₁, input wavelength channel IN₂ switched at switch module S₂, etc., with input wavelength channel INₙ switched at switch module Sₙ. The geometry of the overall switch module array may be therefore laid out in a diagonal pattern across the plane of planar waveguide structure (910) such that the retained or express wavelength channels propagate along similar respective distances between input and output channels.

In the optical system (900) shown in FIG. 28, the demultiplexer (920) may comprise an array waveguide grating (AWG), a Bragg grating, an optical filter, an interferometer, or a dispersive component to separate out different wavelengths. Additionally, if the light in the optical system (900) and, more specifically, the light coupled into the planar waveguide structure (910), has a fixed polarization that is known and appropriately oriented within the switch, polarization dependent optical switches can be employed instead of the polarization independent switching modules described above thereby simplifying the device.

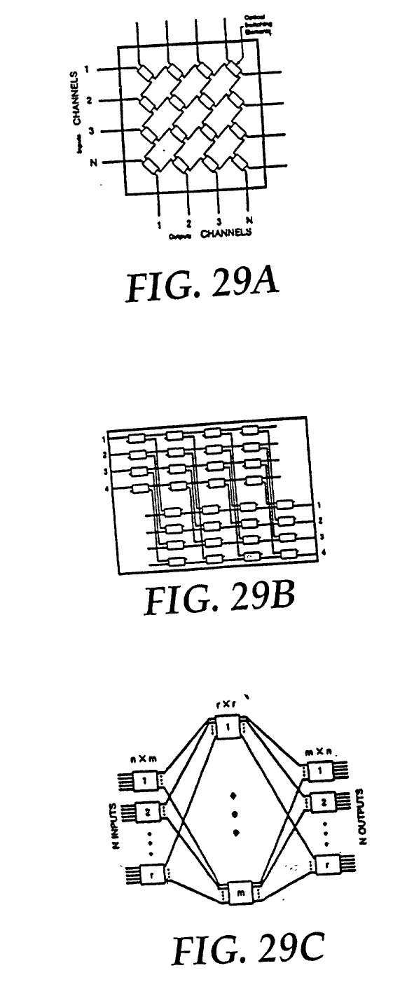

While the specific switching architectures shown and described above by reference to the previous Figures are believed to be highly beneficial, other specific switching architectures may also be suitable applications of the electro-optic TIR switches according to the embodiments, as shown in FIGS. 29A-G. More specifically, FIG. 29A shows a “crossbar” architecture; FIG. 29B shows a “double crossbar” architecture; FIG. 29C shows a “3-stage clos” architecture. Notwithstanding the specific switching architectures herein shown and described, it is contemplated that a specific layout of a switching array according to the embodiments herein shown and described will be generally tailored according to a specific application and need. For example, the number of input and/or output channels, angles and arrangements of cross-connects, etc. will vary between specific materials chosen and desired applications. Such modifications may be made according to one of ordinary skill based upon this disclosure without departing from the scope of the present invention.

### INDUSTRIAL APPLICABILITY

The present invention is well suited for application in a wide range of fields in which light modulators and high speed light switching devices are used, such as in high-speed printing, image processing and telecommunications. The present invention is also especially suited for use in flat panel displays and projection television.

Some of the basic array structures discussed above are in a one-dimensional line configuration, these may be configured and arranged to form two-dimensional structures such as shown elsewhere hereunder. Further to the molding processes herein described, and in particular according to use of the sol-gel process, the switches and other modulators of the invention are particularly well suited for integration directly into planar substrates configured for a wide variety of uses (e.g. planar waveguide arrays such as SiO₂/Si-based structures as herein described).

The materials presently used in flat panel displays respond very slowly to changes in display information. This leads to the commonly observed problem, especially in flat panel displays of laptop computers, that the display of a moving object will leave trails behind, due to the lag in the response of the display. The present invention, by contrast, is theoretically capable of switching speeds of 100 GHz and more, producing such fast response that it is beyond the ability of the human eye to register individual steps in a display of motion.

Prior art displays also may exhibit the problem of aliasing, or the jagged edges sometimes seen around the outline of a displayed object due to the comparatively large size of pixels in a digital display. By contrast, the elements of the present invention may be made as smaller than 1 μm×1 μm in cross section, each element being capable of producing an independent signal. Thus each element is potentially an independent pixel. The use of the present invention completely eliminates the problem of aliasing down to the microscopic scale. Indeed, the human eye cannot resolve such small elements. Thus for use on the scale of ordinary unaided human vision, the elements may be grouped into larger pixels, whose overall size can still be small enough to provide far better image resolution than is presently available. There may also be applications in which microscopic pixel size is advantageous, such as making microscopic photo masks for microchip manufacture. The ungrouped pixels of the present invention are uniquely suited for such uses.

The very small size of the elements allows low driving voltages to be used to produce the necessary electric field density to induce the desired electro-optic effect. TTL levels may be used with some materials. The use of TTL level voltages has many significant advantages. TTL level power supplies have been well developed over many years and are commonly available “off the shelf”. Thus power supplies can be easily obtained for systems that utilize the present invention, without having to provide a customized power supply. This also allows easier introduction of the present invention into equipment that uses TTL devices and already has the appropriate power supply in place.

The present invention also may be designed to utilize sub-TTL levels. It is useful in many applications in which these smaller driver voltages are supplied.

Prior art light modulators and optical switches that are fabricated on a common wafer without benefit of any feature to channel the electric field lines commonly suffer from problems with cross-talk between the channels. This interferes with image clarity and can corrupt transmitted data. By contrast, by utilizing the discrete elements of the present invention, cross-talk between channels is practically eliminated, resulting in cleaner image production and improved accuracy and integrity of data transmission. This has very many industrial applications in a wide variety of devices such as printers, telecommunications, and visual displays.

In addition, for telecommunications applications, prior art diode lasers which have been used, have typically suffered from the problem of “chirping” which is interference which can be produced when the voltage supplied to a diode laser is rapidly modulated. In contrast, the present invention modulates the optical output, rather than the diode laser itself. This greatly reduces interference and can eliminate the problem of chirping. This can be an important advantage for telecommunications applications. Moreover, the optical switches described in the embodiments above are adaptable for use in conventional datacom and telecom systems. Datacom, which is generally multimode, is typically classified as short wavelength, i.e., between about 700 and 900 nanometers in wavelength, and generally at about 850 nanometers. In comparison, most telecom applications employ light having wavelength between about 1300 to about 1600 nanometers. More specifically telecom employs light having a relatively narrow peak at 1310 nanometers and a broader band between about 1490 and about 1565, with a peak centered around about 1550 nanometers. However, more recent developments in fiber have enabled the use of wavelengths between the 1310 and 1550. Telecom also generally relies on single mode fiber optics having fiber diameters of between about 5 to 20 micrometers. One example of such optical fiber is SMF 28 available from Corning having a mode filled core about 11 micrometers in diameter. Although these optical switches can work at the telecom and datacom wavelengths discussed above, as well as in conjunction with the optical fiber dimensions described above, the optical switches are not limited to these specific wavelengths and dimensions and are compatible with other wavelengths and fiber and waveguide sizes and configurations.

Another feature that makes the present invention especially desirable for industrial applications is its ease of manufacture and low cost. It can be made using existing technology by varying methods such as micro-machining, laser ablation, selective etching in an electric field, and molding by conventional means or using a sol-gel process. For micro-machining, the same kinds of micro-saws as are presently used in trimming silicon wafers can be used to form the slots between the projections.

Sol-gel processing is a chemically based, relatively low temperature method that can produce ceramics and glasses with better purity and homogeneity than higher temperature conventional processes. Another of the attractive features of the sol-gel process is the capability to produce compositions not possible with conventional methods.

Thin films of PLZT electro-optic ceramic made with the sol-gel process have a number of advantages relative to PLZT ceramics prepared from powders. Large surface areas of thin film can be created which have very uniform (homogeneous) material structure. Small grain sizes are achievable, in the range of 10's of nm, with much less porosity compared with PLZT ceramics prepared from powders. A wide range of film thickness from a few nanometers to a few microns can be produced.

Sol-gel manufacture also easily lends itself to high volume production. It is inexpensive, suitable for large area spatial light modulators or flat panel displays and can utilize micro-machining fabrication processes that are standard in the industry. It can be used for bright, ultra high-speed flat panel displays or spatial light modulators suitable for computer interconnects and high-speed telecommunications with very wide viewing angles that may eventually be used to replace cathode ray tubes.

Notwithstanding the benefits of sol-gel processing as just described, other deposition processes may also be applicable, in particular with respect to filling cavities with PLZT (or other electro-optic material) within planar waveguides as herein described. For example, epitaxial growth, plasma, sputter, or other deposition methods may also be suitable for filling such cavities with PLZT.

In addition, further process considerations are believed useful for improving the deposition and material homogeneity of PLZT filled cavities. In one regard, certain functional and processing benefits have been observed as a result of using a “tie” or “buffering” layer between PLZT and the cavity walls formed within a silica/silicon planar waveguide structure according to the embodiments herein described. In one regard, a desirable buffer layer comprises a material that adheres better to silica, silicon, and PLZT than PLZT is observed to adhere directly to silica and silicon; therefore providing a PLZT:silicon/silica “adhesion” tie layer. In another regard, silica has been observed to migrate into the PLZT polycrystalline structure during the elevated temperatures concomitant with the PLZT sol-gel curing process (including from silicon substrate that oxidizes to the silica form at the elevated temperatures), thereby having a substantially neutralizing or otherwise reducing effect on the electro-optic activity of the contaminated PLZT. Therefore, another desired feature of an appropriate buffer layer provides a barrier that chemically isolates the PLZT from otherwise migratory silica along the cavity walls during the PLZT curing process. Still further attributes for an appropriate buffer layer include: optically transmissive material for intended wavelengths of incident light beams (e.g. about 1310 nm and/or 1550 nm for most telecommunications applications); and relative electrical non-conductivity to the extent the buffer layer may bridge between electrodes according to the assemblies herein described (an electrically conductive buffer layer might otherwise short the electrodes and degrade the ability to create the desired e-field in the electro-optic material therebetween).

According to the desired features just described, several materials have been identified as appropriate for a buffer layer as just described, including in particular without limitation the following materials: MgO, Al₂O₃, ZrO₂, AlN, TiO₂, ITO (Indium Tin Oxide), or combinations and blends thereof.

In particular, ITO is generally observed to adhere very well to silicon and silica and PLZT, provides the necessary chemical barrier preventing silica migration into the PLZT during heat cure, and is also suitably optically transparent in thin film form at 1550 nm wavelength light. However, ITO is also relatively electrically conductive. Therefore, ITO as a buffer layer for the purposes herein described is preferably itself compounded with an electrical conductivity neutralizing agent.

In particular, a solid ITO mixture having its electrical conductivity substantially neutralized and that is suitable for coating onto silicon/silica cavity walls as a PLZT buffer layer may be formed as follows. ITO, in an alcohol solution, is mixed with Al(NO₃)₃—H₂O)₆, also in an alcohol solution; the mixed liquid solution is then heated to flash off liquid solvents to form a solid mixture. According to this process, Al(NO₃)₃ is believed to convert to Al₂O₃, which remains in a solid mixture with the ITO that is then ready for deposition onto the cavity walls. For the purpose of further illustration, one particular buffer coating formulation and process which has been observed to be useful according to this aspect of the invention just described is as follows.

In order to fill the wells or cavities that intersect waveguides with optically active PLZT as herein described, the substrate (SiO₂/Si) is dipped repeatedly into organometallic solutions, air dried for a period of five minutes or more, depending on ambient humidity, and then moved to an oven held at 700 deg. C for a period of one minute. The substrate is coated at a rate of one third to one half a micrometer per cycle, with the build-up occurring more rapidly in the wells. A coating typically requires 50 to 150 dippings, depending on the thickness of the waveguide/cladding layer.

In the particular case of depositing PLZT into cavities in the dissimilar fused silica of a waveguide/cladding substrate structure as herein described, the chosen buffer layer was Indium Tin Oxide (ITO), or ITO in a mixture with aluminum nitride to the extent that it is desired to have an electrically non-conductive buffer layer. An ITO solution is prepared by the addition of the following chemicals:

| | | |
|---|---|---|
| Tin Acetate | 1.95 | gm. |
| Indium Acetate | 16.35 | gm. |
| Methyl Alcohol | 200.00 | gm. |
| Ethylenediamine | 9.00 | gm. |

The typical PLZT 9/65/35 precursor solution is prepared by combining the following chemical solutions:

| | | |
|---|---|---|
| Lead sub-Acetate | 36.00 | gm. |
| Lanthanum Nitrate | 4.14 | gm. |
| Zirconium Acetate | 25.38 | gm. |
| Titanium Acetyl Acetonate | 11.7 | gm. |
| Methyl alcohol | 90.00 | gm. |

(The precursor solutions for the PLZT solution are made up in concentrations necessary to provide the finished solid solution stoichiometry known as 9/65/35.)

The experimental apparatus used to coat the substrates includes a tube furnace mounted vertically, held at a temperature of about 700 degrees C. A thin wire is suspended through this furnace with a weight at the lower end to keep it taut and vertically stable. The SiO₂ substrate is suspended from the lower end of the weight. The upper end of the wire is attached to a computer-controlled linear motor. The substrate is lowered into a container of either buffer layer solution or PLZT, raised to an intermediate position between the container and the furnace for a period of at least five minutes to allow the solvents to evaporate. Then the substrate is raised into the furnace at a rate of 3.5 mm/s; the substrate then dwells in the center of the furnace for 1 minute. At the end of this period, the substrate is lowered to the intermediate position at 4.6 mm/s and allowed to cool for 40 seconds. The cycle is then repeated. In a typical run, 4 coats of buffer layer are applied, followed by 50-100 coats of PLZT, depending on the depth of the well to be filled.

A light modulating switch as herein described above creates a total internal reflection (TIR) boundary within an electro-optic element by providing an electric field in only one of two bordering portions of the switch. This produces a change in the index of refraction of the material in that portion so that it is now different than the index of refraction of the relatively non-activated other, bordering portion, Incident light which approaches at an angle greater than that of the critical angle for the two indexes of the two portions, and which is of proper polarization orientation, will be reflected into a second path, thus modulating the optical output of the switch. The switch can also be operated at TTL levels and picosecond range switching times, in particular according to various of the electro-optic material constructions as herein provided.

The operation of the switch is enhanced when the electric field lines within the active portion are narrowly directed, and with minimum fringe effects. In order to decrease fringing, a preferred embodiment of the present invention uses an element, which has a step region, removed from the unactivated portion, leaving the active portion to be of a greater thickness. The step portion is filled with material with a low dielectric constant and low polarizability that can be air, glass or plastic. The electric field is thus provided with a sharp, substantially planar boundary at least along the upper portion of the TIR boundary adjacent the step. This sharp boundary may also extend into the lower portion of the TIR boundary, in particular where a second bottom step in the inactive portion is formed. This causes the TIR boundary to be very flat and sharply defined with very little fringing at the TIR boundary portion at which the incident beam is reflected. The reflected beam thus suffers very little distortion and maintains excellent beam quality throughout modulation or switching.

As alluded to above with respect to certain specific embodiments, TIR will occur only for light of polarization orientation that is parallel to the plane of the TIR boundary. Light of different polarizations can thus be separated into components by an active TIR boundary, and this allows additional modes of modulation and signal processing that are not available with traditional electrical signals.

The optical switches and switching modules herein described can be easily combined in arrays and N×M cross-connect switches. They will find many uses in optical imaging and telecommunications, especially since they are easy to manufacture and operate.

For the above, and other reasons, it is expected that the device of the present invention will have widespread industrial applicability. Therefore, it is expected that the commercial utility of the present invention will be extensive and long lasting.

In addition to the above mentioned examples and embodiments, various other modifications and alterations of the inventive device may be made without departing from the invention. Accordingly, the particular embodiments in the above disclosure are not to be considered as limiting to the broad aspects of the invention as described herein. For example, various of the embodiments have been herein described as “planar”, such as for example with respect to “planar waveguide structures”. However, other structures that do not have a strictly “planar” geometry may provide suitable substitutes without departing from the scope of the invention. In addition, various of the embodiments have been described with reference to “switching” light. It is to be also appreciated however that other types of light modulation may be accomplished with various of the broadly beneficial modes, variations, and other aspects of the invention, for example beam splitting, filtering, attenuating, phase shifting, or other mechanisms that alter the character of a light signal may be incorporated with or otherwise accomplished with the various features herein described without departing from the scope of the invention. In particular, the specific embodiments shown and described herein should not be considered as limiting with respect to the scope of the appended claims unless specifically therein provided.

What is claimed is:

1. An optical system, comprising:
an optical switch having a first region, a second region in close conjunction with the first region such that a boundary is formed at a junction between the first and second regions, an electro-optic material located within at least one of the first and second regions and that comprises at least one of a solid material, a non-poled material, a ceramic material, a polycrystalline material, a non-ferroelectric material, a cubic material, a relaxor material, a material that reduces its index of refraction with respect to a light polarization component that is aligned with an applied electric field, or combinations or blends thereof, and the optical switch further comprising an electric field source which is adapted at least in part to apply an adjustable electric field to the electro-optic material in the one region such that the optical switch is adjustable between first and second conditions with respect to at least one polarization component of a light signal entering the optical switch and incident upon the boundary at an angle,
wherein in the first condition the first and second regions have respective indexes of refraction such that a substantial portion of the at least one polarization component of the light signal incident upon the boundary transmits across the boundary substantially unreflected, and in the second condition the respective indexes of refraction for the first and second regions are sufficiently different such that a substantial portion of the at least one polarization component of the light signal incident upon the boundary reflects with total internal reflection at the boundary.

2. An optical system, comprising:
an optical switch with a first region, a second region in close conjunction with the first region such that a boundary is formed at a junction between the first and second regions, a first material located in one of the first and second regions and that comprises an electro-optic material, and a second material located in the other of the first and second regions that comprises the electro-optic material in combination with another material such that the second material is less electro-optically active than the first material, the optical switch further comprising an electric field source which is adapted at least in part to apply an adjustable electric field to the electro-optic material in the one region such that the optical switch is adjustable between first and second conditions with respect to at least one polarization component of a light signal entering the optical switch and incident upon the boundary at an angle,
wherein in the first condition the first and second regions have respective indexes of refraction such that a substantial portion of the at least one polarization component of the light signal incident upon the boundary transmits across the boundary substantially unreflected, and in the second condition the respective indexes of refraction for the first and second regions are sufficiently different such that a substantial portion of the at least one polarization component of the light signal incident upon the boundary reflects with total internal reflection at the boundary.

3. An optical system, comprising:
an optical switch with a first region, a second region in close conjunction with the first region such that a boundary is formed at a junction between the first and second regions, an electro-optic material located within at least one of the first and second regions, and an electric field source which is adapted at least in part to apply an adjustable electric field to the electro-optic material along an axis in the one region that is substantially aligned with the boundary such that the optical switch is adjustable between first and second conditions with respect to at least one polarization component of a light signal entering the optical switch and incident upon the boundary at an angle; and
the first region is thicker than the second region relative to the axis,
wherein in the first condition the first and second regions have respective indexes of refraction such that a substantial portion of the at least one polarization component of the light signal incident upon the boundary transmits across the boundary substantially unreflected, and in the second condition the respective indexes of refraction for the first and second regions are sufficiently different such that a substantial portion of the at least one polarization component of the light signal incident upon the boundary reflects with total internal reflection at the boundary.

4. An optical system, comprising:
an optical switching module comprising an electro-optic material and at least one electric field source coupled to the electro-optic material in order to apply an electric field to the electro-optic material to at least in part adjust the optical switching module between a first condition and a second condition with respect to a light signal that is incident upon the optical switching module and without regard to a polarization of the light signal, wherein in the first condition a substantial portion of the light signal entering the optical switching module exits the optical switching module along a first output path, and wherein in the second condition a substantial portion of the light signal entering the optical switching module exits the optical switching module along a second output path.

5. An optical system, comprising:
a substrate having at least one wall that defines at least in part a cavity;
a first input waveguide associated with the substrate and optically coupled to the cavity;
a first output waveguide associated with the substrate and optically coupled to the cavity;
a second output waveguide associated with the substrate and optically coupled to the cavity; and
an optical switch formed within the cavity with a first region, a second region in close conjunction with the first region such that a boundary is formed between the first and second regions, an electro-optic material located within at least one of the first and second regions and having a composition that is different than the substrate and also different than the waveguides, and an electric field source which is adapted at least in part to apply an adjustable electric field to the electro-optic material in the one region such that the optical switch is adjustable between a first condition and a second condition with respect to at least one polarization component of a light signal entering the optical switch from the first input waveguide and incident upon the boundary at an angle,
wherein in the first condition the first and second regions have respective indexes of refraction such that a substantial portion of the at least one polarization component of the light signal incident upon the boundary transmits across the boundary substantially unreflected and into the first output waveguide, and in the second condition the respective indexes of refraction for the first and second regions are sufficiently different such that a substantial portion of the at least one polarization component of the light signal incident upon the boundary reflects with total internal reflection at the boundary and exits the optical switch into the second output waveguide.

6. A method of manufacturing an optical switching structure, comprising:
providing a substrate with a first input waveguide, a first output waveguide, and a second output waveguide;
forming an cavity within the substrate such that the first input waveguide and first and second output waveguides are each respectively optically coupled to the cavity; and
forming an optical switch within the cavity, wherein the optical switch is adapted to switch a light signal entering the optical switch from the first input waveguide at the first location to exit the optical switch either into the first output waveguide or into the second output waveguide.

7. An optical system, comprising:
a substrate;
an input waveguide array comprising n input waveguides that are associated with the substrate and are adapted to carry n distinct light signals as n distinct input optical channels, respectively, wherein n is an integer;
an output waveguide array comprising m output waveguides that are associated with the substrate and that are adapted to carry m distinct light signals as m distinct output optical channels, respectively, wherein m is an integer greater than n; and
an optical switch assembly comprising a plurality of optical switches associated with the substrate, each optical switch being optically coupled to an input waveguide such that a light signal carried by the input waveguide enters the optical switch, and also being optically coupled to at least two output waveguides and adapted to selectively switch at least one polarization component of the light signal entering the optical switch between either of the at least two respectively coupled output waveguides, and wherein the optical switches of the optical switch assembly are arranged with respect to the input and output waveguide arrays, respectively, such that each of the n input optical channels may be selectably directed to exit the optical switch assembly along any one of exactly n+1 of the output waveguides.

8. The optical system of claim 7, wherein each optical switch comprises an electro-optic material and an electric field source which is adapted at least in part to apply an adjustable electric field to the electro-optic material in order to adjust the optical switch between first and second conditions with respect to the at least one polarization component of the light signal entering the optical switch from a first input waveguide coupled to the optical switch, wherein in the first condition a substantial portion of the at least one polarization component of the light signal entering the optical switch exits the optical switch as a first output optical channel into a first output waveguide, and in the second condition a substantial portion of the at least one polarization component entering the optical switch exits the optical switch as a second output channel into a second output waveguide.

9. The optical system of claim 1, wherein the electro-optic material comprises a solid material.

10. The optical system of claim 1, wherein the electro-optic material comprises a non-poled material.

11. The optical system of claim 1, wherein the electro-optic material comprises a ceramic material.

12. The optical system of claims 1, wherein the electro-optic material comprises a polycrystalline material.

13. The optical system of claim 1, wherein the electro-optic material comprises an inorganic material.

14. The optical system of claim 1, wherein the electro-optic material comprises a non-ferroelectric material.

15. The optical system of claim 1, wherein the electro-optic material comprises a cubic material.

16. The optical system of claim 1, wherein the electro-optic material comprises a relaxor material.

17. The optical system of claim 1, wherein the electro-optic material comprises a PLZT material.

18. The optical system of claim 1, wherein the PLZT material comprises a Lanthanum concentration that is between about 8.5% and about 9.0% by atomic percent.

19. The optical system of claim 4, wherein the optical switching module further comprises:
an optical switch having a first region, a second region adjacent the first region with a boundary formed at a junction between the first and second regions, the electro-optic material is located within at least one of the first and second regions, and the at least one electric field source is adapted to apply an adjustable electric field to the electro-optic material within the one region in order to adjust the optical switch between a transmission mode and a reflection mode with respect to at least one polarization component of a light signal entering the optical switch and incident upon the boundary at an angle,
wherein in the transmission mode the first and second regions have respective indexes of refraction such that a substantial portion of the at least one polarization component of the light signal incident upon the boundary transmits across the boundary substantially unreflected, and in the reflection mode the respective indexes of refraction for the first and second regions are sufficiently different such that a substantial portion of the at least one polarization component of the light signal incident upon the boundary reflects with total internal reflection at the boundary, the first condition for the optical switching module being characterized at least in part by the optical switch in one of the transmission and reflection modes, and the second condition for the optical switching module being characterized at least in part by the optical switch in the other of the transmission and reflection modes.

20. The optical system of claim 8, wherein each optical switch comprises:
a first region and a second region in close conjunction with the first region such that a boundary is formed at a junction between the first and second regions, the electro-optic material is located along at least one of the first and second regions, and the electric field source is adapted to apply the adjustable electric field to the electro-optic material in the one region in order to adjust the optical switch between the first and second conditions, wherein in the first condition a substantial portion of the at least one polarization component of the light signal incident upon the boundary transmits across the boundary substantially unreflected and exits the optical switch as the first output optical channel into the respectively coupled first output waveguide, and in the second condition a substantial portion of the at least one polarization component of the light signal incident upon the boundary reflects with total internal reflection at the boundary and exits the optical switch as the second output optical channel into the second output waveguide.

21. The optical system of claims 1, wherein the light signal enters the optical switch as a light beam that is not guided and projects onto the boundary.

22. The optical system of claims 1, wherein the electro-optic material is located within the first region, and the electric field source is adapted to apply the adjustable electric field to the electro-optic material in the first region in order to adjust the optical switch between the respective first and second conditions with respect to the at least one polarization component of the light signal entering the optical switch in the respective first region.

23. The optical system of claim 22, wherein the electro-optic material has an index of refraction that increases with the applied electric field with respect to the one polarization component of the light signal.

24. The optical system of claim 23, wherein the applied electric field is substantially aligned with a polarization of the one polarization component.

25. The optical system of claim 23, wherein the applied electric field is aligned substantially orthogonal to a polarization of the one polarization component.

26. The optical system of claim 22, wherein the electro-optic material has an index of refraction that decreases with the applied electric field with respect to the one polarization component of the light signal.

27. The optical system of claim 26, wherein the applied electric field is substantially aligned with a polarization of the one polarization component.

28. The optical system of claim 26, wherein the applied electric field is aligned substantially orthogonal to a polarization of the one polarization component.

29. The optical system of claims 1, wherein the electro-optic material is located within the second region, and the electric field source is adapted to apply the adjustable electric field to the electro-optic material in the second region in order to adjust the optical switch between the respective first and second conditions with respect to the at least one polarization component of the light signal entering the optical switch in the respective first region.

30. The optical system of claim 29, wherein the electro-optic material has an index of refraction that increases with the applied electric field with respect to the one polarization component of the light signal.

31. The optical system of claim 30, wherein the applied electric field is substantially aligned with a polarization of the one polarization component.

32. The optical system of claim 30, wherein the applied electric field is aligned substantially orthogonal to a polarization of the one polarization component.

33. The optical system of claim 29, wherein the electro-optic material has an index of refraction that decreases with the applied electric field with respect to the one polarization component of the light signal.

34. The optical system of claim 33, wherein the applied electric field is substantially aligned with a polarization of the one polarization component.

35. The optical system of claim 33, wherein the applied electric field is aligned substantially orthogonal to a polarization of the one polarization component.

36. The optical system of claim 1, wherein the electric field source comprises first and second electrodes which are separated the electro-optic material along an axis in the one region such that an electro-optic response to the applied electric field is substantially localized within the electro-optic material between the electrodes in the one region.

37. The optical system of claim 36, wherein the substantially localized electric field within the electro-optic material along the axis between the electrodes is substantially aligned with the boundary.

38. The optical system of claim 36, wherein the one region is thicker than the other of the first and second regions with respect to the axis.

39. The optical system of claims 1, further comprising a second material in the other of the first and second regions having a different composition than the electro-optic material.

40. The optical system of claim 39, wherein the second material comprises the electro-optic material in combination with another material such that an electro-optic response to an applied electric field in the second material of the other region is less than an electro-optic response in the electro-optic material of the one region.

41. The optical system of claim 1, further comprising:
a substrate having at least one wall that defines at least in part a cavity;
a first input waveguide associated with the substrate and optically coupled to the cavity;
a first output waveguide associated with the substrate and optically coupled to the cavity; and
a second output waveguide associated with the substrate and optically coupled to the cavity,
wherein the optical switch is formed within the cavity such that the light signal enters the optical switch from the first input waveguide, in the first condition the substantial portion of the at least one polarization component of the light signal transmitting across the boundary exits the optical switch into the first output waveguide, and in the second condition the substantial portion of the at least one polarization component of the light signal reflecting with total internal reflection at the boundary exits the optical switch into the second output waveguide.

42. The optical system of claim 41, further comprising:
a second input waveguide associated with the substrate and optically coupled to the cavity,
wherein in the first condition a substantial portion of at least one polarization component of a second light signal entering the optical switch from the second input waveguide and incident upon the boundary transmits across the boundary substantially unreflected and exits the optical switch into the second output waveguide.

43. The optical system of claim 42, wherein in the second condition a substantial portion of the at least one polarization component of the second light signal incident upon the boundary reflects with total internal reflection at the boundary and exits the optical switch into the first output waveguide.

44. The optical system of claim 4, comprising:
a substrate;
a plurality of input waveguides associated with the substrate;
a plurality of output waveguides associated with the substrate; and
an optical switching assembly with a plurality of said optical switching modules associated with the substrate, each optical switching module being optically coupled to one of the input waveguides and at least two of the output waveguides,
wherein the optical switching assembly is adapted to selectively direct an input light signal from any one of the plurality of input waveguides to one of at least two of the plurality of output waveguides at least in part by adjusting a selected one of the optical switching modules between the respective first and second conditions.

45. The optical system of claim 4, wherein the optical switching module further comprises:
a first pair of two adjacent regions of material with a first boundary formed at a junction between the first pair of two adjacent regions, a first volume of the electro-optic material located within at least one of the first pair of two adjacent regions, the at least one electrical field source being adapted to apply an adjustable electric field to the electro-optic material in the one region such that the first pair of two adjacent regions is adjustable between a transmission mode wherein the light signal incident upon the first boundary at an angle substantially transmits across the first boundary and a reflection mode wherein a substantial portion of a first polarization component of the light signal substantially reflects with total internal reflection at the boundary while a second polarization component of the light signal substantially transmits across the boundary; and
a second pair of two adjacent regions of material with a second boundary being formed at a junction between the second pair of regions, the second boundary is optically coupled to the first boundary, a second volume of the electro-optic material is located within at least one of the second pair of regions, the at least one electrical field source being adapted to apply an adjustable electric field to the electro-optic material in the one region such that the second pair of two adjacent regions is adjustable between a transmission mode wherein a substantial portion of at least the second polarization component of the light signal transmitting across the first boundary and incident upon the second boundary also transmits across the second boundary substantially unreflected and a reflection mode wherein a substantial portion of the second polarization component of the light signal transmitting across the first boundary and incident upon the second boundary reflects with total internal reflection at the second boundary,
wherein the first condition is characterized at least in part by both of the first and second pairs of adjacent regions in the transmission mode, respectively, and the second condition is characterized at least in part by both the first and second pairs of adjacent regions in the reflection mode, also respectively.

46. The optical system of claim 45, wherein the optical switching module further comprises:
a combiner which is adapted to combine the first polarization component reflecting at the first boundary and the second polarization component reflecting at the second boundary into an output light signal.

47. The optical system of claim 45, further comprising:
an optical switching array of at least n said optical switching modules, each optical switching module being adapted to receive an input light signal from a unique one of n input optical channels, wherein n is an integer; and
n said combiners associated with the at least n optical switching modules, each combiner being adapted to combine the respective first and second polarization components from at least one of said optical switching modules.

48. The optical system of claim 47, further comprising n² optical switching modules, wherein each combiner is associated with a unique combination of n optical switching modules and is adapted to combine the respective first and second polarization components from any one of the respective combination of n optical switching modules into an output light signal.

49. The optical system of claim 48, wherein each optical switching module comprises a unique pair of optical switches such that the optical switching array comprises 2n² of said optical switches.

50. The optical system of claim 45, wherein
the first pair of two adjacent regions and first boundary form a first optical switch; and
the second pair of two adjacent regions and second boundary form a second optical switch that is physically separated from but optically coupled to the first optical switch.

51. The optical system of claim 50, wherein the optical switching module further comprises a waveguide located between and optically coupling the first and second optical switches.

52. The optical system of claim 50, wherein
in the reflection mode for the first pair of adjacent regions of the first optical switch the first polarization component has a first polarization and the second polarization component transmitting across the first boundary has a second polarization that is aligned substantially orthogonal to the first polarization,
wherein the second polarization component enters the second optical switch with the second polarization, and the second pair of adjacent regions is adjustable between the respective transmission and reflection modes with respect to the second polarization component with the second polarization.

53. The optical system of claim 50, wherein the optical switching module further comprises:
a first polarization rotator located between and being optically coupled to the first and second optical switches, and which is adapted to rotate the polarization alignment of the second polarization component after it transmits across the first boundary to a first rotated polarization that is substantially similarly aligned with the first polarization,
wherein the second polarization component enters the second optical switch with the first rotated polarization, and the second pair of adjacent regions is adjustable between the respective transmission and reflection modes with respect to the second polarization component having the first rotated polarization.

54. The optical system of claim 53, wherein the optical switching module further comprises:
a second polarization rotator that is adapted to receive the second component reflecting from the second boundary in the respective reflection mode for the second boundary and to rotate the polarization alignment from the first rotated polarization to a second rotated polarization that is substantially similarly aligned with the second polarization.

55. The optical system of claim 53, wherein the polarization rotator comprises an electro-optic material and also an electric field source which is adapted to apply an adjustable electric field to the electro-optic material.

56. The optical system of claim 53, further comprising a substrate with at least one wall that defines at least in part a substantially continuous cavity, wherein the first polarization rotator and at least one of the first and second optical switches are located within the cavity.

57. The optical system of claim 56, wherein the polarization rotator and both of the first and second optical switches are located within the cavity.

58. The optical system of claim 57, wherein the first optical switch, the polarization rotator, and the second optical switch are formed at least in part from a substantially integral electro-optic material.

59. The optical system of claim 53, wherein the first optical switch is optically coupled to the polarization rotator substantially via a first waveguide, and the polarization rotator is optically coupled to the second optical switch substantially via a second waveguide.

60. The optical system of claim 45, wherein the optical switching module further comprises:
an optical switch with a first region having a first optical refraction index, a second region having a second optical refraction index and that is in close conjunction with the first region, and a third region having a third optical refraction index and that is in close conjunction with the second region opposite the first region, the first and second regions forming the first pair of regions and the second and third regions forming the second pair of regions such that the first boundary is located at a junction between the first and second regions and the second boundary is located at a junction between the second and third regions, and wherein the optical switch is adjustable between the first and second conditions by adjusting either (i) the second optical refractive index relative to both the first and third optical refractive indexes, or (ii) the first and third optical refractive indexes relative to the second optical refractive index.

62. The optical system of claim 60, wherein each of the first and third regions comprises an electro-optic material, and the at least one electric field source is adapted at least in part to apply first and second adjustable electric fields, respectively, to the electro-optic material along the first and third regions, also respectively.

63. The optical system of claim 62, wherein the electro-optic material is further located within the second region, the first and second electric fields are substantially aligned along an axis, and the first and third regions are thicker than the second region relative to the axis.

64. The optical system of claim 62, wherein the first and second electric fields are substantially aligned with each other.

65. The optical system of claim 62, wherein the first and second electric fields are substantially aligned with the first and second boundaries, respectively.

66. The optical system of claim 60, wherein the second region comprises an electro-optic material, and the at least one electric field source is adapted to apply an adjustable electric field to the electro-optic material along the second region.

67. The optical system of claim 66, wherein the electric field is substantially aligned with the first and second boundaries.

68. The optical system of claim 65, wherein the electro-optic material is further located within the first and third regions, the electric field is substantially aligned with the first and second boundaries along an axis, and the second region is thicker than both of the first and third regions relative to the axis.

69. The optical system of claim 5, further comprising:
a second input waveguide associated with the substrate and optically coupled to the cavity;
wherein in the first condition a substantial portion of at least one polarization component of a second light signal entering the optical switch from the second input waveguide and incident upon the boundary transmits across the boundary substantially unreflected and exits the optical switch into the second output waveguide.

70. The optical system of claim 69, wherein in the second condition a substantial portion of the at least one polarization component of the second light signal incident upon the boundary reflects with total internal reflection at the boundary and exits the optical switch into the first output waveguide.

71. The optical system of claim 5, further comprising
a wavelength de-multiplexer which is adapted to receive a WDM optical signal, and to separate the WDM optical signal into n wavelength channels carrying n distinct light signals, respectively, with n unique wavelength bands, also respectively, wherein n is an integer;
n optical switching modules associated with the substrate, each having at least one said optical switch coupled to one said first input waveguides and one each of said first and second output waveguides, each optical switch being adapted to receive at least one polarization component of one of the wavelength channels along the respectively coupled first input waveguide and also being adapted to selectively switch the one wavelength channel between either one of the respectively coupled first and second output waveguides.

72. The optical system of claim 71, wherein the wavelength de-multiplexer is integrated with the substrate.

73. The optical system of claim 71, wherein the wavelength de-multiplexer is physically separate from the substrate but each wavelength channel is optically coupled to the input waveguides associated with the substrate through either free-space or a plurality of coupling waveguides.

74. The optical system of claim 71, further comprising:
n retain waveguides associated with the substrate; and
n drop waveguides associated with the substrate,
wherein the n optical switching modules are arranged to allow at least one polarization component of each of the n wavelength channels to be selectively retained to one of the n retain waveguides or dropped to one of the n drop waveguides, such that m drop waveguides may carry m wavelength channels, respectively, with n−m retain waveguides carrying n−m wavelength channels, also respectively, and with m retain waveguides left open without a retained wavelength channel, wherein m is in integer between zero and n.

75. The optical system of claim 74, further wherein each retain waveguide and each drop waveguide is unitary with at least one output waveguide, respectively.

76. The optical system of claim 74, further comprising:
a wavelength multiplexer coupled to each of the n retain waveguides and which is adapted to combine the n−m wavelength channels from the respective retain waveguide segments into a retained wavelength multiplexed signal.

77. The optical system of claim 76, wherein the wavelength multiplexer is integrated with the substrate.

78. The optical system of claim 76, wherein the wavelength multiplexer is physically separate from the substrate but is optically coupled to each of the n retain waveguides through either free-space or a plurality of coupling waveguides.

79. The optical system of claim 74, wherein the optical switch assembly further comprises a plurality of add waveguides associated with the substrate and that are adapted to receive and carry a plurality of added wavelength channels, respectively, wherein each of the add waveguides is optically coupled to one of the n retain waveguides, and the optical switching modules are arranged with respect to the add and retain waveguides in order to selectively allow up to m of the added wavelength channels to up to m of the retained waveguides that are selectively left open by a dropped wavelength channel.

80. The optical system of claim 7, wherein m is equal to 2n.

81. The optical system of claim 80, wherein each of the of the n input optical channels may not be selectively switched to n−1 of the output optical channels.

82. The optical system of claim 20, wherein
each optical switch is also optically coupled to a second input waveguide; and
in the first condition a substantial portion of at least one polarization component of a second input optical channel entering the optical switch from the second input waveguide as a second light signal and incident upon the boundary transmits across the boundary substantially unreflected and exits the optical switch into the second output waveguide.

83. The optical system of claim 82, wherein in the second condition a substantial portion of the at least one polarization component of the second input optical channel incident upon the boundary reflects with total internal reflection at the boundary and exits the optical switch into the first output waveguide.

84. The optical system of claim 53, further comprising at least one waveguide coupled to at least one of the first and second optical switches.

85. The optical system of claim 5, wherein the substrate comprises at least one of silica and silicon.

86. The optical system of claim 5, wherein the substrate comprises a substantially planar structure.

87. The method of claim 6, further comprising:
forming the optical switch within the cavity at least in part by placing a material within the cavity that has an index of refraction that changes in the presence of an applied energy field.

88. The method of claim 87, wherein the optical switch is formed within the cavity at least in part by:
placing a precursor material within the cavity; and
heat treating the precursor material to form the material.

89. The method of claim 88, further comprising:
providing the precursor material as a sol-gel substance.

90. The method of claim 6, wherein the optical switch is formed within the cavity at least in part by placing an electro-optic material within the cavity.

91. The method of claim 90, further comprising positioning at least one electrode in close association with the electro-optic material such that an electric field may be applied to the electro-optic material within the cavity when a voltage is applied between the electrode and another electrode.

92. The method of claim 91, further comprising providing the electrode along at least one wall of the substrate that defines at least in part the cavity.

93. The method of claim 86, further comprising forming a step in the electro-optic material within the cavity such that one region of the electro-optic material has a first thickness relative to an axis within the cavity and another adjacent region of the electro-optic material has a second thickness within the cavity relative to the axis that is less than the first thickness.

94. The method of claim 90, further comprising:
placing a second material within the cavity having a different composition than the electro-optic material such that the electro-optic material forms a first region and the second material forms a second region within the cavity that is in close conjunction with the first region such that a boundary is formed at the junction between the first and second regions.

95. The method of claim 94, further comprising forming the second material by combining a volume of the electro-optic material with another material such that the second material is less electro-optically active than the electro-optic material alone.

96. The method of claim 95, further comprising providing the electro-optic material as a PLZT material, and forming the second material by combining the volume of PLZT material with the other material.

97. The method of claim 96, wherein the other material is a silica based material.

98. The method of claim 87, further comprising placing the material within the cavity at least in part by introducing a precursor material by vapor deposition.

99. The method of claim 87, further comprising placing the material within the cavity at least in part by introducing a precursor material by plasma deposition.

100. The method of claim 83, further comprising placing the material within the cavity at least in part by epitaxially growing the material within the cavity.

101. An optical system, comprising:
an optical switch having at least one bottom face, n side walls, and at least one top face opposite the at least one bottom face with respect to the n side walls, the optical switch being adapted to receive at least one input light signal incident upon the optical switch along a first optical path and being adjustable between a first condition and a second condition, wherein in the first condition the input light signal is allowed to exit the optical switch along a second optical path exiting the optical switch, and in the second condition at least one polarization component of the input light signal is directed by the optical switch to exit the optical switch along a third optical path; and
a waveguide array comprising not more than n−2 waveguides optically interfaced with the optical switch along not more than n−2 of the side walls, wherein the waveguide array further comprises a first waveguide optically coupled to the first optical path, a second waveguide optically coupled to the second optical path, and a third waveguide optically coupled to the third optical path, and further wherein n is an integer.

102. The optical system of claim 101, further comprising 6 side walls such that the optical switch has a hexagonal shape.

103. The optical system of claim 101, further comprising 8 side walls such that the optical switch has a substantially octagonal shape.

104. The optical system of claim 101, wherein the optical switch comprises an electro-optic material.

105. The optical system of claim 101, wherein the optical switch comprises a PLZT material.

106. The optical system of claim 105, wherein the PLZT material has a lanthanum concentration of between about 8.5% and about 9.0% by atomic percent.

107. An optical system, comprising:
a substrate having at least one surface that forms n side walls that define at least in part a cavity, wherein the cavity is further defined by first and second boundary regions located opposite each other with respect to the n side walls, wherein n is an integer; and
a plurality of waveguides formed within the substrate, wherein not more than n−2 of the waveguides are interfaced with the cavity along not more than n−2 of the side walls.

108. The optical system of claim 107, wherein n equals 6 side walls such that the cavity has a hexagonal shape.

109. The optical system of claim 107, further wherein n equals 8 side walls such that the cavity has a substantially octagonal shape.

110. The optical system of claim 107, further comprising:
an optical switch located within the cavity and which is adjustable between first and second conditions, wherein in the first condition at least one polarization component of an input light signal from a first waveguide and incident upon the optical switch is allowed to transmit across the optical switch substantially unreflected and exits the optical switch along a second waveguide, and in the second condition the optical switch is adapted to substantially reflect the at least one polarization component of the input light signal to exit the optical switch along a third waveguide.

111. The optical system of claim 110, wherein the optical switch comprises an electro-optic material and also an electric field source which is adapted at least in part to apply an adjustable electric field to the electro-optic material.

112. The optical system of claim 111, wherein the optical switch comprises a PLZT material.

113. The optical system of claim 112, wherein the PLZT material has a lanthanum concentration of between about 8.5% and about 9.0% by atomic percent.

114. An optical system, comprising:
a substrate having a surface that defines at least in part a cavity;
an electro-optic material located within the cavity; and
an electric field source which is adapted at least in part to apply an electrical field to the electro-optic material within the cavity; and
a coating located at least in part between electro-optic material and the surface and comprising a mixture of a second material that is different than the electro-optic material and a third material that is different than the electro-optic material and also the second material.

115. An optical system, comprising:
a substrate comprising at least one of silica and silicon, and having a surface that defines at least in part a cavity;
an electro-optic material formed within the cavity by heat processing an electro-optic precursor material within the cavity at sufficient temperature to generally cause silica migration from the substrate; and
a coating located at least in part between the electro-optic material and the surface, wherein the electro-optic material is substantially free from silica contamination.

116. An optical system, comprising:
a substrate having a surface that defines at least in part a cavity;
first and second waveguide segments formed within the substrate and that are optically coupled to and are separated by an optical path through the cavity; and
a plurality of optical components each being located at least in part within the cavity and along the optical path between the first and second waveguide segments,
wherein each of the optical components is adapted to influence at least one aspect of an input light signal from the first waveguide segment incident upon the cavity such that an exit light signal which is different from the input light signal exits the cavity into the second waveguide segment.

117. An optical system, comprising:
a plurality of optical components, each optical component comprising a portion of a substantially continuous material and that defines an optical path and is responsive to an applied energy field in order to influence at least one aspect of a light signal propagating through the material when the energy field is applied to the material, each optical component being aligned with respect to the other optical components such that the respective optical paths are connectable in selected configurations to route at least one aspect of a light signal through the optical system.

118. A method for forming an optical system, comprising:
providing a substrate comprising at least one of silica and silicon;
forming a cavity within the substrate;
filling the cavity at least in part with an electro-optic material;
heating the electro-optic material within the cavity to at least 600 degrees C; and
substantially preventing migration of silica into the electro-optic material while the electro-optic material is being heated.

119. A method for making an optical system, comprising:
providing a substrate comprising at least one of silica and silicon;
forming a cavity within the substrate such a surface of the substrate forms a cavity wall that defines at least in part the cavity;
coating the cavity wall with a mixture of a first material and a second material; and
filling the cavity at least in part with an electro-optic material having a different composition than the first material, the second material, or the mixture.

120. A method for making an optical system, comprising:
providing a substrate comprising at least one of silica and silicon;
forming a cavity within the substrate such a surface of the substrate forms a cavity wall that defines at least in part the cavity; and
applying a coating to the cavity wall that comprises a mixture of a first material that is substantially electrically conductive and a second material that substantially neutralizes the electrical conductivity of the mixture,
wherein the cavity may be filled at least in part with a third material such that the coating is between the third material and the cavity wall.

121. A method for making an optical system, comprising:
providing a substrate;
forming a cavity within the substrate such a surface of the substrate forms a cavity wall that defines at least in part the cavity;
applying a coating to the cavity wall that comprises a first material selected from the group consisting of MgO, Al₂O₃, ZrO₂, TiO₂, ITO, and combinations and blends thereof; and
filling the cavity at least in part with an electro-optic material having a different composition than coating or the first material.

122. The optical system of claim 114, wherein
the coating comprises a mixture of a second material that has a different composition than the electro-optic material and a third material that has a different composition than either the second material or the electro-optic material.

123. The optical system of claim 114, wherein
the second material comprises a relatively electrically conductive material; and
the third material comprises an electrical conductivity neutralizing agent,
wherein the coating does not substantially inhibit an application of an electric field to the electro-optic material within the cavity.

124. The optical system of claim 114, wherein the coating comprises a material that is selected from the group consisting of MgO, Al₂O₃, ZrO₂, TiO₂, ITO (Indium Tin Oxide), or combinations and blends thereof.

125. The optical system of claim 114, wherein the coating comprises a mixture of ITO and Al₂O₃.

126. The optical system of claim 114, wherein the electro-optic material forms at least in part an optical switch within the cavity, and further comprising an electric field source which is adapted to apply an adjustable electric field to the electro-optic material in order to affect a direction of a light signal propagating through the cavity.

127. The optical system of claim 126, wherein
the optical switch further comprises a first region, a second region adjacent the first region such that a boundary is formed between the first and second regions, the electro-optic material is located at least within one of the first and second regions and has an optical index of refraction that changes in the presence of an applied electric field with respect to the at least one polarization component of the input light signal entering the first region; and
the electric field source is adapted at least in part to apply an adjustable electric field to the electro-optic material within one of the first and second regions in order to adjust the optical switch between first and second conditions,
wherein in the first condition the optical refractive index of the first and second regions are substantially matched such that the at least one polarization component is allowed to transmit across the boundary substantially unreflected, and in the second condition the respective optical refractive indexes of the first and second regions are sufficiently different such that the at least one polarization component reflects with total internal reflection at the boundary.

128. The optical system of claim 116, wherein at least one of the optical components comprises:
a material that is adjustable in order to influence at least one aspect of a light signal propagating through the material when an energy field is applied to the material; and
an energy field source that is adapted to apply an adjustable energy field to the material.

129. The optical system of claim 116, wherein the plurality of optical components comprises an optical switch which is adjustable between first and second conditions, wherein in the first condition at least one polarization component of an input light signal incident upon the optical switch along a first optical path is allowed to transmit across the optical switch substantially unreflected and exits the optical switch along a second optical path, and in the second condition the optical switch is adapted to substantially reflect the at least one polarization component of the input light signal such that the at least one polarization component does not exit the optical switch along the second optical path.

130. The optical system of claim 129, wherein
the optical switch further comprises a first region, a second region adjacent the first region such that a boundary is formed between the first and second regions, an electro-optic material located at least within one of the first and second regions and which has an optical index of refraction that changes in the presence of an applied electric field with respect to the at least one polarization component of the input light signal entering the first region; and
the optical system further comprises an electric field source which is adapted at least in part to apply an adjustable electric field to the electro-optic material within one of the first and second regions in order to adjust the optical switch between the first and second conditions,
wherein in the first condition the optical refractive index of the first and second regions are substantially matched such that the at least one polarization component is allowed to transmit across the boundary substantially unreflected, and in the second condition the respective optical refractive indexes of the first and second regions are sufficiently different such that the at least one polarization component reflects with total internal reflection at the boundary.

131. The optical system of claim 129, wherein the plurality of optical components comprises two of said optical switches.

132. The optical system of claim 131, wherein the plurality of optical components further comprises a polarization rotator located between the two optical switches along the optical path.

133. The optical system of claim 129, wherein the plurality of optical components further comprises a polarization rotator located on a first side of the optical switch relative to the optical path.

134. The optical system of claim 133, wherein the plurality of optical components further comprises a second polarization rotator located on a second side of the optical switch opposite the first side of the polarization rotator relative to the optical path.

135. The optical system of claim 117, wherein the material comprises an electro-optic material, and the energy field source comprises an electrical field source that is adapted to apply an adjustable electric field to the electro-optic material.

136. The optical system of claim 116, further comprising a collimator that is adapted to substantially collimate an input light signal incident upon at least one of the plurality of optical components.

137. The method of claim 118, further comprising:
applying a coating to a surface of the substrate that forms a wall that defines at least in part the cavity, such that the coating substantially prevents migration of silica into the electro-optic material during heating.

138. The method of claim 120, further comprising filling the cavity at least in part with an electro-optic material that is different than the first material, the second material, and the mixture.

139. The method of claim 119, further comprising
applying the coating by forming a liquid mixture of a relatively electrically conductive material with an electrical conduction neutralizing agent, applying the liquid mixture to the surface, and curing the liquid mixture to a substantially solid mixture form that is substantially secured to the surface.

140. The method of claim 139, further comprising:
forming the liquid mixture in an alcohol based solution.

141. The method of claim 139, further comprising:
forming the liquid mixture by mixing ITO in an alcohol based solution with Al(NO₃)₃ also in an alcohol solution, wherein the Al(NO₃)₃ may be in a hydrated form.

142. The method of claim 118, further comprising:
providing an electro-optic precursor material in a non-solid form; and
filling the cavity at least in part with the electro-optic precursor material in the non-solid form.

143. The method of claim 142, further comprising:
treating the electro-optic precursor material to form the electro-optic material in a substantially solid form within the cavity.

144. The method of claim 118, wherein the electro-optic material comprises PLZT.

145. The method of claim 144, further comprising providing the PLZT with a lanthanum concentration of between about 8.5% and 9.0% on a molecular basis.

146. The method of claim 118, further comprising forming an optical switch within the cavity without poling the electro-optic material.

147. The method of claim 118, further comprising forming the coating to include a mixture of ITO and Al₂O₃.

148. The method of claim 119, further comprising:
providing the substrate with at least one waveguide formed therein;
forming the cavity such that the waveguide is optically coupled to the cavity along the cavity wall.
